(19) United States
(12) Patent Application Publication
(10) Pub. No.: US 2025/0034002 A1
(43) Pub. Date: Jan. 30, 2025

(54) MATERIALS FOR THE CAPTURE OF SUBSTANCES

(71) Applicant: Membrion, Inc., Seattle, WA (US)

(72) Inventors: Gregory Matthew Newbloom, Seattle, WA (US); Olivia Marie Lenz, Seattle, WA (US); Emma Cave, Seattle, WA (US)

(73) Assignee: Membrion, Inc., Seattle, WA (US)

(21) Appl. No.: 18/717,039

(22) PCT Filed: Dec. 8, 2022
(86) PCT No.: PCT/US2022/052275

§ 371 Date: Jun. 6, 2024

Related U.S. Application Data
(60) Provisional application No. 63/288,216, filed on Dec. 10, 2021.

(51) Int. Cl. C02F 1/28; C02F 1/42; C02F 101/20; C02F 101/36

(52) U.S. Cl. CPC C02F 1/281; C02F 1/42; C02F 2101/20; C02F 2101/36

(57) ABSTRACT

Materials such as ion exchange materials for capturing substances, and associated methods and systems, are generally described. In some instances, adsorbent materials that can capture undesirable species from fluid mixtures such as waste streams are provided. The adsorbent material may include ceramic particles (e.g., as a resin) functionalized for effectively and/or selectively capturing species such as per- and poly-fluoroalkyl substances (PFAS) and/or metal or metalloid-containing ions (including heavy metals). Systems and methods for further treating species captured by the adsorbent material are also provided. For example, some embodiments are directed to mechanochemical treatment of captured species associated with the adsorbent material. Subjecting captured species such as PFAS to mechanochemical transformations can destroy potentially harmful contaminants in a relatively inexpensive and distributable manner.

### RELATED APPLICATIONS

This application claims priority under 35 U.S.C. § 119(e) to U.S. Provisional Patent Application No. 63/288,216, filed Dec. 10, 2021, and entitled “Materials for the Capture of Substances,” which is incorporated herein by reference in its entirety for all purposes.

### TECHNICAL FIELD

Materials such as ion exchange materials for capturing substances, and associated methods and systems, are generally described.

### BACKGROUND

There exists a variety of potentially harmful substances that can contaminate the environment and/or pose health risks. For example, per- and poly-fluoroalkyl substances (PFAS) are sourced from multiple industries such as water-resistant fabrics to fire-fighting foams, and their accumulation can cause long-term adverse health outcomes. As another example, metals (e.g., heavy metals) and metalloids can also be harmful contaminants. Certain embodiments of the present disclosure are directed to inventive compositions, materials, systems, and related methods, for improving the performance and/or properties of materials for capturing and treating substances.

### SUMMARY

Materials such as ion exchange materials for capturing substances, and associated methods and systems, are generally described. The subject matter of the present invention involves, in some cases, interrelated products, alternative solutions to a particular problem, and/or a plurality of different uses of one or more systems and/or articles.

In one aspect, adsorbent materials are described. In some embodiments, an adsorbent material comprises ceramic particles, wherein: the ceramic particles comprise a functional group covalently bonded to a surface of the ceramic particles; a mean maximum cross-sectional dimension of the ceramic particles is greater than or equal to 100 nanometers and less than or equal to 3000 microns; and the ceramic particles are free of any metal or metalloid atoms bound to any other metal or metalloid atoms via a linkage comprising an arylene group or comprises metal or metalloid atoms directly bound other metal or metalloid atoms via a linkage comprising an arylene group in an amount of less or equal to 50 mol % of the metal or metalloid atoms in the ceramic particles. In some embodiments, the mean maximum cross-sectional dimension of the ceramic particles is greater than or equal to 10 microns and less than or equal to 3000 microns.

In some embodiments, an adsorbent material comprises ceramic particles, wherein: the ceramic particles comprise a functional group covalently bonded to a surface of the ceramic particles; a mean maximum cross-sectional dimension of the ceramic particles is greater than or equal to 100 nanometers and less than or equal to 3000 microns; and upon exposure to a liquid, the adsorbent material does not undergo a volume expansion or undergoes a volume expansion by a factor of less than 1.5. In some embodiments, the mean maximum cross-sectional dimension of the ceramic particles is greater than or equal to 10 microns and less than or equal to 3000 microns.

In another aspect, systems for treating a fluid mixture comprising a fluorine-containing molecule are provided. In some embodiments, the system comprises: a vessel comprising: an inlet for receiving the fluid mixture, and an adsorbent material within the vessel, the adsorbent material comprising functional groups having an affinity for the fluorine-containing molecule; and a mechanochemical apparatus configured to receive solid material from the vessel.

In another aspect, methods for treating a fluid mixture comprising a target species comprising a fluorine-containing molecule are provided. In some embodiments, a method comprising exposing an adsorbent material comprising free ceramic particles to the fluid mixture, wherein the ceramic particles comprise a functional group bonded to the ceramic having an affinity for the target species; and removing an amount of the target species from the fluid mixture at least in part by capturing the target species with the ceramic particles using the functional group.

In another aspect, methods for treating a fluid mixture comprising a target species are provided. In some embodiments, a method comprises: exposing an adsorbent material comprising free ceramic particles to the fluid mixture, wherein the ceramic particles comprise a functional group bonded to a surface of the ceramic particles, the functional group having an affinity for the target species, wherein the adsorbent material has a volume of greater than or equal to 0.01 m³; and removing an amount of the target species from the fluid mixture at least in part by capturing the target species molecules with the ceramic particles using the functional group.

In another aspect, methods for treating fluorine-containing molecules are provided. In some embodiments, a method comprises subjecting a target species comprising a fluorine-containing molecule captured by functional groups covalently bound to an adsorbent material to a mechanochemical transformation.

In another aspect, methods for treating a target species are provided. In some embodiments, a method comprises subjecting a target species captured by functional groups covalently bound to a surface of ceramic particles of an adsorbent material to a mechanochemical transformation, wherein a mean maximum cross-sectional dimension of the ceramic particles is greater than or equal to 100 nanometers and less than or equal to 3000 microns. In some embodiments, the mean maximum cross-sectional dimension of the ceramic particles is greater than or equal to 10 microns and less than or equal to 3000 microns.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a schematic cross-sectional illustration of an adsorbent material, according to some embodiments;

FIG. 2 shows a schematic cross-sectional illustration of an adsorbent material comprising particles, according to some embodiments;

FIG. 3 shows a schematic cross-sectional illustration of a ceramic particle comprising functional groups, according to some embodiments;

FIG. 4 shows a schematic cross-sectional illustration of functional groups covalently bound to a ceramic, according to some embodiments;

FIG. 5 shows a schematic cross-sectional illustration of a system for treating a fluid mixture comprising target species, where the system comprises a vessel, an inlet, and an adsorbent material within the vessel, according to some embodiments;

FIG. 6 shows a schematic block diagram of a system for treating a fluid mixture comprising target species, where the system comprises a vessel and a mechanochemical apparatus, according to some embodiments;

FIGS. 7A-7B show scanning electron microscopy (SEM) images of a benchmark resin (FIG. 7A) and an exemplary adsorbent material comprising ceramic particles (FIG. 7B), according to some embodiments;

FIG. 8 shows a plot of ion exchange capacity measured for a benchmark resin and several exemplary adsorbent materials comprising ceramic particles, according to some embodiments;

FIG. 9 shows a plot of adsorption density as a function of time for various PFAS exposed to an exemplary adsorbent material comprising ceramic particles, according to some embodiments;

FIG. 10 shows chemical structures of various functionalized silanes that can be used for forming ceramic particles, according to some embodiments;

FIG. 11 shows a plot of adsorption density as a function of time for various PFAS exposed to exemplary adsorbent materials comprising ceramic particles, according to some embodiments;

FIG. 12 shows a plot of percent destruction of various PFAS captured by an exemplary adsorbent material comprising ceramic particles, according to some embodiments;

FIGS. 13A-13B shows images of ceramic particles prior to exposure to water (FIG. 13A) and after exposure to water (FIG. 13B);

FIG. 14 shows a plot of adsorption by mass of chromate ions by exemplary adsorbent materials comprising ceramic particles and commercial resins, according to some embodiments;

FIG. 15 shows a plot of densities of various exemplary adsorbent materials and commercial resins, according to some embodiments;

FIG. 16 shows a plot of adsorption by volume of chromate ions by exemplary adsorbent materials comprising ceramic particles and commercial resins, according to some embodiments;

FIG. 17A presents a plot of Mn adsorption capacity for adsorbent materials of various particle size ranges, according to some embodiments;

FIG. 17B presents a plot of Cr adsorption capacity for adsorbent materials of various particle size ranges, according to some embodiments;

FIG. 17C presents a plot of maximum adsorption capacity for chromate, selenite, and arsenite for an adsorbent material, according to some embodiments;

FIG. 17D presents a plot of Mn adsorption capacity for two different adsorbent materials, according to some embodiments;

FIG. 18A presents a plot of copper removal percentage by porous adsorbent materials after exposure to an oxidizing agent, according to some embodiments;

FIG. 18B presents a plot of a ratio of the % Cu²⁺ removed by porous adsorbent materials before exposure to an oxidizing agent to % Cu²⁺ removed by corresponding samples that were never exposed to the oxidizing agent;

FIG. 19A presents a plot of copper ion adsorption capacity for porous adsorbent materials as a function of sulfonate loading, according to some embodiments;

FIG. 19B presents a plot of copper adsorption capacity for porous adsorbent materials further functionalized with various additional functional groups, according to some embodiments;

FIG. 20A presents a plot of adsorption capacity for copper ions, calcium ions, and sodium ions for porous adsorbent materials as a function of sulfonate loading, according to some embodiments;

FIG. 20B presents a plot showing ratios of percentages of calcium ions to copper ions removed by various porous adsorbent materials, according to some embodiments; and

FIG. 20C presents a plot showing ratios of percentages of sodium ions to copper ions removed by various porous adsorbent materials, according to some embodiments.

### DETAILED DESCRIPTION

Materials such as ion exchange materials for capturing substances, and associated methods and systems, are generally described. In some instances, adsorbent materials that can capture undesirable species from fluid mixtures such as waste streams are provided. The adsorbent material may include ceramic particles (e.g., as a resin) functionalized for effectively and/or selectively capturing species such as per- and poly-fluoroalkyl substances (PFAS) and/or metal or metalloid-containing ions (including heavy metals). Systems and methods for further treating species captured by the adsorbent material are also provided. For example, some embodiments are directed to mechanochemical treatment of captured species associated with the adsorbent material.

Subjecting captured species such as PFAS to mechanochemical transformations can destroy potentially harmful contaminants in a relatively inexpensive and distributable manner.

Industrialization has presented a variety of environmental and health threats. For example, per- and poly-fluoroalkyl substances are a group of man-made compounds that pose an imminent threat to both the human body and the environment. Manufactured since the 1940s for multiple industries from water-resistant fabrics to fire-fighting foams, PFAS are ubiquitous. These compounds do not easily break down over time, which can lead to accumulation in the body and/or environment. There is evidence that this accumulation causes long-term, adverse health outcomes such as cancer, birth defects, or compromised immune systems. The need for PFAS remediation technologies is higher than ever and is driving a world-wide effort to mitigate the damage caused by these compounds. PFAS compounds are typically made up of two main components: a hydrophilic head group (carboxylic acid, sulfonic acid, etc.) and a hydrophobic tail group (long or short fluoroalkyl chain). One approach for PFAS removal is ion exchange (IX) resins. These resins can adsorb the compounds using a mixture of two processes: (1) electrostatic interactions between the hydrophilic head group of the PFAS and the charged sites in the resin and (2) hydrophobic/van der Waals interactions between the non-polar organic components of the resin and the PFAS tail group. While the exact contribution from these two processes is still up for debate, it is believed in the context of this disclosure that tailoring these properties could be the key to achieving proper PFAS selectivity. For example, the electrostatic interactions could be more influential for the adsorption of short-chain PFAS compared to long-chain due to the decreased hydrophobicity of these compounds.

It has been realized in the context of this disclosure that adsorbent materials such as ceramic materials (e.g., functionalized with functional groups) can offer a cost-effective alternative to polymer-based ion exchange resins. In some instances, the use of ceramic-based materials such as the ceramic particles described herein can circumvent adverse effects (e.g., co-contaminants, fouling) of the organic polymer backbone used in commercial ion exchange resins. Furthermore, in some embodiments, adsorbent materials described in this disclosure can offer tunable properties such as functional group type and loading, pore size, swelling, and/or form factor.

Additionally, one of the most important challenges in the field of contaminant removal (e.g., PFAS capture) is how to destroy the contaminant following capture. While disposal through incineration and/or regeneration is possible, additional unwanted waste streams containing the contaminant (e.g., PFAS or metals) are generated. Other destructive options include electrochemical oxidation, plasma treatment, and sonolysis.

It has been determined in the context of this disclosure that a different type of technique, mechanochemical treatment, can be used to destroy contaminant-amended adsorbent materials (e.g., PFAS-amended resin). For example, in some instances adsorbent materials comprising ceramic (e.g., ceramic particles) for capturing contaminants are relatively brittle. Brittle materials may be more amenable to mechanochemical treatment (e.g., ball-milling) than current commercial polymer-based resins. In some embodiments, systems and methods for employing mechanochemical treatment of captured target species such as PFAS are provided.

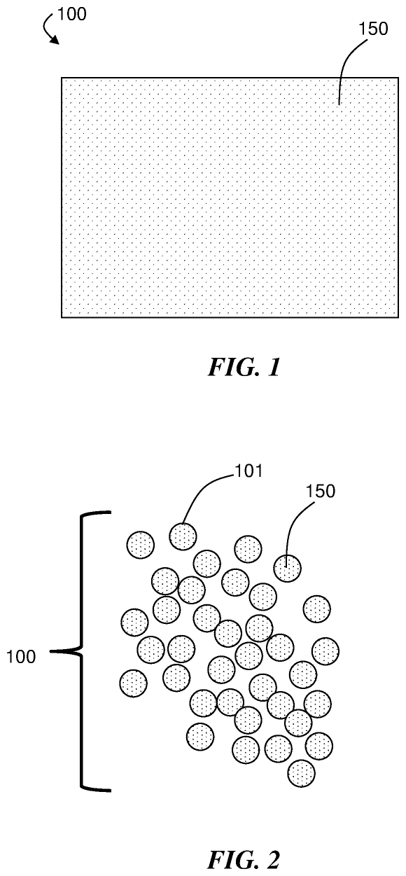

In one aspect, adsorbent materials (e.g., for capturing and/or destroying target species) are provided. FIG. 1 illustratively shows a schematic cross-sectional illustration of adsorbent material 100, according to some embodiments. The adsorbent material may be configured to capture target species from fluid mixtures. For example, the adsorbent material may have chemical or physical properties that promote the formation of attractive interactions between the target species and a surface of the adsorbent material. Such attractive interactions might be specific and/or non-specific. For example, the attractive interactions between the adsorbent material and the target species may include chemisorption, physisorption, dispersion forces, van der Waals forces, electrostatic forces, hydrophobic interactions, hydrophilic interactions, fluorophilic interactions, hydrogen bonding, and/or chemical bond formation (e.g., covalent bond formation, ionic bond formation).

The adsorbent material have any of a variety of suitable form factors. The form factor of the adsorbent material may be chosen based on the type of application. For example, in some embodiments, it may be advantageous for the adsorbent material to be in the form of particles to promote favorable adsorption kinetics for target species. FIG. 2 shows an embodiment of adsorbent material 100 in which adsorbent material 100 is in the form of particles 101. In some embodiments, the particles comprise anisotropic particles. In some embodiments, the particles comprise isotropic particles. In some instances, the adsorbent material may be in the form of a resin. In some embodiments, the adsorbent material is in the form of beads (e.g., isotropic beads). In some instances the particles are free particles. It should be understood that free particles are not immobilized with respect to each other (e.g., via adhesives, binder materials or dispersion matrices). However, free particles would still be considered to be free even in a packed state (e.g., when constrained by exterior forces) because they would be able to move freely in the absence of exterior forces. However, in some instances the particles are part of a fixed structure (e.g., as part of a composite such particles dispersed in a continuous phase material). Further details of particulate embodiments are described in more detail below. In some embodiments the adsorbent material is not in particulate form. For example, the adsorbent material may be a layer of material on a solid substrate (e.g., as a coating). As another example, in some embodiments, the adsorbent material comprises a membrane. It should be understood that the figures shown herein are illustrative and that the adsorbent materials and other components described may have other suitable form factors, shapes, sizes, and configurations.

In some embodiments, the adsorbent material comprises a ceramic. For example, in FIG. 1 adsorbent material 100 comprises ceramic 150, according to some embodiments. In some embodiments, the adsorbent material comprises ceramic particles. For example, in FIG. 2, particles 101 may be ceramic particles comprising ceramic 150. Any of a variety of ceramics may be employed with the adsorbent material. A ceramic, as is generally known in the art, refers to an inorganic, non-metallic oxide, nitride, and/or carbide material, and is typically relatively brittle, has a relatively high density, has a relatively high hardness, and/or has a relatively high melting point.

The ceramic may comprise a metal and/or metalloid. For example, the ceramic may comprise an oxide of a metal and/or a metalloid. Any of a variety of metal and/or metalloids may be employed in the ceramic. For example, the metal and/or metalloid may be silicon (Si), aluminum (Al), titanium (Ti), or zirconium (Zn). It should be understood that the ceramic may comprise more than one different type of metal and/or metalloid. For example, the ceramic may comprise a combination of two or more of Si, Al, Ti, or Zn.

In some embodiments, the ceramic comprises a silica-based ceramic. A silica-based ceramic may be a ceramic comprising predominantly a network of silica (SiO₂), though the silica-based ceramic can include groups (e.g., terminal moieties) not described by the SiO₂ formula. For example, in some embodiments, the silica-based ceramic comprises a network a silica comprising terminal hydroxy groups, terminal organic groups, and/or terminal functional groups (e.g., ion exchange functional groups or fluorocarbon functional groups). In some embodiments, a relatively high percentage (e.g., greater than or equal to 10 mol %, greater than or equal to 25 mol %, greater than or equal to 50 mol %, greater than or equal to 60 mol %, greater than or equal to 75 mol %, greater than or equal to 80 mol %, greater than or equal to 85 mol %, greater than or equal to 90 mol %, greater than or equal to 92 mol %, greater than or equal to 95 mol %, greater than or equal to 98 mol %, greater than or equal to 99 mol %, or 100 mol %; and/or less than or equal to 100 mol %, less than or equal to 99 mol %, less than or equal to 98 mol %, less than or equal to 95 mol %, less than or equal to 90 mol %, or less) of the Si atoms in the silica-based ceramic are in a tetrahedral environment and are bound to either an oxygen, a hydroxy group, or a functional group as described below. In some embodiments, the ceramic comprises a titania-based ceramic. A titania-based ceramic may be a ceramic comprising predominantly a network of titania (TiO₂), though the titania-based ceramic can include groups (e.g., terminal moieties) not described by the TiO₂ formula. For example, in some embodiments, the titania-based ceramic comprises a network of titania comprising terminal hydroxy groups, terminal organic groups, and/or terminal functional groups (e.g., ion exchange functional groups or fluorocarbon functional groups). In some embodiments, a relatively high percentage (e.g., greater than or equal to 10 mol %, greater than or equal to 25 mol %, greater than or equal to 50 mol %, greater than or equal to 60 mol %, greater than or equal to 75 mol %, greater than or equal to 80 mol %, greater than or equal to 85 mol %, greater than or equal to 90 mol %, greater than or equal to 92 mol %, greater than or equal to 95 mol %, greater than or equal to 98 mol %, greater than or equal to 99 mol %, or 100 mol %; and/or less than or equal to 100 mol %, less than or equal to 99 mol %, less than or equal to 98 mol %, less than or equal to 95 mol %, less than or equal to 90 mol %, or less) of the Ti atoms in the titania-based ceramic are in a 6-coordinate environment and are bound to either an oxygen, a hydroxy group, or a functional group as described below. Analogously, in some embodiments, the ceramic comprises an alumina-based ceramic. In some embodiments, the ceramic comprises a zirconia-based ceramic.

In some embodiments, the metal and/or metalloid (e.g., Si, Al, Ti, and/or Zn) is present in a relatively high amount in the silica-based ceramic. The metal and/or metalloid (e.g., Si, Al, Ti, and/or Zn) may be present in a relatively high amount in the silica-based ceramic due to the ceramic being predominantly metal or metalloid oxide-based, rather than having a relatively high percentage of other components, such as a polymer matrix. In some embodiments, the ceramic comprises the metal and/or metalloid (e.g., Si, Al, Ti, and/or Zn) in an amount of greater than or equal to 6 weight percent (wt %), greater than or equal to 10 wt %, greater than equal to 12 wt %, greater than or equal to 15 wt %, greater than or equal to 17 wt %, greater than or equal to 20 wt %, greater than or equal to 24 wt %, greater than or equal to 30 wt %, greater than or equal to 40 wt %, or more in the ceramic. In some embodiments, the ceramic comprises the metal and/or metalloid (e.g., Si, Al, Ti, and/or Zn) in an amount less than or equal to 60 wt %, less than or equal to 50 wt %, less than or equal to 47 wt %, less than or equal to 40 wt %, less than or equal to 30 wt %, less than or equal to 28 wt %, less than or equal to 26 wt %, less than or equal to 24 wt %, less than or equal to 22 wt %, less than or equal to 20 wt %, less than or equal to 17 wt %, or less in the ceramic. Combinations of these ranges are possible. For example, in some embodiments, the ceramic comprises the metal and/or metalloid (e.g., Si, Al, Ti, and/or Zn) in an amount greater than or equal to 6 wt % and less than or equal to 60 wt %, or greater than or equal to 11 wt % and less than or equal to 26 wt % in the ceramic.

In some embodiments, the ceramic comprises the metal and/or metalloid (e.g., Si, Al, Ti, and/or Zn) in an amount of greater than or equal to 1.5 mole percent (mol %), greater than or equal to 2.8 mol %, greater than or equal to 3 mol %, greater than or equal to 5 mol %, greater than or equal to 8 mol %, greater than or equal to 10 mol %, greater than or equal to 12 mol %, greater than or equal to 15 mol %, greater than or equal to 18 mol %, greater than or equal to 20 mol %, or more in the ceramic. In some embodiments, the ceramic comprises the ceramic comprises the metal and/or metalloid (e.g., Si, Al, Ti, and/or Zn) in an amount less than or equal to 35 mol %, less than or equal to 33.4 mol %, to 30 mol %, less than or equal to 28 mol %, less than or equal to 26 mol %, less than or equal to 24 mol %, less than or equal to 22 mol %, less than or equal to 20 mol %, less than or equal to 18 mol %, or less in the ceramic. Combinations of these ranges are possible. For example, in some embodiments, the ceramic comprises the metal and/or metalloid (e.g., Si, Al, Ti, and/or Zn) in an amount greater than or equal to 1.5 mol % and less than or equal to 35 mol %, greater than or equal to 1.5 mol % and less than or equal to 33.4 mol %, greater than or equal to 8 mol % and less than or equal to 20 mol %, greater than or equal to 2.8 mol % and less than or equal to 18 mol %, or greater than or equal to 12 mol % and less than or equal to 18 mol % in the ceramic.

The weight percentage and mole percentage and molar ratios in the ceramic described above can be determined by directly measuring the ceramic using techniques such as X-ray photoelectron spectroscopy (XPS) or by removing the ceramic from the rest of the adsorbent material if necessary (e.g., removing a coating from a support membrane or particles from a polymer matrix) and performing an elemental analysis, such as inductively coupled plasma mass spectrometry (ICP-MS) or nuclear magnetic resonance (NMR).

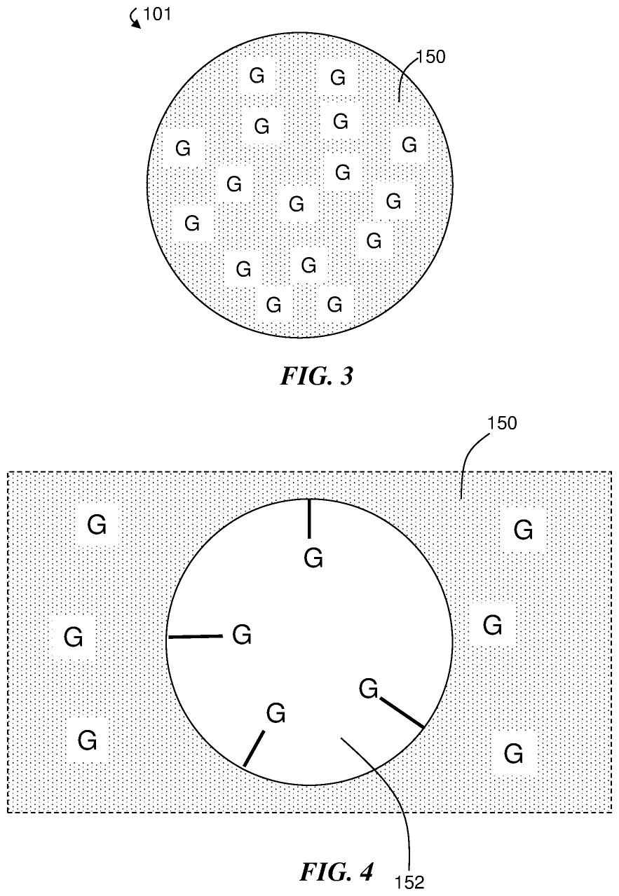

In some embodiments, the ceramic of the adsorbent material comprises particles comprise a functional group. The functional group may facilitate capture of a target species. FIG. 3 shows an adsorbent material in the form of a particle comprising ceramic 150 and functional group G, according to some embodiments. While FIG. 3 shows adsorbent material particle 101 in the form of a spherical particle, it should be understood that any of the possible form factors of the adsorbent material can comprise the functional group (e.g., functional group G). The functional group may be affixed to a surface of the ceramic. For example, the functional group may be covalently bonded to a surface of the ceramic of the adsorbent material. For example, in some embodiments where the adsorbent material comprises ceramic particles, the ceramic particles comprise a functional group covalently bonded to a surface of the ceramic particles. One specific example is where the functional group is part of a terminal moiety of the extended ceramic structure of the ceramic.

In some embodiments where the adsorbent material is configured to capture a target species, the functional group has affinity for the target species. For example, in embodiments where the target species is a fluorine-containing molecule, the functional group may have affinity for the fluorine-containing functional molecule. The affinity between the target species and the functional group may cause the target species to become immobilized with respect to the functional group and therefore the adsorbent material. Immobilization with the functional group is one way for the adsorbent material to capture a target species. Immobilization in this context refers to two objects being resistant or unable to freely move with respect to each other even in the absence of external forces, though it should be understood that attachment (e.g., via a covalent bond) is not necessary for immobilization to occur. For example, immobilization could occur via noncovalent interactions such as van der Waals forces and/or electrostatic forces. A functional group having affinity for the target species may have a relatively high binding constant for the target species. For example, a functional group having affinity for the target species may have a binding constant with the target species of greater than or equal to 0.001 M⁻¹, greater than or equal to 0.01 M⁻¹, greater than or equal to 0.1 M⁻¹, greater than or equal to 1 M⁻¹, greater than or equal to 10 M⁻¹, greater than or equal to 100 M⁻¹, greater than or equal to 1×10³ M⁻¹, greater than or equal to 1×10⁴ M⁻¹, greater than or equal to 1×10⁵ M⁻¹, greater than or equal to 1×10⁶ M⁻¹, greater than or equal to 1×10⁷ M⁻¹, greater than or equal to 1×10⁸ M⁻¹, greater than or equal to 1×10⁹ M⁻¹, or greater. Knowledge of the chemical properties of a target species (e.g., electrostatic charge, hydrophobicity, hydrophilicity, fluorophilicity, polarizability, chemical reactivity) can be used to select suitable functional groups for use in the adsorbent material. For example, if the target species is a fluorine-containing material (as described in more detail below), the adsorbent material may be functionalized with functional groups comprising fluorocarbons to promote capture via fluorophilic interactions and/or hydrocarbons to promote capture via hydrophobic interactions. As another example, if the target species is a metal-containing ion such as a heavy metal ion, the adsorbent material may be functionalized with functional groups carrying a fixed charge (or capable of carrying a charge by protonation or deprotonation) complementary to that of the metal-containing ion to promote capture via electrostatic interactions.

In some embodiments, at least some of the functional groups of the adsorbent material are ion exchange functional groups. For example, in some embodiments, the ceramic particles comprises an exchange functional groups covalently bound to a surface of the ceramic particles. An ion exchange functional group is a functional group that is capable of participating in ion exchange. One of ordinary skill, given the benefit of this disclosure, would understand whether a functional group is capable of participating in ion exchange.

In some embodiments, the ion exchange functional group is an anion exchange functional group. An anion exchange functional group is a functional group that is capable of participating in anion exchange. One of ordinary skill, given the benefit of this disclosure, would understand whether a functional group is capable of participating in anion exchange. For example, the anion exchange functional groups may be functional groups capable of associating and disassociating anions. As one example, in some embodiments, the anion exchange functional groups covalently bound to the ceramic are positively-charged functional groups. The positive charge may allow for an electrostatic attraction between the anion exchange functional group and an anion. In some embodiments, the anion exchange functional groups are functional groups that are neutral (not positively charged or negatively charged) but, upon protonation, have a positive charge (e.g., a neutral base). In some embodiments, the anion exchange functional groups covalently bound to the ceramic are quaternary ammonium groups. In some embodiments, the anion exchange functional groups covalently bound to the ceramic are or comprise imidazole and/or imidazolium groups. The imidazole and/or imidazolium groups may be optionally substituted (e.g., with alkyl groups and/or halo groups bound to the aromatic carbons). In some instances, it may be beneficial for the anion exchange functional groups to be or comprise imidazole and/or imidazolium groups because imidazole and/or imidazolium groups are stable in solutions having a wider range of pH values (including higher pH ranges) than are certain other functional groups, such as quaternary ammonium groups. In some embodiments, the anion exchange functional groups covalently bound to the ceramic are weak base groups such as amine groups (e.g., primary amine groups, secondary amine groups, tertiary amine groups). In some embodiments, the functional group comprises two or more amine and/or ammonium groups. For example, the functional group may be a chelating group comprising multiple amine groups.

In some embodiments, the ion exchange functional group is a cation exchange functional group. A cation exchange functional group is a functional group that is capable of participating in cation exchange. One of ordinary skill, given the benefit of this disclosure, would understand whether a functional group is capable of participating in cation exchange. For example, the cation exchange functional groups may be functional groups capable of associating and disassociating cations. As one example, in some embodiments, the cation exchange functional groups covalently bound to the ceramic are negatively-charged functional groups. The negative charge may allow for an electrostatic attraction between the cation exchange functional group and a cation (e.g., a metal ion). In some embodiments, the cation exchange functional groups are functional groups that are neutral (not positively charged or negatively charged) but, upon deprotonation, have a negative charge (e.g., a neutral Brönsted-Lowry acid). In some embodiments, the functional groups covalently bound to the ceramic are acid-base functional groups. For example, in some embodiments, the functional groups covalently bound to ceramic are sulfonate (—SO₃⁻) and/or sulfonic acid (—SO₃H) groups. In some embodiments, the cation exchange functional groups covalently bound to the ceramic are phosphate (—O—PO₃Hₙⁿ⁻²; n is 0 or 1) and/or phosphoric acid (—O—PO₃H₂) groups. In some embodiments, the cation exchange functional groups covalently bound to the ceramic are carboxylate and/or carboxylic acid groups. In some embodiments, the cation exchange functional groups covalently bound to the ceramic are phosphonate (—R—PO₃Hₙⁿ⁻²; n is 0 or 1; R is branched or branched, optionally substituted or unsubstituted alkyl or aryl) groups and/or phosphonic acid (—R—PO₃H₂; R is branched or branched, optionally substituted or unsubstituted alkyl or aryl) groups.

In some embodiments, the functional group of the adsorbent material comprises a hydrophobic moiety. The presence of hydrophobic moieties on the adsorbent material (e.g., on the surface of the ceramic) can promote capture of target species comprising hydrophobic moieties such as fluorine-containing molecules (e.g., via hydrophobic interactions). In some embodiments, the functional group of the adsorbent material comprises an aliphatic group. For example, the functional group may comprise an alkyl group, an alkenyl group, an alkynyl group, and/or a carbocyclyl group. In some embodiments, the functional group comprises an optionally substituted branched or unbranched C₁-C₁₈ alkyl group. In some embodiments, the functional group comprises an optionally substituted branched or unbranched C₁-C₈ alkyl group. In some embodiments, the functional group comprises an aryl group (e.g., a phenyl group).

In some embodiments, the functional group of the adsorbent material comprises a fluorine-containing moiety. For example, the functional group may comprise a fluorine-containing organic moiety. As a specific example, the functional group may comprise a fluorocarbon. The presence of fluorine-containing moieties on the adsorbent material (e.g., on the surface of the ceramic) can promote capture of fluorine-containing molecules (e.g., via fluorophilic interactions). As such, in some embodiments where capture of fluorine-containing molecules such as PFAS, the ceramic particles may be functionalized with fluorine-containing moieties. In some embodiments, the functional group comprises a fluoroaliphatic group. For example, the functional group may comprise a perfluoroaliphatic group. As one example, the functional group may comprise a fluoroalkyl group such as a C₁-C₁₈ fluoroalkyl group. In some embodiments, the functional group comprises a C₁-C₁₈ perfluoroalkyl group. In some embodiments, the functional group comprises a fluoroaryl groups (e.g., a perfluoroaryl group).

The functional groups may be bound to the metal and/or metalloid of the ceramic (e.g., Si, Al, Ti, and/or Zn) ceramic via a linking group (e.g., an organic linking group). For example, in the case of quaternary ammonium groups the nitrogen of the quaternary ammonium groups may be covalently bound to the metal and/or metalloid in the ceramic via an organic linker such as a linker chosen from optionally-substituted or unsubstituted C₁₋₁₈ alkylene and arylene (or C₁₋₈ alkylene and arylene, or C₁₋₄ alkylene and arylene). It should be understood that in the present disclosure, any description of an item being “chosen from” a list of items can be replaced with a description of an item being selected from a “group consisting of” those items. For example, in some embodiments, the nitrogen of the quaternary ammonium groups or an aromatic carbon of the imidazole and/or imidazolium groups may be covalently bound to the metal and/or metalloid in the ceramic via an organic linker such as a linker selected from the group consisting of optionally-substituted or unsubstituted C₁₋₁₈ alkylene and arylene.

The adsorbent material may comprise multiple different functional groups (e.g., covalently bound to the ceramic). Having multiple different functional groups may allow for leveraging groups with affinity for different portions of the target species, or different molecules within a group of target species. For example, some target species (such as some PFAS) may comprise a hydrophilic head group (e.g., a carboxylate or sulfonate) and a hydrophobic tail groups (e.g., a fluorocarbon). In some such instances, it can be advantageous to have a subset of the functional groups of the adsorbent material comprising hydrophilic functional groups such as electrostatically charged groups, and a different subset of the functional groups comprising hydrophobic functional groups such as aliphatic groups or fluoroaliphatic groups, which could increase the chances that a particular interaction between the target species and the adsorbent material leads to capture. In some embodiments where the adsorbent material comprises ceramic particles, some of the particles may comprises different types of functional groups on the surface of the same particle. In some such embodiments, at least some of the ceramic particles comprise a first functional group covalently bound to the ceramic and a second, different functional group covalently bound to the ceramic. Ceramic particles having multiple different functional groups may be prepared using any of a variety of techniques. For example, such particles may be formed by the co-condensation of different ceramic precursor molecules such as silanes functionalized with the different functional groups. As another example, such particles may be formed by first producing ceramic particles comprising the first functional group (e.g., at least partially or completely dried functionalized ceramic particles). Then, the ceramic particles comprising the first functional group can be exposed to functionalized silicon-containing precursors comprising the second functional group (e.g., a silane functionalized with the second functional group) under conditions promoting reaction between the ceramic particles and the precursors (e.g., by exposing the ceramic particles to a liquid solution comprising the functionalized silicon-containing precursor having the second functional group mixed with a solvent (e.g., an alcohol such as ethanol) and/or an acid (e.g., acetic acid) at room temperature or at elevated temperatures (e.g., greater than or equal to 40° C.)).

Alternatively, different functional groups may be on different particles within the adsorbent material. For example, in some embodiments, the adsorbent material comprises a first subset of the ceramic particles each comprising a first functional group covalently bound to the ceramic, and a second subset of the ceramic particles each comprising a second, different functional group covalently bound to the ceramic. As a particular example, in some embodiments, the adsorbent material comprises a first subset of silica-based ceramic particles comprising anion exchange groups such as quaternary ammonium groups covalently bound to the silica-based ceramic, and a second subset of silica-based ceramic particles comprising fluorocarbon functional groups covalently bound to the silica-based ceramic.

As mentioned above, the porous adsorbent material may comprise a first functional group and a second functional group (e.g., each covalently bound to the same ceramic particle or each covalently bound to separate ceramic particles). The first functional group may be any of the functional groups described above and below (e.g., an ion exchange functional group such as an anion exchange functional group or a cation exchange functional group). In some embodiments, the first functional group comprises an ion exchange group and the second functional group comprises a second, different ion exchange group. In some embodiments, the first functional group comprises an ion exchange group (e.g., a cation exchange group such as a sulfonate and/or sulfonic acid). In some embodiments, the second functional group comprises an amine group (e.g., a single amine group such as a primary amine or multiple amine groups). In some embodiments, the first functional group comprises a sulfonate group and/or sulfonic acid group and the second functional group comprises an amine group. In some embodiments, the second functional group comprises a chelating group, which in this context refers to a moiety comprising two or more groups that can donate a pair of electrons to coordinate to a metal. For example, a chelating group may comprise two or more groups chosen from amine, carbonyl, thiol, and/or carboxylate. In some embodiments, the second functional group comprises ethylenediamine triacetic acid (e.g., bound to a silicon atom). Such a functional group could be incorporated via use of a functionalized silicon-container precursor such as N-(triethoxysilylpropyl)ethylenediamine, triacetic acid. In some embodiments, the second functional group comprises N-(2-aminoethyl)-3-aminopropyl (e.g., bound to a silicon atom). Such a functional group could be incorporated via use of a functionalized silicon-container precursor such as N-(2-aminoethyl)-3-aminopropyltriethoxysilane. In some embodiments, the first functional group comprises a sulfonate group and/or sulfonic acid group and the second functional group comprises a chelating group. In some embodiments, the second functional group comprises an iminodiacetic acid group, a salicylaldehyde Schiff base group, an imidazole group, a bispicolylamine group, and/or an aminoalkyl (e.g., aminomethyl) phosphonic group. It has been observed and determined in the context of this disclosure that in some embodiments, combinations of first functional groups and second functional groups as described in this disclosure can promote improved performance in capturing target species such as metal and/or metalloid ions.

FIG. 4 is a schematic illustration of functional groups represented by “G” covalently bound to a ceramic 150, according to some embodiments. As shown illustratively in this figure, the functional groups G are covalently attached to the interior portions of the ceramic material. In some embodiments, the functional groups (e.g., anion exchange functional group, cation exchange functional group, hydrophobic functional group, fluorophilic functional group) are exposed at an exterior surface of the ceramic (e.g., the exterior surface of a ceramic particle). In some cases, the functional groups covalently bound to the ceramic are exposed at surfaces of pores in ceramic. For example, in FIG. 4, cation exchange functional groups G covalently bound to ceramic 150 are shown exposed at a surface of a pore 152 of the ceramic. Functional groups present at the surface of pores of the ceramic may, in some embodiments, allow for relatively efficient capture of target species such as fluorine-containing molecules and/or metal and/or metalloid-containing ions.

One of ordinary skill in the art would understand that the relative amount of the conjugate acid of a functional group covalently bound to the ceramic compared to the amount of conjugate base of the functional group present at any given time will depend on the conditions and environment of the adsorbent material. For example, in embodiments where the functional group is an imidazole or an amine (e.g., a tertiary amine), the relative number of imidazolium vs. imidazole or ammonium vs. amine groups will depend at least in part on the pH of any solution with which adsorbent material is in contact, the pKₐ of other functional groups if present, and/or the concentration of counterions in any solution with which the adsorbent material is in contact.

As mentioned above, in some embodiments, the ceramic (e.g., of the ceramic particles) has a relatively high loading of functional groups. For example, in some embodiments, the ceramic may have a relatively high loading of anion exchange functional groups such as quaternary ammonium groups. As another example, in some embodiments, the ceramic may have a relatively high loading of cation exchange functional groups such as sulfonate and/or sulfonic acid groups. As yet another example, in some embodiments the ceramic may have a relatively high loading of fluorocarbon-containing functional groups such as fluoroalkyl groups. Having a relatively high loading of functional groups may, at least in part, lead to beneficial performance characteristics of the adsorbent material. For example, a high loading of functional groups may contribute to a relatively high ion exchange capacity and/or target species adsorption density. Some methods described herein, such as some sol-gel techniques involving condensation and functionalization of metal and/or metalloid-containing precursors may provide loadings of functional groups that are otherwise challenging to achieve using certain existing techniques.

In some embodiments, functional groups (e.g., anion exchange functional groups, cation exchange functional groups, hydrophobic groups, fluorophilic groups) are present in the ceramic in an amount of greater than or equal to 0.01 mmol, greater than or equal to 0.05 mmol, greater than or equal 0.1 mmol, greater than or equal to 0.3 mmol, greater than or equal to 0.5 mmol, greater than or equal to 0.7 mmol, greater than or equal to 1 mmol, greater than or equal to 2 mmol, greater than or equal to 3 mmol or more per gram of the ceramic. In some embodiments, functional groups are present in the ceramic in an amount of less than or equal to 10 mmol, less than or equal to 5 mmol, or less per gram of the ceramic. Combinations of these ranges are possible. For example, in some embodiments, functional groups are present in the ceramic in an amount of greater than or equal to 0.01 mmol and less than or equal to 10 mmol per gram, or greater than or equal to 0.1 mmol and less than or equal to 10 mmol per gram of the ceramic. It should be understood that the loadings described herein refer to the total sum of functional groups, regardless of, for example, protonation state or whether it is associated with a counterion. For example, if the functional groups are quaternary ammonium groups, then the loading of quaternary ammonium groups is the sum of quaternary ammonium cations (i.e., a charged group) and quaternary ammonium salts (i.e., neutral groups comprising anion exchange functional groups associated with anions). For example, if the ceramic of the adsorbent material included 0.1 mmol of free quaternary ammonium cations and 0.3 mmol of quaternary ammonium groups associated with anions per gram of the ceramic, the quaternary ammonium groups would be present in the ceramic in an amount of 0.4 mmol per gram of the ceramic. The loading of ion exchange functional groups within the ceramic of the adsorbent material can be determined by performing the measurement of the anion or cation exchange capacity of the ceramic as described below, and taking the number of chloride ions measured in solution (as determined by the titration) as being equal to the number of anion exchange functional groups in the anion exchange membrane and the number of sodium ions measured in solution (as determined by the titration) as being equal to the number of cation exchange groups. The loading of ion exchange groups can then be determined using that number of anion and cation exchange functional groups (in mmol) and dividing by the weight of the ceramic of the dried adsorbent material (in g). It should be understood that the above quantities and measurements for the loading of ion exchange functional groups refers to accessible ion exchange functional groups, and not to ion exchange functional groups that are inaccessible to solvent and ions (e.g., ion exchange functional groups trapped in enclosed pores that cannot be contacted by solvent or anions). The loading of other types of functional groups such as fluorocarbon functional groups can be determined by, for example, nuclear magnetic resonance combining fluorine-19 NMR and silicon-29 NMR, or by conducting fluorine elemental analysis (e.g., via oxygen flask combustion or pyrohydrolysis).

Ceramic materials covalently bound to functional groups as disclosed above may be prepared using any of a variety of techniques. In some embodiments, the ceramic is sol-gel derived. Non-limiting but exemplary processes and reagents for preparing at least some sol-gel derived functionalized silica-based ceramics (and their structures and properties) are described in U.S. Patent Publication No. 2020-0384421, published on Dec. 10, 2020 and entitled “Ceramic Cation Exchange Materials,” and in U.S. Patent Publication No. 2020-0388871, published on Dec. 10, 2020 and entitled “Ceramic Anion Exchange Materials,” are each incorporated herein by reference in its entirety for all purposes. With the benefit of these publications and this disclosure, one can analogously prepare sol-gel derived functionalized titania-based ceramics, alumina-based ceramics, and/or zirconia-based ceramics.

In some embodiments, the sol used in the sol-gel techniques is a metal and/or metalloid-containing precursor sol (i.e., the ceramic is derived from a metal and/or metalloid-containing precursor sol). For example, in the case of silica-based ceramic, the ceramic may be derived from a silicon-containing precursor. The silicon-containing precursor sol may comprise any of a variety of suitable silicon-containing precursor components, such as silica colloidal particles, siloxanes, silicate esters, silanols, silanes, alkoxysilanes, tetraalkyl orthosilicates, halosilanes, or combinations thereof. As another example, in the case of titania-based ceramic, the ceramic may be derived from a titanium-containing precursor. The titanium-containing precursor sol may comprise any of a variety of suitable titanium-containing precursor components, such as titania colloidal particles, titanium(IV) alkoxides, or combinations thereof. In some embodiments, the ceramic is derived from a metal and/or metalloid-containing precursor sol containing two or more different metal and/or metalloid-containing precursor components. In some such cases, the ceramic is formed via a co-condensation of two or more metal and/or metalloid-containing precursor components (e.g., two or more different silanes or substituted silanes, two or more different titanium (IV) alkoxides or substituted titanium (IV) alkoxides).

In some embodiments, the metal and/or metalloid-containing precursor sol from which the ceramic is derived comprises a metal and/or metalloid-containing precursor comprising a functional group (e.g., any of the functional groups G described above) or a moiety comprising a leaving group (e.g., a halo group). In some embodiments, the ceramic is derived from the co-condensation of a metal and/or metalloid-containing precursor comprising a functional group (e.g., any of the functional groups G described above) or a moiety comprising a leaving group (e.g., a halo group). In some embodiments, the ceramic is derived from a mixture comprising a compound having the structure (I):

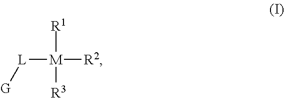

wherein each of R¹, R², and R³ are independently chosen from optionally-substituted or unsubstituted C₁₋₁₈ alkoxy and halo, L is chosen from optionally-substituted or unsubstituted C₁₋₁₈ alkylene and arylene, M is the metal and/or metalloid (e.g., Si, Al, Ti, Zn) and G comprises the functional group (e.g., any of the ion exchange functional groups, hydrophobic functional groups, and/or fluorophilic functional groups described above). In some embodiments, L is chosen from optionally-substituted or unsubstituted C₁₋₈ alkylene and arylene.

In some embodiments, the ceramic is derived from a mixture comprising a compound having the structure (II):

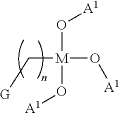

where A¹ is independently chosen from hydrogen, methyl, ethyl, propyl, or butyl, n is greater than or equal to 1 and less than or equal to 18, M is the metal and/or metalloid (e.g., Si, Al, Ti, Zn), and G comprises the functional group (e.g., any of the ion exchange functional groups, hydrophobic functional groups, and/or fluorophilic functional groups described above). In some embodiments, n is greater than or equal to 1 and less than or equal to 8.

As one example, in some embodiments, the silica-based ceramic is derived from a mixture (e.g., a silicon-containing precursor sol) comprising 3-(trihydroxysilyl)-1-alkanesulfonic acid.

As another example, in some embodiments, the silica-based ceramic is derived from a mixture (e.g., a silicon-containing precursor sol) comprising trimethoxysilylpropyl-N,N,N-trimethylammonium (TMAPS). As another example, in some embodiments, the silica-based ceramic is derived from a mixture (e.g., a silicon-containing precursor sol) comprising triethoxysilylpropyl-N,N,N-trimethylammonium (TEAPS).

As another example, in some embodiments, the silica-based ceramic is derived from a mixture (e.g., a silicon-containing precursor sol) comprising nonafluorohexyltriethoxysilane. As another example, in some embodiments, the silica-based ceramic is derived from a mixture (e.g., a silicon-containing precursor sol) comprising (tridecafluoro-1,1,2,2-tetrahydrooctyl)triethoxysilane. As another example, in some embodiments, the silica-based ceramic is derived from a mixture (e.g., a silicon-containing precursor sol) comprising n-octyltriethoxysilane. As another example, in some embodiments, the silica-based ceramic is derived from a mixture (e.g., a silicon-containing precursor sol) comprising hexadecyltriethoxysilane. As another example, in some embodiments, the silica-based ceramic is derived from a mixture (e.g., a silicon-containing precursor sol) comprising 1H,1H, 2H,2H-perfluorooctyltriethoxysilane.

In some embodiments, the metal and/or metalloid-containing precursor component comprises a leaving group instead of functional group G. The leaving group may be later replaced with a functional group via a reaction performed after formation of sol-gel. As one example, in some embodiments, a silica-based ceramic is derived from a mixture (e.g., a silicon-containing precursor sol) comprising (3-chloropropyl)triethoxysilane (3CPTES). The resulting silica-based ceramic derived from the above-mentioned leaving group-containing compounds may, in some cases, be reacted with an amine to form a quaternary ammonium group, as described in more detail below.

In some embodiments, the silica-based ceramic is derived from a mixture (e.g., a silicon-containing precursor sol) comprising a tetraalkyl orthosilicate such as tetraethyl orthosilicate (TEOS) and/or a tetraalkyl orthosiloxane such as tetraethyl orthosiloxane. In some embodiments, the silica-based ceramic is derived from a single-phase mixture (e.g., a single-phase silicon-containing precursor sol) comprising a tetraalkyl orthosilicate (e.g., TEOS) and a functional group-containing silicon-containing precursor component such as any of those described above (e.g., having structure (I) or (II). In some embodiments, the silica-based ceramic is derived from a mixture (e.g., a silicon-containing precursor sol) comprising two or more precursors. For instance, in some embodiments, the silica-based ceramic is derived from a mixture comprising a tetraalkyl orthosilicate (e.g., TEOS) and a functional-group containing silicon-containing precursor component such as any of those described above (e.g., having structure (I) or (II)) in a tetraalkyl orthosilicate:functional group-containing silicon-containing precursor component mass ratio of less than or equal to 99:1, less than or equal to 95:5, less than or equal to 90:10, less than or equal to 85:15, less than or equal to 80:20, less than or equal to 75:25, less than or equal to 70:30, less than or equal to 65:35, less than or equal to 60:40, or less. In some embodiments, the silica-based ceramic is derived from a mixture comprising a tetraalkyl orthosilicate (e.g., TEOS) and a functional-group containing silicon-containing precursor component such as any of those described above (e.g., having structure (I) or (II)) in a tetraalkyl orthosilicate:functional group-containing silicon-containing precursor component mass ratio of greater than or equal to 50:50, greater than or equal to 55:45, greater than or equal to 60:40, greater than or equal to 65:35, greater than or equal to 70:30, or greater. Combinations of these ranges are possible (e.g., greater than or equal to 50:50 and less than or equal to 99:1, greater than or equal to 60:40 and less than or equal to 90:10, or greater than or equal to 70:30 and less than or equal to 80:20). Having a relatively high mass ratio of the tetraalkyl orthosilicate to the functional-group containing silicon-containing precursor component can, in some instances, reduce or prevent dissolution during sol-gel formation.

In some embodiments, the ceramic is derived from a mixture (e.g., a metal and/or metalloid-containing precursor sol) comprising an aqueous solution having a certain pH, depending on the desired chemistry to be used. In some embodiments, the aqueous solution may have a pH of greater than or equal to −1, greater than or equal to 0, greater than or equal to 1, greater than or equal to 2, greater than or equal to 3, greater than or equal to 4, greater than or equal to 5, greater than the 6, greater than or equal to 7, greater than or equal to 8, greater than or equal to 9, or higher. In some embodiments, the aqueous solution may have a pH of less than or equal to 14, less than or equal to 13, less than or equal to 12, less than or equal to 11, less than or equal to 10, less than or equal to 9, less than or equal to 8, less than or equal to 7, less than or equal to 6, less than or equal to 5, less than or equal to 4, less than or equal to 3, or less. Combinations of these ranges are possible. For example, in some embodiments, the aqueous solution has a pH of greater than or equal to −1 and less than or equal to 14, greater than or equal to 0 and less than or equal to 7, or greater than or equal to 1 and less than or equal to 3. In some cases, having a relatively acidic pH (e.g., a pH of between 1-3) may allow for certain condensation and hydrolysis reactions to occur during fabrication of the adsorbent material involving the conversion of a sol-gel into a ceramic. In some embodiments, the ceramic is derived from a mixture described above (e.g. a metal and/or metalloid-containing precursor sol) containing one or more acids such as, but not limited to, HCl, H₃PO₄, H₂SO₄, or HNO₃.

In some embodiments, the adsorbent material undergoes relatively little volumetric expansion when exposed to liquid (e.g., water and/or organic liquids). Such a resistance to volumetric expansion (e.g., swelling) upon exposure to liquid may be advantageous in some application, such as those where swelling can cause mechanical stresses that cause system failure and/or reduced selectivity for target species capture. Volumetric expansion with respect to a liquid can be tested by packing a known volume of dry adsorbent material into a vessel such as a graduated cylinder, adding a known volume of liquid to the vessel and agitating to promote mixing, allowing the mixture to rest for 5 minutes, and recording the overall volume of the mixture, with the difference in overall volume and the sum of the add adsorbent material and liquid corresponding to the amount of volumetric expansion of the adsorbent material. In some embodiments, upon exposure to a liquid, the adsorbent material does not undergo a volume expansion or undergoes a volume expansion by a factor of less than 1.5, less than or equal to 1.3, less than or equal to 1.2, less than or equal to 1.1, less than or equal to 1.05, less than or equal to 1.01, or less. In some embodiments, upon exposure to water, the adsorbent material does not undergo a volume expansion or undergoes a volume expansion by a factor of less than 1.5, less than or equal to 1.3, less than or equal to 1.2, less than or equal to 1.1, less than or equal to 1.05, less than or equal to 1.01, or less. In some embodiments, upon exposure to any organic liquid or mixture thereof, the adsorbent material does not undergo a volume expansion or undergoes a volume expansion by a factor of less than 1.5, less than or equal to 1.3, less than or equal to 1.2, less than or equal to 1.1, less than or equal to 1.05, less than or equal to 1.01, or less.

In some embodiments, the ceramic is relatively free of metal or metalloids being bridged via organic groups such as alkylene groups or alkylene groups. It has been realized in the context of this disclosure that the presence of bridging organic groups such as alkylene groups or arylene groups may contribute to undesirable swelling of the adsorbent material (e.g., upon exposure to liquid). In some embodiments, the ceramic (e.g., ceramic particles) are free of any metal or metalloid atoms (e.g., Si, Al, Ti, Zn) bound to any other metal or metalloid atoms via a linkage comprising an arylene group or comprises metal or metalloid atoms (e.g., Si, Al, Ti, Zn) bound to other metal or metalloid atoms via a linkage comprising an arylene group in an amount of less or equal to 50 mol %, less or equal to 40 mol %, less or equal to 30 mol %, less or equal to 20 mol %, less or equal to 15 mol %, less or equal to 10 mol %, less or equal to 5 mol %, less or equal to 3 mol %, less or equal to 2 mol %, less or equal to 1 mol %, less or equal to 0.5 mol %, less or equal to 0.2 mol %, less or equal to 0.1 mol %, less or equal to 0.05 mol %, less or equal to 0.02 mol %, less or equal to 0.01 mol %, or less of the metal or metalloid atoms in the ceramic particles. In some embodiments, the ceramic (e.g., ceramic particles) are free of any metal or metalloid atoms (e.g., Si, Al, Ti, Zn) bound to any other metal or metalloid atoms via a linkage comprising an alkylene or arylene group or comprises metal or metalloid atoms (e.g., Si, Al, Ti, Zn) bound to other metal or metalloid atoms via a linkage comprising an alkylene group or arylene group in an amount of less or equal to 50 mol %, less or equal to 40 mol %, less or equal to 30 mol %, less or equal to 20 mol %, less or equal to 15 mol %, less or equal to 10 mol %, less or equal to 5 mol %, less or equal to 3 mol %, less or equal to 2 mol %, less or equal to 1 mol %, less or equal to 0.5 mol %, less or equal to 0.2 mol %, less or equal to 0.1 mol %, less or equal to 0.05 mol %, less or equal to 0.02 mol %, less or equal to 0.01 mol %, or less of the metal or metalloid atoms in the ceramic particles. In some embodiments, the ceramic (e.g., ceramic particles) are free of any metal or metalloid atoms (e.g., Si, Al, Ti, Zn) bound to any other metal or metalloid atoms via a linkage comprising an aliphatic, heteroaliphatic, arylene, or heteroarylene group or comprises metal or metalloid atoms (e.g., Si, Al, Ti, Zn) bound to other metal or metalloid atoms via a linkage comprising an aliphatic, heteroaliphatic, arylene, or heteroarylene group in an amount of less or equal to 50 mol %, less or equal to 40 mol %, less or equal to 30 mol %, less or equal to 20 mol %, less or equal to 15 mol %, less or equal to 10 mol %, less or equal to 5 mol %, less or equal to 3 mol %, less or equal to 2 mol %, less or equal to 1 mol %, less or equal to 0.5 mol %, less or equal to 0.2 mol %, less or equal to 0.1 mol %, less or equal to 0.05 mol %, less or equal to 0.02 mol %, less or equal to 0.01 mol %, or less of the metal or metalloid atoms in the ceramic particles. In some embodiments, the ceramic (e.g., ceramic particles) are free of any metal or metalloid atoms (e.g., Si, Al, Ti, Zn) bound to any other metal or metalloid atoms via a linkage comprising an organic group or comprises metal or metalloid atoms (e.g., Si, Al, Ti, Zn) bound to other metal or metalloid atoms via a linkage comprising an organic group in an amount of less or equal to 50 mol %, less or equal to 40 mol %, less or equal to 30 mol %, less or equal to 20 mol %, less or equal to 15 mol %, less or equal to 10 mol %, less or equal to 5 mol %, less or equal to 3 mol %, less or equal to 2 mol %, less or equal to 1 mol %, less or equal to 0.5 mol %, less or equal to 0.2 mol %, less or equal to 0.1 mol %, less or equal to 0.05 mol %, less or equal to 0.02 mol %, less or equal to 0.01 mol %, or less of the metal or metalloid atoms in the ceramic particles. Combinations of these ranges are possible.

In some embodiments, the adsorbent material comprises a plurality of particles. For example, as mentioned above, the adsorbent material may comprise ceramic particles (e.g., comprising the functional group covalently bound to a surface of the ceramic particles). An adsorbent material comprising ceramic particles may be in the form of a resin and/or beads. For example, the adsorbent material may comprise an ion exchange resin comprising the functionalized ceramic particles. In some embodiments, the adsorbent material in the form of particles (e.g., a powder) is formed by mechanically breaking ceramic described herein (e.g., via any suitable technique known in the art, such as milling). The ion exchange material particles may be packed into a vessel such as an ion exchange column and used in any of a variety of applications, including target species capture (e.g., from wastewater). In some embodiments, the particles are sufficiently large to be avoid problems such as hydraulic pressure losses (e.g., in packed beds such as in vessels). In some embodiments, the adsorbent material comprises particles (e.g., ceramic particles) having a mean maximum cross-sectional dimension of greater than or equal to 100 nanometers, greater than or equal to 200 nanometers, greater than or equal to 500 nanometers, greater than or equal to 1 micron, greater than or equal to 2 microns, greater than or equal to 5 microns, or greater. In some embodiments, the adsorbent material comprises particles (e.g., ceramic particles) having a mean maximum cross-sectional dimension of greater than or equal to 10 microns, greater than or equal to 20 microns, greater than or equal to 30 microns, greater than or equal to 50 microns, greater than or equal to 75 microns, greater than or equal to 100 microns, greater than or equal to 150 microns, greater than or equal to 200 microns, greater than or equal to 300 microns, greater than or equal to 400 microns, greater than or equal to 500 microns, greater than or equal to 750 microns, greater than or equal to 1000 microns, greater than or equal to 1200 microns, or greater. In some embodiments, the particles are sufficiently small to promote fast adsorption rates with target species. In some embodiments, the adsorbent material comprises particles (e.g., ceramic particles) having a mean maximum cross-sectional dimension of less than or equal to 3000 microns, less than or equal to 2750 microns, less than or equal to 2500 microns, less than or equal to 2250 microns, less than or equal to 2000 microns, less than or equal to 1750 microns, less than or equal to 1500 microns, less than or equal to 1200 microns, less than or equal to 1000 microns, less than or equal to 750 microns, less than or equal to 500 microns, less than or equal to 400 microns, less than or equal to 300 microns, less than or equal to 200 microns, less than or equal to 150 microns, less than or equal to 100 microns, or less. Combinations of these ranges (e.g., greater than or equal to 10 microns and less than or equal to 3000 microns, greater than or equal to 10 microns and less than or equal to 1500 microns, or greater than or equal to 300 microns and less than or equal to 1200 microns) are possible. For example, in some embodiments, the adsorbent material comprises particles (e.g., ceramic particles) having a mean maximum cross-sectional dimension of greater than or equal to 100 nanometers and less than or equal to 3000 microns. It should be understood that all three-dimensional particles have a maximum cross-sectional dimension regardless of shape, and that for the special case of a spherical particles the maximum cross-sectional dimension corresponds to the diameter. In this context, a mean maximum cross-sectional dimension refers to the arithmetic mean of the maximum cross-sectional dimension of each the particles, which can be determined by examining a statistically representative number of particles using, for example, microscopy such as confocal microscopy or tunneling electron microscopy (TEM), depending on the particle sizes.

In some embodiments, ceramic particles (e.g., covalently bound to the functional group) make up a relatively large percentage of the adsorbent material. This may be due to, in some instances, a lack of binder or dispersion matrix used in some embodiments of the adsorbent material, and may afford relatively efficient target species capture (e.g., a relatively high adsorption density). In some embodiments, the ceramic particles are present in the adsorbent material in an amount of greater than or equal to 25 wt %, greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or greater (e.g., 100 wt %) versus the total weight of the adsorbent material. In some embodiments, the ceramic particles are present in the adsorbent material in an amount of less than or equal to 100 wt %, less than or equal to 99.9 wt %, less than or equal to 98 wt %, less than or equal to 95 wt %, less than or equal to 90 wt %, less than or equal to 75 wt %, less than or equal to 50 wt %, or less versus the total weight of the adsorbent material.

In some embodiments, the ceramic is porous. In some such embodiments, the ceramic is nanoporous (having pores with an average (mean) diameter of less than or equal to 10 nm). The presence of relatively small pores in the ceramic may, in some cases, be advantageous in a number of applications such as electrochemical applications and separation applications. In some embodiments, the presence of relatively small pores in the silica-based membrane ceramic can contribute to a relatively high selectivity of adsorbent material (e.g., due to size exclusion). In some embodiments, the ceramic has an average pore diameter of less than or equal to 1 μm (e.g., less than or equal to 500 nm, less than or equal to 100 nm, or less than or equal to 50 nm). In some cases, the ceramic has an average pore diameter of less than or equal to 10 nm, less than or equal to 8 nm, less than or equal to 6 nm, less than or equal to 5 nm, less than or equal to 3 nm, less than or equal to 2 nm, or less. In some embodiments, the ceramic has an average pore diameter of greater than or equal to 0.25 nm, greater than or equal to 0.4 nm, greater than or equal to 0.6 nm, or greater than or equal to 1 nm. Combinations of these ranges are possible. For example, in some embodiments, the ceramic has an average pore diameter of greater than or equal to 0.25 nm and less than or equal to 1 μm, greater than or equal to 0.25 nm and less than or equal to 10 nm, greater than or equal to 0.4 nanometers and less than or equal to 10 nm, greater than or equal to 0.6 nm and less than or equal to 5 nm, or greater than or equal to 0.6 nm and less than or equal to 2.5 nm.

The average pore diameter of the ceramic may be determined using a small angle X-ray scattering (SAXS) technique. In a suitable SAXS technique, a collimated X-ray beam is focused onto a membrane comprising the ceramic for at least 15 minutes, and the scattering intensity as a function of scattering angle is collected on an image plate. The scattering intensity is integrated to generate a 1-dimensional scattering profile that plots the scattering intensity as a function of the q-vector. Scattering of the membrane can be fit with a sphere-based form factor (e.g., solid or core-shell). In some cases, the sphere-based form factor can include a structure factor (e.g., fractal or hard-sphere interactions). Fitting can be performed in the freely available SASView software. A log-normal distribution on pore size polydispersity is assumed. A 1-D SAXS profile is assumed to be well-fit if the residual between the model and data set (Chi²) is less than or equal to 10, less than or equal to 1, less than or equal 0.5, or less. Certain parameters are held constant during fitting, including SLDₛₒₗᵥₑₙₜ=18.8×10⁻⁶ Å⁻² and SLDₛₚₕₑᵣₑ=0 Å⁻², where SLD is the scattering length density. SAXS fitting can be used to determine the volume fraction of porosity, pore size (e.g., average pore diameter), and polydispersity index of the pore size distribution. Suitable SAXS procedures are described in more detail, for example, in Pedersen, J. S., Analysis of small-angle scattering data from colloids and polymer solutions: modeling and least-squares fitting. Advances in Colloid and Interface Science 1997, 70, 171-210, and in Zemb., T.; Lindner, P., Neutron, X-Rays and Light. Scattering Methods Applies to Soft Condensed Matter. North Holland: 2002, which are incorporated herein by reference in their entirety. The average pore diameter may also be determined using other small angle scattering techniques, such as small angle neutron scattering (SANS).

In some embodiments, the adsorbent material has a relatively large volumetric porosity. The volumetric porosity may depend on the porosity of the ceramic. Having a relatively high volumetric porosity may contribute to certain beneficial performance characteristics of the adsorbent material, such as a cation exchange capacity target species adsorption density. In some embodiments, the adsorbent material has a volumetric porosity of greater than or equal to 1%, greater than or equal to 3%, greater than or equal to 5%, greater than or equal to 10%, greater than or equal to 20%, greater than or equal to 30%, greater than or equal to 40%, or more. In some embodiments, the adsorbent material has a volumetric porosity of less than or equal to 70%, less than or equal to 60%, less than or equal to 50%, less than or equal to 45%, less than or equal to 40%, less than or equal to 35%, less than or equal to 30%, less than or equal to 25%, less than or equal to 15%, or less. Combinations of these ranges are possible. For example, in some embodiments, the adsorbent material has a volumetric porosity of greater than or equal to 1% and less than or equal to 70%, greater than or equal to 5% and less than or equal to 50%, greater than or equal to 10% and less than or equal to 50%, or greater than or equal to 30% and less than or equal to 50%. As mentioned above, these volumetric porosities of the adsorbent material can be determined via fitting of SAXS data of the adsorbent material.

In some embodiments, the adsorbent material (e.g., adsorbent material 100) has a relatively high anion exchange capacity. Having a relatively high anion exchange capacity is generally associated with good performance characteristics for an anion exchange material. The anion exchange capacity of a material such as membrane or resin can be measured using the following procedure. An adsorbent material is soaked in an aqueous solution of sodium chloride (2.0 M) for at least 12 hours, with the sodium chloride solution being exchanged twice with fresh sodium chloride solution during this 12 hour time period. After soaking in the sodium chloride solution, the material is soaked in deionized water for at least 15 minutes, with the deionized water being exchanged twice with fresh deionized water during this 15 minute time period. After soaking in the deionized water, the material is soaked in an aqueous solution containing 1.0 M sodium nitrate for at least 3 hours, with the 1.0 M sodium nitrate solution being exchanged twice with fresh 1.0 M sodium nitrate solution (1.0 M sodium nitrate in otherwise deionized water) during this 3 hour period. The adsorbent material is removed from the sodium nitrate solution and rinsed with deionized water. All of the sodium nitrate solutions as well as the rinse solutions are then combined and titrated with an aqueous solution containing 0.010 M silver nitrate using potassium chromate (0.25 M in the solution) as an indicator. The titration ends when solution changes color from bright yellow to slightly yellow-brown. An autotitrator can be used to perform the titration without the use of an indicator such as potassium chromate, instead using, for example a silver sensing probe. A set of “blank” sodium nitrate solutions that are not exposed to the adsorbent material are used and titrated to determine a baseline chloride ion background for the aqueous solutions. The material is rinsed with deionized water and dried overnight at room temperature (e.g., 25 degrees ° C.). The weight and of the material is recorded following drying step. The anion exchange capacity (AEC) is measured using:

$$A E C = \frac{{V}_{titrant} {C}_{titrant}}{{w}_{dry}}$$

where Vₜᵢₜᵣₐₙₜ is the volume of the silver nitrate titrant added during the titration, corrected for the baseline chloride concentration of the aqueous solutions (Vₜᵢₜᵣₐₙₜ=V_{titrant, material}−V_{titrant, blanks}), Cₜᵢₜᵣₐₙₜ is the concentration of the titrant (0.010 M in this case), and w_{dry} is the weight of the dried material in grams. In this disclosure, anion exchange capacity is reported in units of eq/g, which are equivalents (eq) per unit weight (g, grams). The number of equivalents in a solution refers to the numbers of moles of an ion (e.g., chloride ions) in solution multiplied by the valence of the ions. The above procedure can be used for measuring the anion exchange capacity associated with anion exchange functional groups carrying a fixed charge, such as quaternary ammonium groups. If a material comprises anion exchange functional groups whose charge depends on protonation state (e.g., primary, secondary, or tertiary amine groups), the procedure can be modified by instead immersing 0.5 g of the adsorbent material in a large volume of 1 M HCl (instead of the 2.0 M sodium chloride solution) for 5 hours, followed by filtering, washing in deionized water, and then immersing in 0.5 M sodium hydroxide for 1 day to exchange chloride ions with hydroxide ions. 10 mL of the resulting chloride ion solution can then be equilibrated with 1 M nitric acid and then chloride content can be determined by titration of 0.1 M silver nitrate solution with potassium chromate as an indicator. The anion exchange capacity can then be determined based on quantification of the released chloride ions and the mass of the dried adsorbent material.

In some embodiments, it has been observed that adsorbent materials described herein having a relatively high loading of certain functional groups (e.g., quaternary ammonium groups) contributes at least in part to the relatively high anion exchange capacity as compared to certain existing ion exchange materials. Additionally, it has been observed that the anion exchange capacity of adsorbent materials and materials described herein may also depend at least in part on the composition of a silicon-containing precursor sol from which a silica-based ceramic of the adsorbent material is derived (e.g., water to silicon ratio, acid strength, ratio of silicon-containing precursors such as TEOS and TMAPS).

In some embodiments, the adsorbent material has an anion exchange capacity of greater than or equal to 0.01 milliequivalents per gram (meq/g). In some embodiments, the adsorbent material has an anion exchange capacity of greater than or equal to 0.1 meq/g, greater than or equal to 0.2 meq/g, greater than or equal to 0.3 meq/g, greater than or equal to 0.5 meq/g, greater than or equal to 0.7 meq/g, greater than or equal to 1 meq/g, greater than or equal to 1.2 meq/g, greater than or equal to 1.5 meq/g, greater than or equal to 1.7 meq/g, or greater. In some embodiments, the adsorbent material has an anion exchange capacity of less than or equal to 2.5 meq/g, less than or equal to 2.2 meq/g, 2 meq/g, less than or equal to 1.8 meq/g, less than or equal to 1.5 meq/g, less than or equal to 1.2 meq/g, less than or equal to 1 meq/g, less than or equal to 0.7 meq/g, or less. Combinations of these ranges are possible. For example, in some embodiments, the adsorbent material has an anion exchange capacity of greater than or equal to 0.01 meq/g and less than or equal to 2.5 meq/g, greater than or equal to 0.1 meq/g and less than or equal to 2.5 meq/g, greater than or equal to 0.5 meq and less than or equal to 2.5 meq/g, or greater than or equal to 1 meq/g and less than or equal to 2.5 meq/g. In some embodiments, the adsorbent material has a relatively high anion exchange capacity while having a relatively high amount of metal and/or metalloid present in the ceramic of the adsorbent material. For example, in some embodiments, the adsorbent material has an anion exchange capacity of greater than or equal to 0.01 meq/g, greater than or equal to 0.1 meq/g, greater than or equal to 0.2 meq/g, greater than or equal to 0.3 meq/g, greater than or equal to 0.5 meq/g, greater than or equal to 0.7 meq/g, greater than or equal to 1 meq/g and/or up to 1.2 meq/g, up to 1.5 meq/g, up to 1.8 meq/g, or up to 2 meq/g while having the metal and/or metalloid (e.g., Si, Al, Ti, Zn) present in the ceramic in an amount of at least 6 wt %, at least 10 wt %, at least 12 wt %, at least 15 wt %, at least 17 wt %, at least 20 wt %, and/or up to 24 wt %, up to 26 wt %, up to 28 wt %, up to 30 wt %, up to 40 wt %, up to 47 wt %, up to 60 wt %, or more.

In some embodiments, the adsorbent material (e.g., adsorbent material 100) has a relatively high cation exchange capacity. Having a relatively high cation exchange capacity is generally associated with good performance characteristics for an adsorbent material in the context of this disclosure. The cation exchange capacity of a material such as a resin or membrane can be measured using the following procedure. The material is soaked in sulfuric acid (1.0 M) for at least 20 minutes, with the sulfuric acid solution being exchanged twice with fresh sulfuric acid solution during this 20 minute time period. After soaking in the sulfuric acid solution, the material is soaked in deionized water for at least 15 minutes, with the deionized water being exchanged twice with fresh deionized water during this 15 minute time period. After soaking in the deionized water, the material is soaked in an aqueous solution containing 0.50 M sodium sulfate for at least 20 minutes, with the 0.50 M sodium sulfate solution being exchanged twice with fresh 0.50 M sodium sulfate solution (0.50 M sodium sulfate in otherwise deionized water) during this 20 minute period. The material is removed from the sodium sulfate solution and rinsed with deionized water. All of the sodium sulfate solutions as well as the rinse solutions are then combined and titrated with an aqueous solution containing 0.010 M sodium hydroxide using phenolphthalein as an indicator. The titration ends when solution becomes purple in color. An autotitrator can be used to perform the titration. A set of “blank” sodium sulfate solutions that are not exposed to the material are used and titrated to determine a baseline pH background for the aqueous solutions. The material is rinsed with deionized water and dried overnight at room temperature (e.g., 25 degrees ° C.). The weight of the material is recorded following drying step. The cation exchange capacity (CEC) is measured using:

$$C EC = \frac{{V}_{titrant} {C}_{titrant}}{{w}_{dry}}$$

where Vₜᵢₜᵣₐₙₜ is the volume of the sodium hydroxide titrant added during the titration, corrected for the baseline pH of the aqueous solutions (Vₜᵢₜᵣₐₙₜ=V_{titrant, material}−V_{titrant, blanks}), Cₜᵢₜᵣₐₙₜ is the concentration of the titrant (0.010 M in this case), and wary is the weight of the dried material in grams. In this disclosure, cation exchange capacity is reported in units of eq/g, which are equivalents (eq) per unit weight (g, grams). The number of equivalents in a solution refers to the numbers of moles of an ion (e.g., protons) in solution multiplied by the valence of the ions. The same procedure described above can be used for any cation exchange materials and is not limited to just membranes or resins.

In some embodiments, it has been observed that adsorbent materials described herein having a relatively high loading of certain functional groups (e.g., cation exchange functional groups sulfonate and/or sulfonic acid groups, phosphate and/or phosphoric acid groups, phosphonate and/or phosphonic acid groups, carboxylate and/or carboxylic acid groups, etc.) contributes at least in part to the relatively high cation exchange capacity as compared to certain existing ion exchange materials. Additionally, it has been observed that the cation exchange capacity adsorbent materials and materials described herein may also depend at least in part on the composition of a metal and/or metalloid-containing precursor sol from which a ceramic of the adsorbent material is derived (e.g., water to metal and/or metalloid ratio, and acid strength).

In some embodiments, the adsorbent material has a cation exchange capacity of greater than or equal to 0.01 milliequivalents per gram (meq/g). In some embodiments, the adsorbent material has a cation exchange capacity of greater than or equal to 0.1 meq/g, greater than or equal to 0.2 meq/g, greater than or equal to 0.3 meq/g, greater than or equal to 0.5 meq/g, greater than or equal to 0.7 meq/g, greater than or equal to 1 meq/g, greater than or equal to 1.2 meq/g, greater than or equal to 1.5 meq/g, greater than or equal to 1.7 meq/g, or greater. In some embodiments, the adsorbent material has a cation exchange capacity of less than or equal to 2.5 meq/g, less than or equal to 2.2 meq/g, 2 meq/g, less than or equal to 1.8 meq/g, less than or equal to 1.5 meq/g, less than or equal to 1.2 meq/g, less than or equal to 1 meq/g, less than or equal to 0.7 meq/g, or less. Combinations of these ranges are possible. For example, in some embodiments, the adsorbent material has a cation exchange capacity of greater than or equal to 0.01 meq/g and less than or equal to 2.5 meq/g, greater than or equal to 0.1 meq/g and less than or equal to 2.5 meq/g, greater than or equal to 0.5 meq and less than or equal to 2.5 meq/g, or greater than or equal to 1 meq/g and less than or equal to 2.5 meq/g. In some embodiments, the adsorbent material has a relatively high cation exchange capacity while having a relatively high amount of metal and/or metalloid present in the ceramic of the adsorbent material. For example, in some embodiments, the adsorbent material has a cation exchange capacity of greater than or equal to 0.01 meq/g, greater than or equal to 0.1 meq/g, greater than or equal to 0.2 meq/g, greater than or equal to 0.3 meq/g, greater than or equal to 0.5 meq/g, greater than or equal to 0.7 meq/g, greater than or equal to 1 meq/g and/or up to 1.2 meq/g, up to 1.5 meq/g, up to 1.8 meq/g, or up to 2 meq/g while having the metal and/or metalloid (e.g., Si, Al, Ti, Zn) present in the ceramic in an amount of at least 6 wt %, at least 10 wt %, at least 12 wt %, at least 15 wt %, at least 17 wt %, at least 20 wt %, and/or up to 24 wt %, up to 26 wt %, up to 28 wt %, up to 30 wt %, up to 40 wt %, up to 47 wt %, up to 60 wt %, up to 70 wt % or more.

As mentioned above, some embodiments comprise removing target species such as fluorine-containing molecules and/or metal and/or metalloid-containing ions from fluid mixtures such as wastewater streams. Some such embodiments may involve contacting fluid mixtures comprising the target species with the adsorbent material. As one example, a wastewater stream comprising fluorine-containing molecules such as PFAS (e.g., industrial effluent) may be passed through an ion exchange column comprising the adsorbent material (e.g., a ceramic material described herein such as a silica-based ceramic functionalized with ion exchange groups and/or fluorocarbon groups). As another example, a wastewater stream comprising metal and/or metal-containing ions (e.g., chromate, manganese ions) may be passed through an ion exchange column comprising the adsorbent material.

In some embodiments, the target species comprises a fluorine-containing molecule. A fluorine-containing molecule may be an organic molecule comprising one or more fluoro substituents. The fluorine-containing molecule may be electrostatically neutral. However, in some embodiments the fluorine-containing molecule carries an electrostatic charge at least under some conditions (e.g., depending on the pKₐ of the molecule and the pH of a surrounding medium). In some embodiments, the fluorine-containing molecule comprises a fluorocarbon moiety. In some embodiments, the fluorine-containing molecule comprises a fluoroaliphatic group. For example, the fluorine-containing molecule may comprise a fluoroalkyl group (e.g., a C₁-Cis fluoroalkyl group). In some embodiments, the fluorine-containing molecule comprises a fluoroheteroaliphatic group. In some embodiments, the fluorine-containing molecule comprises a polyfluoroaliphatic group. In some embodiments, the fluorine-containing molecules comprises a perfluoroaliphatic group.

In some embodiments, a fluorine-containing molecule comprises a head group and a tail group. In some embodiments, the fluorine-containing molecule comprises a hydrophilic head group. Those of ordinary skill in the art, with the benefit of this disclosure, would understand the meaning of a hydrophilic head group of an organic molecule. Examples of hydrophilic head groups include, but are not limited to, carboxylates/carboxylic acids, sulfonates/sulfonic acids, sulfonamides, sulfonamidocarboxylates/sulfonamidocarboxylic acids, phosphates/phosphoric acids, and/or phosphonates/phosphonic acids. In some embodiments, the fluorine-containing molecule comprises a hydrophobic tail groups. Those of ordinary skill in the art, with the benefit of this disclosure, would understand the meaning of a hydrophobic tail group of an organic molecule. Examples of hydrophobic tail groups include, but are not limited to, fluoroaliphatic groups (e.g., C₄-C₁₈ fluoroalkyl groups such as poly- and perfluoroalkyl groups) and fluoroaryl (e.g., poly- and perfluoroaryl groups).

In some embodiments, the fluorine-containing molecule comprises a per- or poly-fluoroalkyl substance (PFAS). PFAS are generally known and can be harmful pollutants (e.g., from wastewater sources), and so effective and inexpensive capture of PFAS is desirable.

In some embodiments, the per- or poly-fluoroalkyl substance comprises a perfluoroalkyl carboxylic acid. Examples of perfluoroalkyl carboxylic acids include, but are not limited to, perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, and/or perfluorotetradecanoic acid.

In some embodiments, the per- or poly-fluoroalkyl substance comprises a perfluoroalkyl sulfonic acid. Examples of perfluoroalkyl sulfonic acids include, but are not limited to, perfluorobutanesulfonic acid, perfluoropentansulfonic acid, perfluorohexanesulfonic acid, perfluoroheptanesulfonic acid, perfluorooctanesulfonic acid, perfluorononanesulfonic acid, perfluorodecanesulfonic acid, and/or perfluorododecanesulfonic acid.

In some embodiments, the per- or poly-fluoroalkyl substance comprises a fluorotelomer sulfonic acid. Examples of fluorotelomer sulfonic acids include, but are not limited to, 1H,1H, 2H, 2H-perfluorohexane sulfonic acid, 1H,1H, 2H, 2H-perfluorooctane sulfonic acid, and/or 1H,1H, 2H, 2H-perfluorodecane sulfonic acid.

In some embodiments, the per- or poly-fluoroalkyl substance comprises a perfluorooctanesulfonamide. Examples of perfluorooctanesulfonamides include, but are not limited to, perfluorooctanesulfonamide, N-methyl perfluorooctanesulfonamide, and/or N-ethyl perfluorooctanesulfonamide.

In some embodiments, the per- or poly-fluoroalkyl substance comprises a perfluorooctane sulfonamidoacetic acid. Examples of perfluorooctane sulfonamidoacetic acids include, but are not limited to, N-methyl perfluorooctanesulfonamidoacetic acid and/or N-ethyl perfluorooctanesulfonamidoacetic acid.

In some embodiments, the per- or poly-fluoroalkyl substance comprises a perfluorooctane sulfonamide ethanol. Examples of perfluorooctane sulfonamide ethanols include, but are not limited to, N-methyl perfluorooctanesulfonamidoethanol and/or N-ethyl perfluorooctanesulfonamidoethanol.

In some embodiments, the per- or poly-fluoroalkyl substance comprises a per- or polyfluoroether carboxylic acid. Examples of per- or polyfluoroether carboxylic acids include, but are not limited to, hexafluoropropylene oxide dimer acid, 4,8-Dioxa-3H-perfluorononanoic acid, perfluoro-3-methoxypropanoic acid, perfluoro-4-methoxybutanoic acid, and/or nonafluoro-3,6-dioxaheptanoic acid.

In some embodiments, the per- or poly-fluoroalkyl substance comprises an ether sulfonic acid. Examples of ether sulfonic acids include, but are not limited to, 9-chlorohexadecafluoro-3-oxanonane-1-sulfonic acid, 11-chloroeicosafluoro-3-oxaundecane-1-sulfonic acid, and/or perfluoro(2-ethoxyethane)sulfonic acid.

In some embodiments, the per- or poly-fluoroalkyl substance comprises a fluorotelomer carboxylic acid. Examples of fluorotelomer carboxylic acids include, but are not limited to, 3-perfluoropropyl propanoic acid, 2H,2H,3H,3H-perfluorooctanoic acid, and/or 3-perfluoroheptyl propanoic acid.

In some embodiments, the per- or poly-fluoroalkyl substance comprises hexafluoropropylene oxide dimer acid (HFPO-DA). In some embodiments, the per- or poly-fluoroalkyl substance comprises a salt of HFPO-DA, such as the ammonium salt of HFPO-DA (also known as GenX™). In some embodiments, the per- or poly-fluoroalkyl substance comprises a fluorochemical known to be used to produce HFPO-DA and/or a salt of HFPO-DA.

In some embodiments, the target species comprises a metal-containing ion. In some such instances, the metal-containing ion is a cation. For example, the cation may comprise a transition metal cation. Non-limiting examples include V²⁺, V³⁺, V⁴⁺, V⁵⁺, Cr³⁺, Mn²⁺, Mn³⁺, Fe²⁺, Fe³⁺, Co²⁺ Ni²⁺, Cu²⁺, and Cd²⁺. In some embodiments, the cation comprises an alkali ion (e.g., Li⁺, Na⁺, K⁺). In some embodiments, the cation comprises an alkaline earth metal ion (e.g., Mg²⁺, Ca²⁺). In some embodiments, the cation comprises an arsenic cation (e.g., As³⁺, As⁵⁺). In some embodiments, the metal-containing ion is an anion, such a polyatomic anion. For example, in some embodiments, the metal-containing ion is a metal oxyanion. Non-limiting examples include chromate (CrO₄²⁻), hydrogen chromate (HCrO₄⁻), dichromate (Cr₂O₇²⁻), permanganate (MnO₄⁻), and vanadates (e.g., VO₄³⁻). In some embodiments, the metal-containing ion is a heavy-metal containing ion. Non-limiting examples of heavy metal-containing ions include those of mercury, zinc, lead, cadmium, chromium, and nickel.

In some embodiments, the target species comprises a metalloid-containing ion. In some such instances, the metalloid-containing ion is a metalloid oxyanion. Non-limiting examples of metalloid oxyanions include arsenite (AsO₃³⁻), arsenate (AsO₄³⁻), selenate (SeO₄²⁻), and selenite (SeO₃²⁻).

While examples of metal and/or metalloid oxyanions are given above, the target species may include other oxyanions. For example, the target species may comprise nitrate (NO₃⁻). Other examples of oxyanions include, but are not limited to, SO₃⁻, CO₃⁻, PO₄³⁻, HPO₄²⁻, H₂PO₄⁻, BO₃⁻, NO₃⁻, NO₂⁻, and ClO₃⁻.

In some embodiments, the target species comprises a metal or metalloid oxide. For example, the target species may comprise a transition metal oxide, an alkali oxide, an alkaline earth metal oxide, and/or a heavy metal oxide (e.g., a mercury oxide, a lead oxide, a zinc oxide).

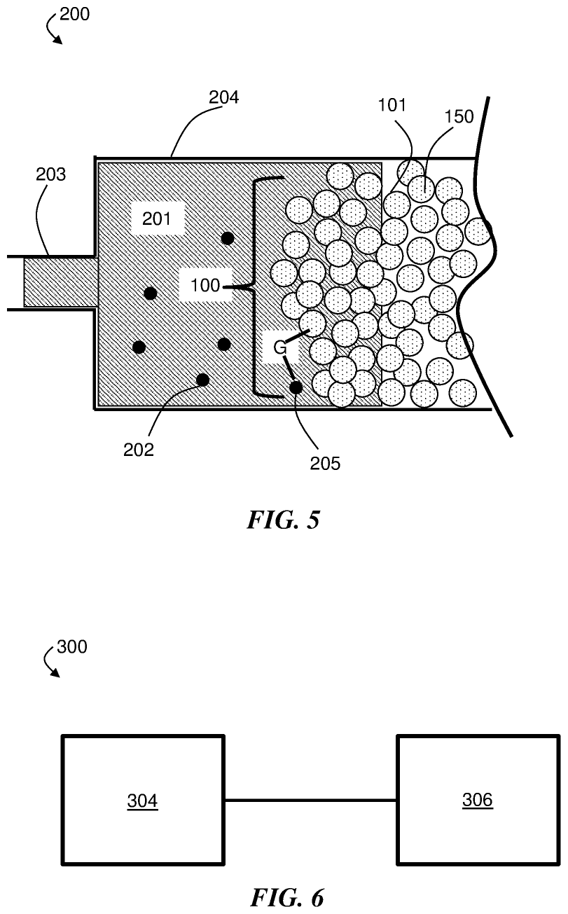

In some embodiments, an amount of a target species is removed from a fluid mixture. The fluid mixture may be a liquid mixture (e.g., an aqueous solution, an organic solutions, or a combination thereof), a gaseous mixture (e.g., a gaseous effluent stream from an industrial process), or a combination thereof. In some embodiments, the target species is at least partially (e.g., partially or completely) dissolved in the fluid mixture. The target species may be removed by being exposed to the adsorbent material (e.g., comprising a ceramic such as ceramic particles). For example, adsorbent material may be exposed to the fluid mixture comprising the target species such that the target species contacts at least a portion of the adsorbent material. Such a contact can be performed, for example, by placing the adsorbent material within a vessel comprising an inlet for receiving the fluid mixture and transporting at least a portion of the fluid mixture into the vessel. The vessel may comprise a solid structure with an interior volume that can receive an adsorbent material and a fluid mixture. For example, the vessel may be a column (e.g., an ion exchange column), a tank, a reactor, a cartridge, channel (e.g., a closed channel) a trough, a tube, or a pipe. FIG. 5 shows a schematic cross-sectional diagram of system 200 for treating fluid mixture 201 comprising target species 202 (e.g., a fluorine-containing molecule, a metal and/or metalloid-containing ion, an oxyanion, a metal and/or metalloid oxide). Inlet 203 of vessel 204 may be configured to be in fluidic communication with a source of the fluid mixture. In some embodiments, the inlet of the vessel is in fluidic communication with a source of the fluid mixture. For example, the vessel may be an ion exchange column whose inlet is connected to a wastewater source (e.g., piping, tubing, etc.). Fluid mixture 201 may be at least partially (as shown in FIG. 5) or completely transported into vessel 200 via inlet 203. For example, the fluid mixture may be induced to flow into the vessel by positive pressure (e.g., from a pump or from hydrostatic pressure), negative pressure (e.g., via vacuum), and/or gravity. The adsorbent material may form a bed within the vessel. For example, adsorbent material 100, which may comprise ceramic particles 101 comprising ceramic 150, can be positioned as a packed bed within vessel 204 of system 200, according to some embodiments.

In some embodiments, the fluid mixture comprising the target species enters the vessel and encounters the adsorbent material. At this point, the target species may contact the functional groups bound to the adsorbent material (e.g., on a surface of ceramic) and become captured. Capture by of the target species by the functional groups (e.g., via electrostatic attraction, van der Waals forces, chemical bond formation, etc.) can contribute to the removal of the target species from fluid stream. FIG. 5 shows captured target species 205 associated with adsorbent material 100 via functional group G bound to one of particles 101, in accordance with some embodiments. Captured target species (e.g., target species immobilized with respect to the adsorbent material) are considered removed from the fluid mixture, even if the fluid mixture at least temporarily still surrounds the adsorbent material.

The fluid stream may pass through the vessel one or more times (e.g., at least one time, at least two times, at least three times, etc.). In some embodiments, the fluid mixture is passed through multiple vessels comprising adsorbent material, which may progressively remove greater and greater amounts of the target species from the fluid stream. In some embodiments, the fluid mixture is passed into and through the vessel and exposed to the adsorbent material under continuous flow. However, in some embodiments, the fluid mixture comprising the target species is transported into the vessel and contacted with the adsorbent material under batch conditions (e.g., where the vessel is part of a batch reactor).

In some embodiments, the adsorbent material is exposed to the fluid mixture and is mixed (e.g., via agitation, inversion of a vessel containing the adsorbent material, etc.). In some embodiments, the adsorbent material (e.g., comprising ceramic particles) is added to a batch of the fluid mixture (e.g., in a tank) and allowed to form a suspension (e.g., upon mixing) or settled while target species are captured by the adsorbent materials.

Prior to exposure to the adsorbent material, the fluid mixture may comprise the target species in any of a variety of amounts, depending on the source of the fluid mixture (e.g., industrial wastewater versus residential wastewater). In some embodiments, a particular target species is present in the fluid mixture in an amount of at least 0.05 parts per trillion (ppt), at least 0.1 ppt, at least 0.2 ppt, at least 0.5 parts ppt, at least 1 ppt, at least 2 ppt, at least 5 ppt, at least 10 ppt, at least 20 ppt, at least 50 ppt, at least 100 ppt, at least 200 ppt, at least 500 ppt, at least 1 part per billion (ppb), at least 2 ppb, at least 5 ppb, at least 10 ppb, at least 20 ppb, at least 50 ppb, at least 100 ppb, at least 200 ppb, at least 500 ppb, at least 1 part per million (ppm), at least 2 ppm, at least 5 ppm, at least 10 ppm, at least 20 ppm, at least 50 ppm, at least 100 ppm or more, and/or less than or equal to 500 ppm, less than or equal to 200 ppm, or less on a mass basis. In some embodiments where multiple different target species are present, the total amount of all target species is present in the fluid mixture in an amount of at least at least 0.05 ppt, at least 0.1 ppt, at least 0.2 ppt, at least 0.5 ppt, at least 1 ppt, at least 2 ppt, at least 5 ppt, at least 10 ppt, at least 20 ppt, at least 50 ppt, at least 100 ppt, at least 200 ppt, at least 500 ppt, at least 1 part per billion (ppb), at least 2 ppb, at least 5 ppb, at least 10 ppb, at least 20 ppb, at least 50 ppb, at least 100 ppb, at least 200 ppb, at least 500 ppb, at least 1 part per million (ppm), at least 2 ppm, at least 5 ppm, at least 10 ppm, at least 20 ppm, at least 50 ppm, at least 100 ppm, or more, and/or less than or equal to 500 ppm, less than or equal to 200 ppm, or less on a mass basis. Combinations of these ranges are possible.

In some embodiments, exposure of the fluid mixture to the adsorbent material results in the removal of at least 10 wt %, at least 25 wt %, at least 40 wt %, at least 50 wt %, at least 60 wt %, at least 75 wt %, at least 85 wt %, at least 90 wt %, at least 95 wt %, at least 98 wt %, at least 99 wt %, at least 99.9 wt %, at least 99.99 wt % or more of the target species. In some embodiments, exposure of the fluid mixture to the adsorbent material results in the removal of less than or equal to 100 wt %, less than or equal to 99.9 wt %, less than or equal to 99 wt %, less than or equal to 98 wt %, less than or equal to 95 wt %, less than or equal to 90 wt %, less than or equal to 85 wt %, less than or equal to 80 wt %, less than or equal to 75 wt %, less than or equal to 60 wt %, less than or equal to 50 wt %, less than or equal to 40 wt %, or less of the target species. The extent of removal of the target species may depend on the affinity of the adsorbent material to the target species as well as other conditions such as duration of exposure, extent of mixing, temperature, pH, and amount of adsorbent material used.

In some embodiments, the adsorbent material has a relatively high adsorption density (q) which is defined by the following equation where C₀ is the initial concentration of target species in the fluid mixture (mg/L), C is the concentration of target species solution at the time of collection (mg/L), Vis the volume of bulk solution (L) and m is the dry mass of adsorbate (g):

$$q = \frac{( {C}_{0} - C ) V}{m}$$

In some embodiments, the adsorbent material has a relatively high adsorption density (e.g., upon exposure to the fluid mixture comprising the target species). In some embodiments, the adsorbent material has an adsorption density for a target species of at least 0.01, at least 0.02, at least 0.05, at least 0.1, at least 0.2, at least 0.5, at least 1, at least 2, at least 5, at least 10, at least 20, and/or up to 30, up to 40, up to 50 or more milligram of target species per gram of adsorbent material when exposed to a fluid mixture comprising the target species in an amount of at least at least 1 part per trillion (ppt), at least 2 ppt, at least 5 ppt, at least 10 ppt, at least 20 ppt, at least 50 ppt, at least 100 ppt, at least 200 ppt, at least 500 ppt, at least 1 part per billion (ppb), at least 2 ppb, at least 5 ppb, at least 10 ppb, at least 20 ppb, at least 50 ppb, at least 100 ppb, at least 200 ppb, at least 500 ppb, at least 1 part per million (ppm), at least 2 ppm, at least 5 ppm, at least 10 ppm, at least 20 ppm, at least 50 ppm, at least 100 ppm, or more and/or less than or equal to 500 ppm, less than or equal to 200 ppm, or less on a mass basis for a period of at least 24 hours. In some embodiments, the adsorbent material has a maximum adsorption density for a target species of at least 0.01, at least 0.02, at least 0.05, at least 0.1, at least 0.2, at least 0.5, at least 1, at least 2, at least 5, at least 10, at least 20, or more and/or less than or equal to 50, less than or equal to 40, less than or equal to 30 or more milligram of target species per gram of adsorbent material when exposed to a fluid mixture comprising the target species for at least 24 hours. The maximum adsorption density can be determined by generating an adsorption isotherm, such as via the methodology described in the examples below.

In some embodiments, the adsorbent material (e.g., exposed to the fluid mixture in a vessel) has a relatively large volume. It has been determined that using relatively large volumes of adsorbent materials described herein can effectively remove target species such as PFAS while remaining relatively inexpensive (e.g., due to inexpensive manufacturing). In some embodiments, the adsorbent material within the vessel and/or exposed to the fluid mixture comprising the target species has a volume of greater than or equal to 0.01 m³, greater than or equal to 0.02 m³, greater than or equal to 0.05 m³, greater than or equal to 0.1 m³, greater than or equal to 0.2 m³, greater than or equal to 0.5 m³, greater than or equal to 1 m³, greater than or equal to 2 m³, greater than or equal to 3 m³, greater than or equal to 5 m³, greater than or equal to 10 m³, or more and/or less than or equal to 50 m³, less than or equal to 20 m³, or less. These volumes may refer to the dry volume (equivalent) of the adsorbent material.

In some embodiments, the adsorbent material has relatively good durability under harsh conditions. For example, in some embodiments, the adsorbent material maintains relatively good performance for capturing target species (e.g., metal and/or metalloid ions and/or fluorine-containing molecules such as PFAS) even after exposure to an oxidizing agent. For example, as a room temperature screening test, in some embodiments, a percentage of target species (e.g., a metal ion such as Cu²⁺) removed from the fluid stream by the porous adsorbent material after exposure of the porous adsorbent material to an aqueous solution comprising at least 35 volume percent of an oxidizing agent such as hydrogen peroxide for a period of 46 hours is at least 70%, at least 75%, at least 80%, at least 85%, at least 90%, at least 95%, and/or up to 96% or greater. In some embodiments, as a room temperature screening test, a ratio calculated by dividing (a) the percentage of target species (e.g., a metal ion such as Cu²⁺) removed from the fluid stream by the porous adsorbent material after exposure of the porous adsorbent material to an aqueous solution comprising at least 35 volume percent of an oxidizing agent such as hydrogen peroxide for a period of 46 hours by (b) the percentage of the same target species removed from the fluid stream by an otherwise identical porous adsorbent material under otherwise identical conditions but without exposure to the oxidizing agent is at least 0.88, at least 0.90, at least 0.92, at least 0.94, and/or up to 0.96% or greater. In some embodiments in which the oxidizing agent is hydrogen peroxide and the target species is Cu²⁺, the screening test could be performed as follows. A sample 0.1 g of the porous adsorbent material is exposed to 10 mL of aqueous 35 vol % hydrogen peroxide solution and shaken for 46 hours on an orbital shaker. The hydrogen peroxide solution is refreshed twice to ensure sufficient exposure. The fresh hydrogen peroxide-exposed porous adsorbent material is rinsed with deionized water and then shaken with 10 mL of pH 3.2 aqueous solution of 300 mg/L copper sulfate for 4 hours. The supernatant is analyzed for CU²⁺ concentration via ultraviolet-visible (UV-vis) spectrophotometry. The difference in copper concentration between this value and the 300 mg/L stock solution is then calculated in terms of a percentage of Cu²⁺ removed after exposure.

Certain aspects of this disclosure are directed to transforming the target species into a different species. Such a transformation may be desirable in order to completely remove a health and/or environment threat associated with the species. For example, it may be desirable to destroy captured PFAS in order to prevent it from being reintroduced into the environment. Such a transformation may also be helpful in recovering components of the target species for use in other applications. As noted above, it has been realized in the context of this disclosure that certain techniques for transforming (e.g., destroying) target species such as incineration can create problematic additional waste streams or be energy intensive and/or expensive. It has further been realized that, in some embodiments, mechanochemical treatment can be used to transform target species inexpensively, using a simple and scalable workflow, and without necessarily generating harmful waste streams. Subjecting a substance (e.g., a solid substance to a mechanochemical transformation involves applying mechanical stress to the substance to induce chemical transformation on a molecular scale. Mechanical stresses that can be used to engender mechanochemical transformations include, but are not limited to, compressive stress, shear stress, cavitation, or combinations thereof.

In some embodiments, a target species (e.g., fluorine-containing molecules such as PFAS) captured by the functional group covalently bound to the adsorbent material (e.g., at a surface of a ceramic) are subjected to a mechanochemical transformation. The mechanochemical transformation may destroy the target species. For example, the target species may be transformed under the mechanical stress of the mechanochemical treatment into a different substance that is, in some instances less harmful or unharmful. For example, captured fluorine-containing molecules such as PFAS bound to the functional groups of the adsorbent material may undergo defluorination under mechanochemical treatment. The captured target species may be subjected to the mechanochemical transformation in a mechanochemical apparatus. A mechanochemical apparatus refers to a structure configured to apply mechanical stress to a solid substance of sufficient magnitude to induce a chemical reaction. For example, a mechanochemical apparatus may comprise a grinding medium.

In some embodiments, at least some of the amount of target species (e.g., fluorine-containing molecules) removed from the fluid stream at least in part via capture by the functional groups of the adsorbent material described above may be subjected to the mechanochemical transformation. In some such instances, the target species subjected to the mechanochemical transformation remain captured by the functional groups that initially removed the target species from the fluid mixture, even during the mechanochemical transformation. These embodiments stand in contrast to techniques where captured target species may be removed from the materials that initially captured the species prior to undergoing mechanochemical treatment. By directly mechanochemically treating target species still captured by the adsorbent material, a simpler workflow with few waste streams can be employed. In some embodiments, a system for treating a fluid mixture comprises both the vessel comprising the adsorbent material described above, as well as a mechanochemical apparatus. The mechanochemical apparatus may be configured to receive solid material (e.g., adsorbent material amended with target species) from the vessel. FIG. 6 shows a schematic block diagram of system 300 comprising vessel 304 (which in some embodiments corresponds to vessel 204 in connection with FIG. 5) and mechanochemical apparatus 306 configured to receive solid material from vessel 304, in accordance with some embodiments.

In some embodiments, the mechanochemical transformation is performed at least in part via ball milling the captured target species (e.g., captured by the functional groups covalently bound to the adsorbent material). Ball milling is known in the art and generally involves rotating a hollow cylinder partially filled with balls serving as a grinding medium and the substance to be treated. Impact from the balls as they fall during rotation applies the mechanical stress that induces the mechanochemical transformation. In some embodiments, the mechanochemical apparatus (e.g., mechanochemical apparatus 306) comprises a bill mill. In some embodiments, a planetary ball mill is employed.

In some embodiments, the ball milling of the target species involves use of a co-milling agent. The co-milling agent may facilitate the transformation (e.g., destruction) of the target species by, for example, catalyzing the reaction or serving as a reagent in the reaction. In some embodiments, the ball milling process comprises exposing target species (e.g., fluorine-containing molecules) to a base. Any of a variety of bases may be used. For example, the base may be a hydroxide-containing salt. Examples of hydroxide-containing salts include potassium hydroxide, sodium hydroxide, and ammonium hydroxide.

In some embodiments, subjecting the captured target species to the mechanochemical transformation results in the conversion of at least 10 wt %, at least 25 wt %, at least 40 wt %, at least 50 wt %, at least 60 wt %, at least 75 wt %, at least 85 wt %, at least 90 wt %, at least 95 wt %, at least 98 wt %, at least 99 wt %, at least 99.9 wt %, at least 99.99 wt % or more of the target species into a different species. In some embodiments, subjecting the captured target species to the mechanochemical transformation results in the conversion of less than or equal to 100 wt %, less than or equal to 99.99 wt %, less than or equal to 99.9 wt %, less than or equal to 98 wt %, less than or equal to 95 wt %, less than or equal to 90 wt %, less than or equal to 85 wt %, less than or equal to 80 wt %, less than or equal to 75 wt %, less than or equal to 60 wt %, less than or equal to 50 wt %, or less of the target species into a different species.

U.S. Provisional Patent Application No. 63/288,216, filed Dec. 10, 2021, and entitled “Materials for the Capture of Substances,” is incorporated herein by reference in its entirety for all purposes.

Definitions of specific functional groups and chemical terms are described in more detail below. The chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Thomas Sorrell, Organic Chemistry, University Science Books, Sausalito, 1999; Michael B. Smith, March's Advanced Organic Chemistry, 7th Edition, John Wiley & Sons, Inc., New York, 2013; Richard C. Larock, Comprehensive Organic Transformations, John Wiley & Sons, Inc., New York, 2018; and Carruthers, Some Modern Methods of Organic Synthesis, 3rd Edition, Cambridge University Press, Cambridge, 1987.

Unless otherwise provided, formulae and structures depicted herein include compounds that do not include isotopically enriched atoms, and also include compounds that include isotopically enriched atoms. For example, compounds having the present structures except for the replacement of hydrogen by deuterium or tritium, replacement of ¹⁹F with ¹⁸F, or the replacement of a carbon by a ¹³C- or ¹⁴C-enriched carbon are within the scope of the disclosure. Such compounds are useful, for example, as analytical tools or probes in biological assays.

When a range of values (“range”) is listed, it encompasses each value and sub-range within the range. A range is inclusive of the values at the two ends of the range unless otherwise provided. For example “C₁₋₆ alkyl” encompasses, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl. As another example, “C₁₋₁₈ alkyl” encompasses, C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₋₁₅, C₁₋₁₇, C₁₋₁₆, C₁₋₁₅, C₁₋₁₄, C₁₋₁₃, C₁₋₁₂, C₁₋₁₁, C₁₋₁₀, C₁₋₉, C₁₋₈, C₁₋₇, C₁₋₆, C₁₋₅, C₁₋₄, C₁₋₃, C₁₋₂, C₂₋₁₅, C₂₋₁₇, C₂₋₁₆, C₂₋₁₅, C₂₋₁₄, C₂₋₁₃, C₂₋₁₂, C₂₋₁₁, C₂₋₁₀, C₂₋₉, C₂₋₅, C₂₋₇, C₂₋₆, C₂₋₅, C₂₋₄, C₂₋₃, C₃₋₁₅, C₃₋₁₇, and so forth.

The term “aliphatic” refers to alkyl, alkenyl, alkynyl, and carbocyclic groups. Likewise, the term “heteroaliphatic” refers to heteroalkyl, heteroalkenyl, heteroalkynyl, and heterocyclic groups.

The term “alkyl” refers to a radical of a straight-chain or branched saturated hydrocarbon group having from 1 to 20 carbon atoms (“C₁₋₂₀ alkyl”). In some embodiments, an alkyl group has 1 to 12 carbon atoms (“C₁₋₁₂ alkyl”). In some embodiments, an alkyl group has 1 to 10 carbon atoms (“C₁₋₁₀ alkyl”). In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₈ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, isobutyl), pentyl (C₅) (e.g., n-pentyl, 3-pentanyl, amyl, neopentyl, 3-methyl-2-butanyl, tert-amyl), and hexyl (C₆) (e.g., n-hexyl). Additional examples of alkyl groups include n-heptyl (C₇), n-octyl (C₈), n-dodecyl (C₁₂), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₂ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu or s-Bu), unsubstituted isobutyl (i-Bu)). In certain embodiments, the alkyl group is a substituted C₁₋₁₂ alkyl (such as substituted C₁₋₆ alkyl, e.g., —CH₂F, —CHF₂, —CF₃, —CH₂CH₂F, —CH₂CHF₂, —CH₂CF₃, or benzyl (Bn)).

The term “haloalkyl” is a substituted alkyl group, wherein one or more of the hydrogen atoms are independently replaced by a halogen, e.g., fluoro, bromo, chloro, or iodo. “Perhaloalkyl” is a subset of haloalkyl, and refers to an alkyl group wherein all of the hydrogen atoms are independently replaced by a halogen, e.g., fluoro, bromo, chloro, or iodo. In some embodiments, the haloalkyl moiety has 1 to 20 carbon atoms (“C₁₋₂₀ haloalkyl”). In some embodiments, the haloalkyl moiety has 1 to 10 carbon atoms (“C₁₋₁₀ haloalkyl”). In some embodiments, the haloalkyl moiety has 1 to 9 carbon atoms (“C₁₋₉ haloalkyl”). In some embodiments, the haloalkyl moiety has 1 to 8 carbon atoms (“C₁₋₅ haloalkyl”). In some embodiments, the haloalkyl moiety has 1 to 7 carbon atoms (“C₁₋₇ haloalkyl”). In some embodiments, the haloalkyl moiety has 1 to 6 carbon atoms (“C₁₋₆ haloalkyl”). In some embodiments, the haloalkyl moiety has 1 to 5 carbon atoms (“C₁₋₅ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃ haloalkyl”). In some embodiments, the haloalkyl moiety has 1 to 2 carbon atoms (“C₁₋₂ haloalkyl”). In some embodiments, all of the haloalkyl hydrogen atoms are independently replaced with fluoro to provide a “perfluoroalkyl” group. In some embodiments, all of the haloalkyl hydrogen atoms are independently replaced with chloro to provide a “perchloroalkyl” group. Examples of haloalkyl groups include —CHF₂, —CH₂F, —CF₃, —CH₂CF₃, —CF₂CF₃, —CF₂CF₂CF₃, —CCl₃, —CFCl₂, —CF₂Cl, and the like.

The term “heteroalkyl” refers to an alkyl group, which further includes at least one heteroatom (e.g., 1, 2, 3, or 4 heteroatoms) selected from oxygen, nitrogen, or sulfur within (e.g., inserted between adjacent carbon atoms of) and/or placed at one or more terminal position(s) of the parent chain. In certain embodiments, a heteroalkyl group refers to a saturated group having from 1 to 20 carbon atoms and 1 or more heteroatoms within the parent chain (“heteroC₁₋₂₀ alkyl”). In certain embodiments, a heteroalkyl group refers to a saturated group having from 1 to 12 carbon atoms and 1 or more heteroatoms within the parent chain (“heteroC₁₋₁₂ alkyl”). In some embodiments, a heteroalkyl group is a saturated group having 1 to 11 carbon atoms and 1 or more heteroatoms within the parent chain (“heteroC₁₋₁₁ alkyl”). In some embodiments, a heteroalkyl group is a saturated group having 1 to 10 carbon atoms and 1 or more heteroatoms within the parent chain (“heteroC₁₋₁₀ alkyl”). In some embodiments, a heteroalkyl group is a saturated group having 1 to 9 carbon atoms and 1 or more heteroatoms within the parent chain (“heteroC₁₋₉ alkyl”). In some embodiments, a heteroalkyl group is a saturated group having 1 to 8 carbon atoms and 1 or more heteroatoms within the parent chain (“heteroC₁₋₈ alkyl”). In some embodiments, a heteroalkyl group is a saturated group having 1 to 7 carbon atoms and 1 or more heteroatoms within the parent chain (“heteroC₁₋₇ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 5 carbon atoms and 1 or 2 heteroatoms within the parent chain (“heteroC₁₋₅ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃ alkyl”). In some embodiments, a heteroalkyl group is a saturated group having 1 to 2 carbon atoms and 1 heteroatom within the parent chain (“heteroC₁₋₂ alkyl”). In some embodiments, a heteroalkyl group is a saturated group having 1 carbon atom and 1 heteroatom (“heteroC₁₋₄ alkyl”). In some embodiments, a heteroalkyl group is a saturated group having 2 to 6 carbon atoms and 1 or 2 heteroatoms within the parent chain (“heteroC₂₋₆ alkyl”). Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₁₂ alkyl. In certain embodiments, the heteroalkyl group is a substituted heteroC₁₋₁₂ alkyl.

The term “alkenyl” refers to a radical of a straight-chain or branched hydrocarbon group having from 1 to 20 carbon atoms and one or more carbon-carbon double bonds (e.g., 1, 2, 3, or 4 double bonds). In some embodiments, an alkenyl group has 1 to 20 carbon atoms (“C₁₋₂₀ alkenyl”). In some embodiments, an alkenyl group has 1 to 12 carbon atoms (“C₁₋₁₂ alkenyl”). In some embodiments, an alkenyl group has 1 to 11 carbon atoms (“C₁₋₁₁ alkenyl”). In some embodiments, an alkenyl group has 1 to 10 carbon atoms (“C₁₋₁₀ alkenyl”). In some embodiments, an alkenyl group has 1 to 9 carbon atoms (“C₁₋₉ alkenyl”). In some embodiments, an alkenyl group has 1 to 8 carbon atoms (“C₁₋₈ alkenyl”). In some embodiments, an alkenyl group has 1 to 7 carbon atoms (“C₁₋₇ alkenyl”). In some embodiments, an alkenyl group has 1 to 6 carbon atoms (“C₁₋₆ alkenyl”). In some embodiments, an alkenyl group has 1 to 5 carbon atoms (“C₁₋₅ alkenyl”). In some embodiments, an alkenyl group has 1 to 4 carbon atoms (“C₁₋₄ alkenyl”). In some embodiments, an alkenyl group has 1 to 3 carbon atoms (“C₁₋₃ alkenyl”). In some embodiments, an alkenyl group has 1 to 2 carbon atoms (“C₁₋₂ alkenyl”). In some embodiments, an alkenyl group has 1 carbon atom (“C₁ alkenyl”). The one or more carbon-carbon double bonds can be internal (such as in 2-butenyl) or terminal (such as in 1-butenyl). Examples of C₁₋₄ alkenyl groups include methylidenyl (C₁), ethenyl (C₂), 1-propenyl (C₃), 2-propenyl (C₃), 1-butenyl (C₄), 2-butenyl (C₄), butadienyl (C₄), and the like. Examples of C₁₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₁₋₂₀ alkenyl. In certain embodiments, the alkenyl group is a substituted C₁₋₂₀ alkenyl. In an alkenyl group, a C═C double bond for which the stereochemistry is not specified (e.g., —CH═CHCH₃ or

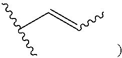

may be in the (E)- or (Z)-configuration.

The term “heteroalkenyl” refers to an alkenyl group, which further includes at least one heteroatom (e.g., 1, 2, 3, or 4 heteroatoms) selected from oxygen, nitrogen, or sulfur within (e.g., inserted between adjacent carbon atoms of) and/or placed at one or more terminal position(s) of the parent chain. In certain embodiments, a heteroalkenyl group refers to a group having from 1 to 20 carbon atoms, at least one double bond, and 1 or more heteroatoms within the parent chain (“heteroC₁₋₂₀ alkenyl”). In certain embodiments, a heteroalkenyl group refers to a group having from 1 to 12 carbon atoms, at least one double bond, and 1 or more heteroatoms within the parent chain (“heteroC₁₋₁₂ alkenyl”). In certain embodiments, a heteroalkenyl group refers to a group having from 1 to 11 carbon atoms, at least one double bond, and 1 or more heteroatoms within the parent chain (“heteroC₁₋₁₁ alkenyl”). In certain embodiments, a heteroalkenyl group refers to a group having from 1 to 10 carbon atoms, at least one double bond, and 1 or more heteroatoms within the parent chain (“heteroC₁₋₁₀ alkenyl”). In some embodiments, a heteroalkenyl group has 1 to 9 carbon atoms at least one double bond, and 1 or more heteroatoms within the parent chain (“heteroC₁₋₉ alkenyl”). In some embodiments, a heteroalkenyl group has 1 to 8 carbon atoms, at least one double bond, and 1 or more heteroatoms within the parent chain (“heteroC₁₋₈ alkenyl”). In some embodiments, a heteroalkenyl group has 1 to 7 carbon atoms, at least one double bond, and 1 or more heteroatoms within the parent chain (“heteroC₁₋₇ alkenyl”). In some embodiments, a heteroalkenyl group has 1 to 6 carbon atoms, at least one double bond, and 1 or more heteroatoms within the parent chain (“heteroC₁₋₆ alkenyl”). In some embodiments, a heteroalkenyl group has 1 to 5 carbon atoms, at least one double bond, and 1 or 2 heteroatoms within the parent chain (“heteroC₁₋₅ alkenyl”). In some embodiments, a heteroalkenyl group has 1 to 4 carbon atoms, at least one double bond, and 1 or 2 heteroatoms within the parent chain (“heteroC₁₋₄ alkenyl”). In some embodiments, a heteroalkenyl group has 1 to 3 carbon atoms, at least one double bond, and 1 heteroatom within the parent chain (“heteroC₁₋₃ alkenyl”). In some embodiments, a heteroalkenyl group has 1 to 2 carbon atoms, at least one double bond, and 1 heteroatom within the parent chain (“heteroC₁₋₂ alkenyl”). In some embodiments, a heteroalkenyl group has 1 to 6 carbon atoms, at least one double bond, and 1 or 2 heteroatoms within the parent chain (“heteroC₁₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₁₋₂₀ alkenyl. In certain embodiments, the heteroalkenyl group is a substituted heteroC₁₋₂₀ alkenyl.

The term “alkynyl” refers to a radical of a straight-chain or branched hydrocarbon group having from 1 to 20 carbon atoms and one or more carbon-carbon triple bonds (e.g., 1, 2, 3, or 4 triple bonds) (“C₁₋₂₀ alkynyl”). In some embodiments, an alkynyl group has 1 to 10 carbon atoms (“C₁₋₁₀ alkynyl”). In some embodiments, an alkynyl group has 1 to 9 carbon atoms (“C₁₋₉ alkynyl”). In some embodiments, an alkynyl group has 1 to 8 carbon atoms (“C₁₋₈ alkynyl”). In some embodiments, an alkynyl group has 1 to 7 carbon atoms (“C₁₋₇ alkynyl”). In some embodiments, an alkynyl group has 1 to 6 carbon atoms (“C₁₋₆ alkynyl”). In some embodiments, an alkynyl group has 1 to 5 carbon atoms (“C₁₋₅ alkynyl”). In some embodiments, an alkynyl group has 1 to 4 carbon atoms (“C₁₋₄ alkynyl”). In some embodiments, an alkynyl group has 1 to 3 carbon atoms (“C₁₋₃ alkynyl”). In some embodiments, an alkynyl group has 1 to 2 carbon atoms (“C₁₋₂ alkynyl”). In some embodiments, an alkynyl group has 1 carbon atom (“C₁ alkynyl”). The one or more carbon-carbon triple bonds can be internal (such as in 2-butynyl) or terminal (such as in 1-butynyl). Examples of C₁₋₄ alkynyl groups include, without limitation, methylidynyl (C₁), ethynyl (C₂), 1-propynyl (C₃), 2-propynyl (C₃), 1-butynyl (C₄), 2-butynyl (C₄), and the like. Examples of C₁₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₁₋₂₀ alkynyl. In certain embodiments, the alkynyl group is a substituted C₁₋₂₀ alkynyl.

The term “heteroalkynyl” refers to an alkynyl group, which further includes at least one heteroatom (e.g., 1, 2, 3, or 4 heteroatoms) selected from oxygen, nitrogen, or sulfur within (e.g., inserted between adjacent carbon atoms of) and/or placed at one or more terminal position(s) of the parent chain. In certain embodiments, a heteroalkynyl group refers to a group having from 1 to 20 carbon atoms, at least one triple bond, and 1 or more heteroatoms within the parent chain (“heteroC₁₋₂₀ alkynyl”). In certain embodiments, a heteroalkynyl group refers to a group having from 1 to 10 carbon atoms, at least one triple bond, and 1 or more heteroatoms within the parent chain (“heteroC₁₋₁₀ alkynyl”). In some embodiments, a heteroalkynyl group has 1 to 9 carbon atoms, at least one triple bond, and 1 or more heteroatoms within the parent chain (“heteroC₁₋₉ alkynyl”). In some embodiments, a heteroalkynyl group has 1 to 8 carbon atoms, at least one triple bond, and 1 or more heteroatoms within the parent chain (“heteroC₁₋₈ alkynyl”). In some embodiments, a heteroalkynyl group has 1 to 7 carbon atoms, at least one triple bond, and 1 or more heteroatoms within the parent chain (“heteroC₁₋₇ alkynyl”). In some embodiments, a heteroalkynyl group has 1 to 6 carbon atoms, at least one triple bond, and 1 or more heteroatoms within the parent chain (“heteroC₁₋₆ alkynyl”). In some embodiments, a heteroalkynyl group has 1 to 5 carbon atoms, at least one triple bond, and 1 or 2 heteroatoms within the parent chain (“heteroC₁₋₅ alkynyl”). In some embodiments, a heteroalkynyl group has 1 to 4 carbon atoms, at least one triple bond, and 1 or 2 heteroatoms within the parent chain (“heteroC₁₋₄ alkynyl”). In some embodiments, a heteroalkynyl group has 1 to 3 carbon atoms, at least one triple bond, and 1 heteroatom within the parent chain (“heteroC₁₋₃ alkynyl”). In some embodiments, a heteroalkynyl group has 1 to 2 carbon atoms, at least one triple bond, and 1 heteroatom within the parent chain (“heteroC₁₋₂ alkynyl”). In some embodiments, a heteroalkynyl group has 1 to 6 carbon atoms, at least one triple bond, and 1 or 2 heteroatoms within the parent chain (“heteroC₁₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₁₋₂₀ alkynyl. In certain embodiments, the heteroalkynyl group is a substituted heteroC₁₋₂₀ alkynyl.

The term “carbocyclyl” or “carbocyclic” refers to a radical of a non-aromatic cyclic hydrocarbon group having from 3 to 14 ring carbon atoms (“C₃₋₁₄ carbocyclyl”) and zero heteroatoms in the non-aromatic ring system. In some embodiments, a carbocyclyl group has 3 to 14 ring carbon atoms (“C₃₋₁₄ carbocyclyl”). In some embodiments, a carbocyclyl group has 3 to 13 ring carbon atoms (“C₃₋₁₃ carbocyclyl”). In some embodiments, a carbocyclyl group has 3 to 12 ring carbon atoms (“C₃₋₁₂ carbocyclyl”). In some embodiments, a carbocyclyl group has 3 to 11 ring carbon atoms (“C₃₋₁₁ carbocyclyl”). In some embodiments, a carbocyclyl group has 3 to 10 ring carbon atoms (“C₃₋₁₀ carbocyclyl”). In some embodiments, a carbocyclyl group has 3 to 8 ring carbon atoms (“C₃-s carbocyclyl”). In some embodiments, a carbocyclyl group has 3 to 7 ring carbon atoms (“C₃₋₇ carbocyclyl”). In some embodiments, a carbocyclyl group has 3 to 6 ring carbon atoms (“C₃₋₆ carbocyclyl”). In some embodiments, a carbocyclyl group has 4 to 6 ring carbon atoms (“C₄₋₆ carbocyclyl”). In some embodiments, a carbocyclyl group has 5 to 6 ring carbon atoms (“C₅₋₆ carbocyclyl”). In some embodiments, a carbocyclyl group has 5 to 10 ring carbon atoms (“C₅₋₁₀ carbocyclyl”). Exemplary C₃₋₆ carbocyclyl groups include cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. Exemplary C₃₋₈ carbocyclyl groups include the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. Exemplary C₃₋₈ carbocyclyl groups include the aforementioned C₃₋₁₀ carbocyclyl groups as well as cycloundecyl (C₁₁), spiro[5.5]undecanyl (C₁₁), cyclododecyl (C₁₂), cyclododecenyl (C₁₂), cyclotridecane (C₁₃), cyclotetradecane (C₁₄), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is an unsubstituted C₃₋₁₄ carbocyclyl. In certain embodiments, the carbocyclyl group is a substituted C₃₋₁₄ carbocyclyl.

In some embodiments, “carbocyclyl” is a monocyclic, saturated carbocyclyl group having from 3 to 14 ring carbon atoms (“C₃₋₁₄ cycloalkyl”). In some embodiments, a cycloalkyl group has 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 4 to 6 ring carbon atoms (“C₄₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₅). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₄ cycloalkyl. In certain embodiments, the cycloalkyl group is a substituted C₃₋₁₄ cycloalkyl. In certain embodiments, the carbocyclyl includes 0, 1, or 2 C═C double bonds in the carbocyclic ring system, as valency permits.

The term “heterocyclyl” or “heterocyclic” refers to a radical of a 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 3-14 membered heterocyclyl. In certain embodiments, the heterocyclyl group is a substituted 3-14 membered heterocyclyl. In certain embodiments, the heterocyclyl is substituted or unsubstituted, 3- to 7-membered, monocyclic heterocyclyl, wherein 1, 2, or 3 atoms in the heterocyclic ring system are independently oxygen, nitrogen, or sulfur, as valency permits.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

Exemplary 3-membered heterocyclyl groups containing 1 heteroatom include azirdinyl, oxiranyl, and thiiranyl. Exemplary 4-membered heterocyclyl groups containing 1 heteroatom include azetidinyl, oxetanyl, and thietanyl. Exemplary 5-membered heterocyclyl groups containing 1 heteroatom include tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include dioxolanyl, oxathiolanyl and dithiolanyl. Exemplary 5-membered heterocyclyl groups containing 3 heteroatoms include triazolinyl, oxadiazolinyl, and thiadiazolinyl. Exemplary 6-membered heterocyclyl groups containing 1 heteroatom include piperidinyl, tetrahydropyranyl, dihydropyridinyl, and thianyl. Exemplary 6-membered heterocyclyl groups containing 2 heteroatoms include piperazinyl, morpholinyl, dithianyl, and dioxanyl. Exemplary 6-membered heterocyclyl groups containing 3 heteroatoms include triazinyl. Exemplary 7-membered heterocyclyl groups containing 1 heteroatom include azepanyl, oxepanyl and thiepanyl. Exemplary 8-membered heterocyclyl groups containing 1 heteroatom include azocanyl, oxecanyl and thiocanyl. Exemplary bicyclic heterocyclyl groups include indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H-furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1H-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₄ aryl. In certain embodiments, the aryl group is a substituted C₆₋₁₄ aryl.

“Aralkyl” is a subset of “alkyl” and refers to an alkyl group substituted by an aryl group, wherein the point of attachment is on the alkyl moiety.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, e.g., either the ring bearing a heteroatom (e.g., 2-indolyl) or the ring that does not contain a heteroatom (e.g., 5-indolyl). In certain embodiments, the heteroaryl is substituted or unsubstituted, 5- or 6-membered, monocyclic heteroaryl, wherein 1, 2, 3, or 4 atoms in the heteroaryl ring system are independently oxygen, nitrogen, or sulfur. In certain embodiments, the heteroaryl is substituted or unsubstituted, 9- or 10-membered, bicyclic heteroaryl, wherein 1, 2, 3, or 4 atoms in the heteroaryl ring system are independently oxygen, nitrogen, or sulfur.

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

Exemplary 5-membered heteroaryl groups containing 1 heteroatom include pyrrolyl, furanyl, and thiophenyl. Exemplary 5-membered heteroaryl groups containing 2 heteroatoms include imidazolyl, pyrazolyl, oxazolyl, isoxazolyl, thiazolyl, and isothiazolyl. Exemplary 5-membered heteroaryl groups containing 3 heteroatoms include triazolyl, oxadiazolyl, and thiadiazolyl. Exemplary 5-membered heteroaryl groups containing 4 heteroatoms include tetrazolyl. Exemplary 6-membered heteroaryl groups containing 1 heteroatom include pyridinyl. Exemplary 6-membered heteroaryl groups containing 2 heteroatoms include pyridazinyl, pyrimidinyl, and pyrazinyl. Exemplary 6-membered heteroaryl groups containing 3 or 4 heteroatoms include triazinyl and tetrazinyl, respectively. Exemplary 7-membered heteroaryl groups containing 1 heteroatom include azepinyl, oxepinyl, and thiepinyl. Exemplary 5,6-bicyclic heteroaryl groups include indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include naphthyridinyl, pteridinyl, quinolinyl, isoquinolinyl, cinnolinyl, quinoxalinyl, phthalazinyl, and quinazolinyl. Exemplary tricyclic heteroaryl groups include phenanthridinyl, dibenzofuranyl, carbazolyl, acridinyl, phenothiazinyl, phenoxazinyl, and phenazinyl.

“Heteroaralkyl” is a subset of “alkyl” and refers to an alkyl group substituted by a heteroaryl group, wherein the point of attachment is on the alkyl moiety.

The term “unsaturated bond” refers to a double or triple bond.

The term “unsaturated” or “partially unsaturated” refers to a moiety that includes at least one double or triple bond.

The term “saturated” or “fully saturated” refers to a moiety that does not contain a double or triple bond, e.g., the moiety only contains single bonds.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl.

A group is optionally substituted unless expressly provided otherwise. The term “optionally substituted” refers to being substituted or unsubstituted. In certain embodiments, alkyl, alkenyl, alkynyl, heteroalkyl, heteroalkenyl, heteroalkynyl, carbocyclyl, heterocyclyl, aryl, and heteroaryl groups are optionally substituted. “Optionally substituted” refers to a group which is substituted or unsubstituted (e.g., “substituted” or “unsubstituted” alkyl, “substituted” or “unsubstituted” alkenyl, “substituted” or “unsubstituted” alkynyl, “substituted” or “unsubstituted” heteroalkyl, “substituted” or “unsubstituted” heteroalkenyl, “substituted” or “unsubstituted” heteroalkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety. The invention is not limited in any manner by the exemplary substituents described herein.

Exemplary carbon atom substituents include halogen, —CN, —NO₂, —N₃, —SO₂H, —SO₃H, —OH, —OR^{aa}, —ON(R^{bb})₂, —N(R^{bb})₂, —N(R^{bb})3⁺X⁻, —N(OR^{cc})R^{bb}, —SH, —SR^{aa}, —SSR^{cc}, —C(═O)R^{aa}, —CO₂H, —CHO, —C(OR^{cc})₂, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂—C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃—C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{cc})₂, —OP(═O)(OR^{cc})₂, —P(═O)(N(R^{bb})₂)₂, —OP(═O)(N(R^{bb})₂)₂, —N^{bb}P(═O)(R^{aa})₂, —NR^{bb}P(═O)(OR^{cc})₂—NR^{bb}P(═O)(N(R^{bb})₂)₂, —P(R^{cc})₂, —P(OR^{cc})₂, —P(R^{cc})₃⁺X⁻, —P(OR^{cc})3⁺X⁻, —P(R^{cc})₄, —P(OR^{cc})₄ —OP(R^{cc})₂, —OP(R^{cc})₃³⁰ X⁻, —OP(OR^{cc})₂, —OP(OR^{cc})₃⁺X⁻, —OP(R^{cc})₄, —OP(OR^{cc})₄B(R^{aa})₂, —B(OR^{cc})₂, —BR^{aa}(OR^{cc}), C₁₋₂₀ alkyl, C₁₋₂₀ perhaloalkyl, C₁₋₂₀ alkenyl, C₁₋₂₀ alkynyl, heteroC₁₋₂₀ alkyl, heteroC₁₋₂₀ alkenyl, heteroC₁₋₂₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion;
or two geminal hydrogens on a carbon atom are replaced with the group ═O, ═S, ═NN(R^{bb})₂, ═NNR^{bb}C(═O)R^{aa}, —NNR^{bb}C(═O)OR^{aa}, —NNR^{bb}S(═O)₂R^{aa}, ═NR^{bb}, or ═NOR^{cc};
wherein:
   each instance of R^{aa} is, independently, selected from C₁₋₂₀ alkyl, C₁₋₂₀ perhaloalkyl, C₁₋₂₀ alkenyl, C₁₋₂₀ alkynyl, heteroC₁₋₂₀ alkyl, heteroC₁₋₂₀alkenyl, heteroC₁₋₂₀alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each of the alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
   each instance of R^{bb} is, independently, selected from hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(R^{aa})₂ —P(═O)(OR^{cc})₂, —P(═O)(N(R^{cc})₂)₂, C₁₋₂₀ alkyl, C₁₋₂₀ perhaloalkyl, C₁₋₂₀ alkenyl, C₁₋₂₀ alkynyl, heteroC₁₋₂₀alkyl, heteroC₁₋₂₀alkenyl, heteroC₁₋₂₀alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
   each instance of RC is, independently, selected from hydrogen, C₁₋₂₀ alkyl, C₁₋₂₀ perhaloalkyl, C₁₋₂₀ alkenyl, C₁₋₂₀ alkynyl, heteroC₁₋₂₀ alkyl, heteroC₁₋₂₀ alkenyl, heteroC₁₋₂₀ alkynyl, C₃₋₁₀ carbocyclyl, 3-14 membered heterocyclyl, C₆₋₁₄ aryl, and 5-14 membered heteroaryl, or two R^{cc} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
   each instance of R^{dd} is, independently, selected from halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NRfC(═O)R^{ee}, —NR^{ee}CO₂R^{ee}, —NR^{ff}C(═O)N(R^{ff})₂, —C(═NR)OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR₄C(═NR^{ff})N(R^{ff})₂, —NR^{ff}SO₂R^{ee}, —SO₂N(R^{f})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂, —P(═O)(R^{ee})₂, —OP(═O)(R^{ee})₂, —OP(═O)(OR^{ee})₂, C₁₋₁₀ alkyl, C₁₋₁₀ perhaloalkyl, C₁₋₁₀ alkenyl, C₁₋₁₀ alkynyl, heteroC₁₋₁₀alkyl, heteroC₁₋₁₀alkenyl, heteroC₁₋₁₀alkynyl, C₃₋₁₀ carbocyclyl, 3-10 membered heterocyclyl, C₆₋₁₀ aryl, and 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{cc} groups, or two geminal R^{dd} substituents are joined to form ═O or ═S; wherein X⁻ is a counterion;
each instance of R^{ee} is, independently, selected from C₁₋₁₀ alkyl, C₁₋₁₀ perhaloalkyl, C₁₋₁₀ alkenyl, C₁₋₁₀ alkynyl, heteroC₁₋₁₀ alkyl, heteroC₁₋₁₀ alkenyl, heteroC₁₋₁₀ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups;
   each instance of R^{ff} is, independently, selected from hydrogen, C₁₋₁₀ alkyl, C₁₋₁₀ perhaloalkyl, C₁₋₁₀ alkenyl, C₁₋₁₀ alkynyl, heteroC₁₋₁₀ alkyl, heteroC₁₋₁₀ alkenyl, heteroC₁₋₁₀ alkynyl, C₃₋₁₀ carbocyclyl, 3-10 membered heterocyclyl, C₆₋₁₀ aryl, and 5-10 membered heteroaryl, or two R^{ff} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups;
   each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)²⁺X⁻, —NH₂(C₁₋₆ alkyl)+X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(NH)NH(C₁₋₆ alkyl), —OC(NH)NH₂, —NHC(NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂C₁₋₆ alkyl, —SO₂OC₁₋₆ alkyl, —OSO₂C₁₋₆ alkyl, —SOC₁₋₆ alkyl, —Si(C₁₋₆ alkyl)₃, —OSi(C₁₋₆ alkyl)₃, —C(═S)N(C₁₋₆ alkyl)₂, C(═S)NH(C₁₋₆ alkyl), C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₁₀ alkyl, C₁₋₁₀ perhaloalkyl, C₁₋₁₀ alkenyl, C₁₋₁₀ alkynyl, heteroC₁₋₁₀ alkyl, heteroC₁₋₁₀ alkenyl, heteroC₁₋₁₀ alkynyl, C₃₋₁₀ carbocyclyl, C₆₋₁₀ aryl, 3-10 membered heterocyclyl, or 5-10 membered heteroaryl; or two geminal R^{gg} substituents can be joined to form ═O or ═S; and
   each X⁻ is a counterion.

In certain embodiments, each carbon atom substituent is independently halogen, substituted (e.g., substituted with one or more halogen) or unsubstituted C₁₋₆ alkyl, —OR—, —SR—, —N(R^{bb})₂, —CN, —SCN, —NO₂, —C(═O)R^{aa}, —CO₂R^{aa}, —C(═O)N(R^{bb})₂, —OC(═O)R^{aa}, —OCO₂R^{aa}, —OC(═O)N(R^{bb})₂, —NR^{bb}C(═O)R^{aa}, —NR^{b}CO₂R^{aa}, or —NR^{bb}C(═O)N(R^{bb})₂. In certain embodiments, each carbon atom substituent is independently halogen, substituted (e.g., substituted with one or more halogen) or unsubstituted C₁₋₁₀ alkyl, —OR^{aa}, —SR^{aa}, —N(R^{bb})₂, —CN, —SCN, —NO₂, —C(═O)R^{aa}, —CO₂R—, —C(═O)N(R^{bb})₂, —OC(═O)R^{aa}, —OC(═O)N(R^{bb})₂, —NR^{bb}C(═O)R^{aa}, —N^{bb}CO₂R—, or —NR^{bb}C(═O)N(R^{bb})₂, wherein R^{aa} is hydrogen, substituted (e.g., substituted with one or more halogen) or unsubstituted C₁₋₁₀ alkyl, an oxygen protecting group (e.g., silyl, TBDPS, TBDMS, TIPS, TES, TMS, MOM, THP, t-Bu, Bn, allyl, acetyl, pivaloyl, or benzoyl) when attached to an oxygen atom, or a sulfur protecting group (e.g., acetamidomethyl, t-Bu, 3-nitro-2-pyridine sulfenyl, 2-pyridine-sulfenyl, or triphenylmethyl) when attached to a sulfur atom; and each R^{bb} is independently hydrogen, substituted (e.g., substituted with one or more halogen) or unsubstituted C₁₋₁₀ alkyl, or a nitrogen protecting group (e.g., Bn, Boc, Cbz, Fmoc, trifluoroacetyl, triphenylmethyl, acetyl, or Ts). In certain embodiments, each carbon atom substituent is independently halogen, substituted (e.g., substituted with one or more halogen) or unsubstituted C₁₋₆ alkyl, —OR^{aa}, —SR^{aa}, —N(R^{bb})₂, —CN, —SCN, or —NO₂. In certain embodiments, each carbon atom substituent is independently halogen, substituted (e.g., substituted with one or more halogen moieties) or unsubstituted C₁₋₁₀ alkyl, —OR^{a}, —SR^{aa}, —N(R^{bb})₂, —CN, —SCN, or —NO₂, wherein R^{aa} is hydrogen, substituted (e.g., substituted with one or more halogen) or unsubstituted C₁₋₁₀ alkyl, an oxygen protecting group (e.g., silyl, TBDPS, TBDMS, TIPS, TES, TMS, MOM, THP, t-Bu, Bn, allyl, acetyl, pivaloyl, or benzoyl) when attached to an oxygen atom, or a sulfur protecting group (e.g., acetamidomethyl, t-Bu, 3-nitro-2-pyridine sulfenyl, 2-pyridine-sulfenyl, or triphenylmethyl) when attached to a sulfur atom; and each R^{bb} is independently hydrogen, substituted (e.g., substituted with one or more halogen) or unsubstituted C₁₋₁₀ alkyl, or a nitrogen protecting group (e.g., Bn, Boc, Cbz, Fmoc, trifluoroacetyl, triphenylmethyl, acetyl, or Ts).

In certain embodiments, the molecular weight of a carbon atom substituent is lower than 250, lower than 200, lower than 150, lower than 100, or lower than 50 g/mol.

In certain embodiments, a carbon atom substituent consists of carbon, hydrogen, fluorine, chlorine, bromine, iodine, oxygen, sulfur, nitrogen, and/or silicon atoms. In certain embodiments, a carbon atom substituent consists of carbon, hydrogen, fluorine, chlorine, bromine, iodine, oxygen, sulfur, and/or nitrogen atoms. In certain embodiments, a carbon atom substituent consists of carbon, hydrogen, fluorine, chlorine, bromine, and/or iodine atoms. In certain embodiments, a carbon atom substituent consists of carbon, hydrogen, fluorine, and/or chlorine atoms.

The term “halo” or “halogen” refers to fluorine (fluoro, —F), chlorine (chloro, —Cl), bromine (bromo, —Br), or iodine (iodo, —I).

The term “hydroxyl” or “hydroxy” refers to the group —OH. The term “substituted hydroxyl” or “substituted hydroxyl,” by extension, refers to a hydroxyl group wherein the oxygen atom directly attached to the parent molecule is substituted with a group other than hydrogen, and includes groups selected from —OR^{aa}, ON(R^{bb})₂, —OC(═O)SR^{aa}, —OC(═O)R^{aa}, —OCO₂R^{aa}, —OC(═O)N(R^{bb})₂, —OC(═NR^{bb})R^{aa}, —OC(═NR^{bb})OR^{aa}, —OC(═NR^{bb})N(R^{bb})₂, —OS(═O)R^{aa}, —OSO₂R^{aa}, —OSi(R^{aa})₃, —OP(R^{cc})₂, —OP(R^{cc})3⁺X⁻, —OP(OR^{cc})₂, —OP(OR^{cc})₃⁺X⁻, —OP(═O)(R^{aa})₂, —OP(═O)(OR^{cc})₂, and —OP(═O)(N(R^{bb}))₂, wherein X⁻, R^{aa}, R^{bb}, and R^{cc} are as defined herein.

The term “thiol” or “thio” refers to the group —SH. The term “substituted thiol” or “substituted thio,” by extension, refers to a thiol group wherein the sulfur atom directly attached to the parent molecule is substituted with a group other than hydrogen, and includes groups selected from —SR^{aa}, —S═SR^{cc}, —SC(═S)SR^{aa}, —SC(═S)OR^{aa}, —SC(═S) N(R^{bb})₂, —SC(═O)SR^{aa}, —SC(═O)OR^{aa}, —SC(═O)N(R^{bb})₂, and —SC(═O)R^{aa}, wherein R^{aa} and R^{cc} are as defined herein.

The term “amino” refers to the group —NH₂. The term “substituted amino,” by extension, refers to a monosubstituted amino, a disubstituted amino, or a trisubstituted amino. In certain embodiments, the “substituted amino” is a monosubstituted amino or a disubstituted amino group.

The term “monosubstituted amino” refers to an amino group wherein the nitrogen atom directly attached to the parent molecule is substituted with one hydrogen and one group other than hydrogen, and includes groups selected from —NH(R^{bb}), —NHC(═O)R^{aa}, —NHCO₂R^{aa}, —NHC(═O)N(R^{bb})₂, —NHC(═NR^{bb})N(R^{bb})₂, —NHSO₂R^{aa}, —NHP(═O)(OR^{cc})₂, and —NHP(═O)(N(R^{bb})₂)₂, wherein R^{aa}, R^{bb} and R^{cc} are as defined herein, and wherein R^{bb} of the group —NH(R^{bb}) is not hydrogen.

The term “disubstituted amino” refers to an amino group wherein the nitrogen atom directly attached to the parent molecule is substituted with two groups other than hydrogen, and includes groups selected from —N(R^{bb})₂, —NR^{bb} C(═O)R^{aa}, NR^{bb}CO₂Ra^{a}—NR^{bb}C(═O)N(R^{bb})₂—NR^{bb}C(═NR^{bb})N(R^{bb})₂—R^{bb}SO₂R^{aa}, —NR^{bb}P(═O)(OR^{cc})₂, and —NR^{bb}P(═O)(N(R^{bb})₂)₂, wherein R^{aa}, R^{bb}, and R^{cc} are as defined herein, with the proviso that the nitrogen atom directly attached to the parent molecule is not substituted with hydrogen.

The term “trisubstituted amino” refers to an amino group wherein the nitrogen atom directly attached to the parent molecule is substituted with three groups, and includes groups selected from —N(R^{bb})₃ and —N(R^{bb})3⁺X⁻, wherein R^{bb} and X⁻ are as defined herein.

The term “sulfonyl” refers to a group selected from —SO₂N(R^{bb})₂, —SO₂Ra^{a}, and —SO₂OR^{aa}, wherein R^{aa} and R^{bb} are as defined herein.

The following examples are intended to illustrate certain embodiments of the present invention, but do not exemplify the full scope of the invention.

### Example 1

This Example describes the preparation and characterization of adsorbent materials for capturing PFAS compounds, and experiments reporting the successful capture of the PFAS compounds.

The following individual PFAS Compounds were ordered from SynQuest Laboratories (abbreviations shown in brackets and CAS numbers shown in parentheses): perfluoroheptanoic acid [PFHpA] (375-85-9), perfluorooctanoic acid [PFOA] (335-67-1), perfluorononanoic acid [PFNA] (375-95-1), perfluorobutanesulfonic acid [PFBS](375-73-5), perfluorohexanesulfonic acid [PFHxS] (355-46-4), and perfluorooctanesulfonic acid [PFOS] (1763-23-1). The following standards were ordered from Wellington Laboratories: 30 Native PFAS Solution (1 μg/mL; Product No: PFAC30 PAR) and [¹³C]perfluorinated acid/sulfonate Mix (Product No: MPFAC-MXA).

Other chemicals employed were: potassium hydroxide (KOH), methanol (MeOH), ammonium hydroxide (NH₄OH), and ammonium chloride (NH₄Cl).

Supplies for performing the experiments included polypropylene or high density polypropylene (HDPE) sample/standard storage bottles, 9 mm plastic screw thread Vials—2-mL or 300-μL (Thermo Fisher C4000, polypropylene), 9 mm autosampler vial screw thread caps (Thermo Fisher C5000, polypropylene membrane), MasterFlex L/S Precision Pump Tubing C-Flex (Product No: 06424-16), centrifuge tubes (polypropylene)—2-mL, 15-mL and 50-mL, a mortar and pestle, an end-over-end rotator, and a mini centrifuge.

The adsorbent material for capturing PFAS compounds was prepared as a resin. The resin was made from dried silica-based ceramic anion exchange membrane (AEM) sol either prepared fresh in the laboratory (“AEM-lab”) for the purpose of these experiments or from the leftover sol used for manufacturing membranes for other purposes (“AEM-mfg”). These membranes were prepared according to the methods described in U.S. Patent Publication No. 2020-0388871, published on Dec. 10, 2020 and entitled “Ceramic Anion Exchange Materials,” which is incorporated herein by reference in its entirety for all purposes. Briefly, the sols were prepared by combining TEOS and TEAPS with 0.3 M HCl (at a 6:1 mole ratio of TEOS:TEAPS) while stirring until the mixtures became clear. Then, the mixture was heated to 60° C. and stirred for 30-35 minutes. The resulting mixture was allowed to dry until fully solidified, and then ground into a powder with a mortar and pestle for 10 minutes. AEM-lab sols were aged for 1 hour at 40° C. and then 30 minutes in an open container at 40° C. AEM-mfg sols were also aged. The resulting powder was then characterized using scanning electron microscopy (SEM) and Fourier-transform infrared (FTIR) spectroscopy.

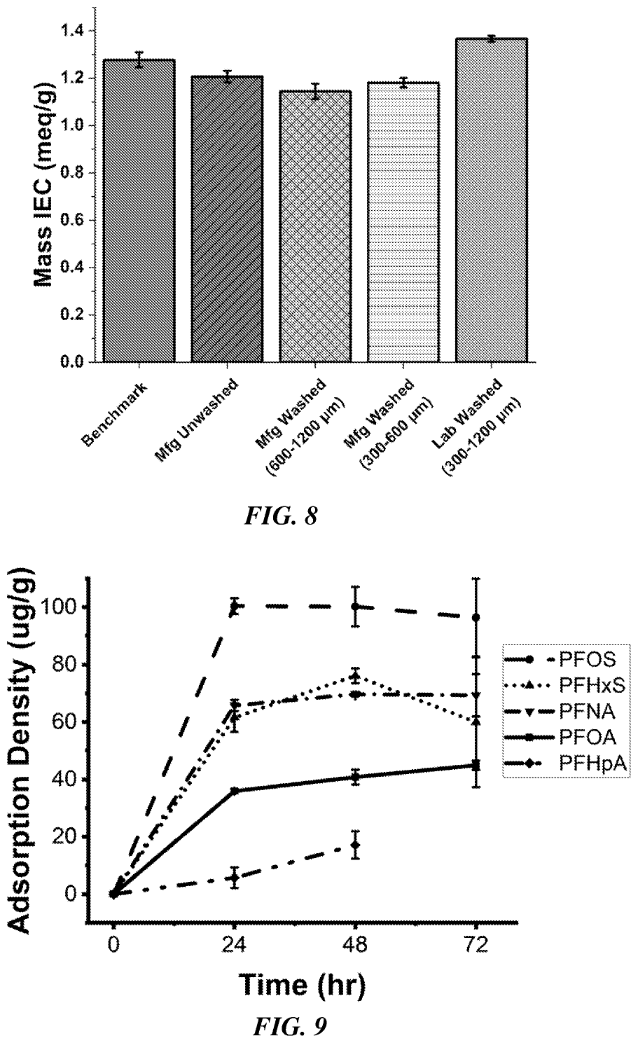

To ensure purity of the resin, the following washing procedure was followed. In a Buchner funnel, the resin was rinsed three times with reverse osmosis (RO) water for around 10 minutes each to remove any excess unreacted silane from the sol preparation process. The resin was then added to a plastic container and soaked in an aqueous solution of 0.25 M NaCl for 24 hours to convert the resin to a chloride form. Using the Buchner funnel once more, the resin was rinsed three times with 0.25 M NaCl to remove any OH⁻ released during the previous step. Finally, the resin was rinsed with RO water and allowed to dry in air overnight to remove any excess moisture and allow for more accurate weighing. The particle size of the dried resin was controlled using sieves with mesh sizes of 1180 micron, 600 micron, 300 micron, and 150 micron. Ion exchange capacity measurements were made with particles that passed through the 1180 micron sieve but were stopped by the 600 micron sieve and particles that passed through the 600 micron sieve but were stopped by the 300 micron sieve (see FIG. 8). It should be understood that the “1200 μm” value used with reference to FIG. 8 is for convenience, and in fact corresponds to 1180 microns. The batch slurry experiments described below were performed with particles that passed through the 1180 micron sieve but were stopped by the 600 micron sieve.

Ion exchange capacity was measured for the resin. The “Anion Exchange Capacity” was measured according to the method described in U.S. Patent Publication No. 2020-0388871, with the following modifications to accommodate the different form factor. To exchange the soaking solutions (2 M NaCl, deionized water (DI), 2M NaNO₃), a disposable pipette was used. The tip of the pipette was placed flush with the bottom of the beaker to ensure resin was excluded. Before dispensing the liquid into waste or a collection beaker, the pipette was inspected to ensure no resin was present. If resin was in the pipette, it was dispensed back into the original beaker and the liquid was re-drawn.

All PFAS solutions, samples and standards were stored in a high-density polypropylene bottle. Any standard or sample that required accurate concentration measurements (such as calibration standards and surrogate solutions) were kept in a refrigerator and allowed to come to room temperature before using. Anything that didn't require accurate concentration measurements (e.g., PFAS solutions for the batch test described below) were stored at room temperature. These experiments did not require accurate concentration because the initial and final concentrations were measured using liquid chromatography with tandem mass spectrometry (LC/MS/MS). For solubility and stability reasons, the dilution standards were prepared in methanol. This dilution standard was then spiked into deionized water for use in batch experiments.

One method used for PFAS adsorption experiments was a differential column batch reactor previously reported in Ateia, M., et al. “Best Practices for Evaluating New Materials as Adsorbents for Water Treatment.” ACSMater. Lett. 2020, 2 (11), 1532-1544. https://doi.org/10.1021/ACSMATERIALSLETT.0C00414. A 0.7×30 cm Kimble Flex-Column was used for resin columns. It was packed with around 10-12 cm of glass wool at the bottom. Next, around one gram of resin was weighed into a beaker. Water was added to the beaker to create a slurry which was then poured into the column on top of the glass wool. A wire hanger was cut and reshaped into a straight line which was then used to swirl the resin suspended in water in the column to ensure even distribution. This was allowed to settle for a few hours until the water had completely drained out of the column. Glass wool was then packed until the very top of the column. Water was added once more to ensure the glass wool was in place. For every resin experiment, a blank column of only glass wool has run to confirm no PFAS adsorption from the column/glass wool, as well as a benchmark (ResinTech SIR HP110) resin for comparison.

Once the column was packed, a peristaltic pump was used to run the PFAS-containing water through the column from bottom to top. To start, DI water was pumped from a reservoir, into the bottom of the column, out of the top of the column and back into the initial reservoir. This was allowed to run overnight to ensure that the column was not leaking and to hydrate the resin. After the water, the flow direction was switched (from “bottom to top” to “top to bottom”) and the tube attached to the bottom of the column was placed in an empty vessel. The pump speed was increased from 5 to 25 to ensure all water was pumped out of the system. Once pumped, the column was ready for PFAS experiment.

Multiple aliquots of a PFAS-spiked deionized water sample solution (˜50 ppb) were added to smaller HDPE bottles or sample vials and were placed in the refrigerator until analysis. Twenty-five milliliters of PFAS sample solution was added to clean HDPE bottle reservoirs. The tubes which were connected to each column were added to the appropriate reservoir, taking extra care that the bottom and top tubes were coming from the same column. The pump was turned on (set to 5) pumping from bottom to top and the column was observed for a few minutes to ensure no leaks. Once the solution was continuously flowing, 5 mL more PFAS solution was added to make sure that there was enough solution at the bottom of the reservoir for continuous contact. This was then allowed to run for multiple days. Final concentration aliquots were collected and stored in a refrigerator until analysis by LC/MS/MS. The pump tubing was changed between runs.

An end-over-end centrifuge tube rotator was used for all slurry batch reactor experiments. The largest centrifuge tube compatible with the current rotator was 50-mL and the lowest reliable measurement capable on the analytical balance was around 10 mg. As a result, all batch reactor measurements were performed with a ratio of 10 mg adsorbate and 50 mL contaminated solution, or 200 mg/L.

Around 10 mg washed resin was weighed and added to a 50-mL centrifuge tube. Next, 52 mL PFAS solution (˜50 ppb) was added. Two milliliters of solution from each tub were extracted using an automated pipet, added to a 2-mL centrifuge tube and set aside (in the refrigerator if overnight) until sample prep. For every sample run, a benchmark and two types of blanks were run. For one blank, DI water was added to a tube containing the washed resin to ensure no cross-contamination in the blank or resin. For the other blank, the PFAS solution was added to a centrifuge tube containing no resin to ensure no adsorption onto the tube surface. Once all centrifuge tubes were full, the rotator was started at 70 rpm end-over-end. This was run for the desired experiment time and after the allotted time, 2 mL aliquots were collected into 2-mL centrifuge tubes.

To avoid PFAS loss through a variety of different types of filters, a centrifuge was used for sample preparation. The 2 mL aliquots collected throughout the experiment were centrifuged at 6000 rpm using the mini centrifuge for about 20 minutes. During this time, 0.5 mL methanol was added to the equivalent number of 2-mL centrifuge tubes to accommodate the number of samples required for analysis. To this, 80 μL internal standard were added to each tube. At the end of the 20 minutes, 0.5 mL PFAS sample were added to the prepared 2-mL centrifuge vials. The desired ratio for sample analysis is 50:50 DI.MeOH. These were then capped and centrifuged for ˜5 minutes to fully mix. Next, 300 μL of sample/methanol/IS mixture was added to the LC/MS/MS sample vials and capped. These were then analyzed or stored in the refrigerator until analysis.

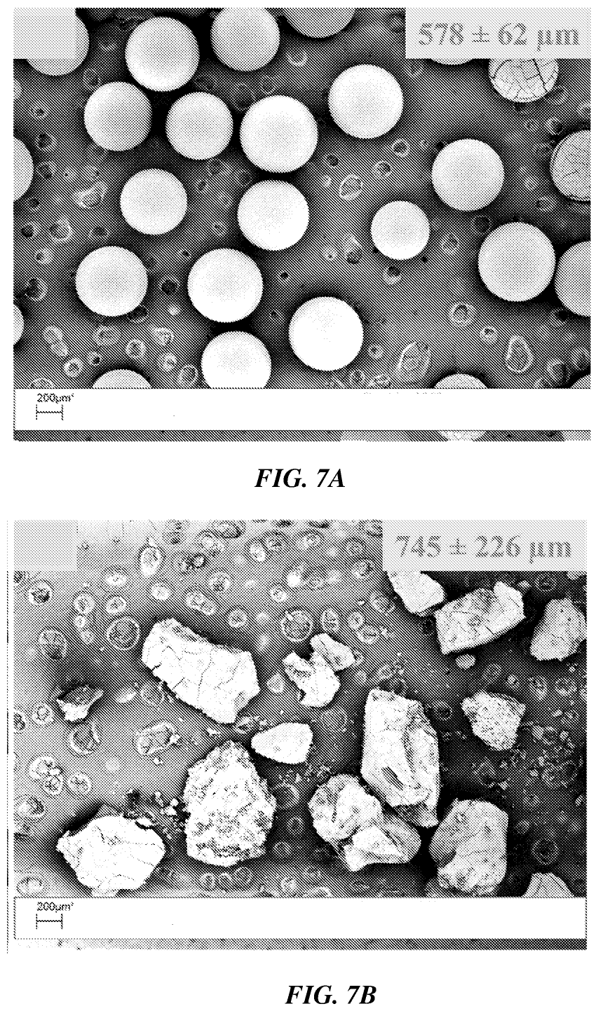

The resin prepared for the PFAS capture experiments were characterized using SEM and FTIR. The SEM measurements were used to investigate the size of the resin particles, based on preparation method, compared to the benchmark (ResinTech SIR-110-HP). FIGS. 7A-7B show SEM images of the benchmark (FIG. 7A) and AEM-lab resin ground under dry conditions (FIG. 7B). The shape of the AEM-lab resin was observed to be much more inconsistent than the benchmark. Compared to the spherical shape of the benchmark, the AEM-lab resin pieces were more rectangular with sharp edges. This is believed to affect the packing of the resin in the column and the accessibility of the PFAS solution to the pores.

The effect of grinding conditions on resin particle size was investigated using SEM. The resin was ground for ten minutes over a range of amounts of water added (forming samples AEM1, AEM2, and AEM3 as shown in Table 1). The average particle size for the resin ground in dry conditions was smallest compared to the wet grinding conditions. The smaller particles size trended towards the benchmark size and provided more surface area for adsorption.

TABLE 1
Comparison of resin particle size based on grinding conditions.

| | Grinding Condition | Particle Length (um) | | | |
|---|---|---|---|---|---|
| Sample | Resin:Water Ratio | Average | Std. Dev | Min | Max |
| Benchmark | N/A | 567.9 | 61.8 | 452.6 | 771.4 |
| AEM1 | 10:0 | 745.4 | 226.3 | 375.0 | 1258 |
| AEM2 | 10:0.5 | 830.6 | 199.8 | 527.1 | 1348 |
| AEM3 | 10:1 | 934.9 | 400.2 | 457.5 | 2267 |

To characterize the amount of ion exchange functional groups available in the resin, ion exchange capacity (IEC) was measured. This was specifically used to investigate the difference between the benchmark, AEM-mfg washed and unwashed, and AEM-lab washed resins. The results are shown in FIG. 8 and suggest that the resin with the highest amount of available exchange sites is the AEM-lab, washed. This resin has an IEC greater than the benchmark which suggested a potential competitive advantage for PFAS capture. Another conclusion that could be drawn from this data was that the resin made from the waste stream from membrane manufacturing (AEM-mfg) suffered from a lower ion exchange capacity. This suggested that the resin prepared fresh in the laboratory should be more effective at PFAS adsorption from an electrostatic perspective.

PFAS column differential batch column reactor tests were conducted and yielded promising results. LC/MS/MS was used to investigate the PFAS adsorption of AEM resin at concentrations that matched those found in highly contaminated sites (0.5-50 μg/L). The starting concentration of the PFOA in water solution was around 7 μg/L and the column was run for 24 hours. The results indicated that around 75+3% of the PFOA was adsorbed using AEM-lab (unwashed) resin, which compared respectably to the ˜100% adsorption performance of the benchmark resin. The measured PFOA adsorption of the blank control was ˜0%.

To move to more industrially relevant adsorption conditions, the reactor configuration was switched from the differential column batch reactor to a slurry batch reactor. This allowed for use of 10 mg of resin compared to 1 g. The other change made for this experiment was the use of a mixed PFAS solution (containing ˜45 μg/L PFNA, PFOA, PFOA, PFHpA, PFOS, and PFHxS). The goal was to gain a better understanding of the selectivity of AEM resin (˜10 mg, washed, with particle size of 600-1200 microns) towards a long and short chain PFAS. The batch was run over the course of 72 hours, with aliquots taken every 24 hours. Washed AEM-mfg resin was used for this experiment.

The results from the slurry batch reactor are shown in FIG. 9. The adsorption is reported in adsorption density (q) which is defined by the following equation where C₀ is the initial concentration of PFAS solution (mg/L), C is the concentration of PFAS solution at the time of collection (mg/L), V is the volume of bulk solution (L) and m is the dry mass of adsorbate (g):

$$q = \frac{( {C}_{0} - C ) V}{m}$$

The use of the adsorption density metric ensured that the mass of resin used was accounted for in the adsorption measurement. These data show two main takeaways: (1) selectivity towards sulfonic acid-based (PFOS, PFHxS) PFAS compared to carboxylic acids (PFNA, PFOA, PFHpA) and (2) selectivity towards long chain (PFOS, PFNA, PFOA, PFHxS) compared to short chain (PFHpA). The sulfonic acid-containing PFAS trend with higher adsorption density compared to the carboxylic acids. This suggests that the electrostatic interaction between the sulfonate on the PFAS and the quaternary ammonium on the resin is stronger compared to the carboxylate. The AEM-mfg resin was much more effective for adsorbing long chain PFAS rather than short chain. Short chain adsorption relies heavily on the electrostatic interaction between the resin and the PFAS as opposed to the degree of hydrophobicity. This suggests that adjusting the functional group type and loading in the resin could influence the selectivity of short-chain PFAS.

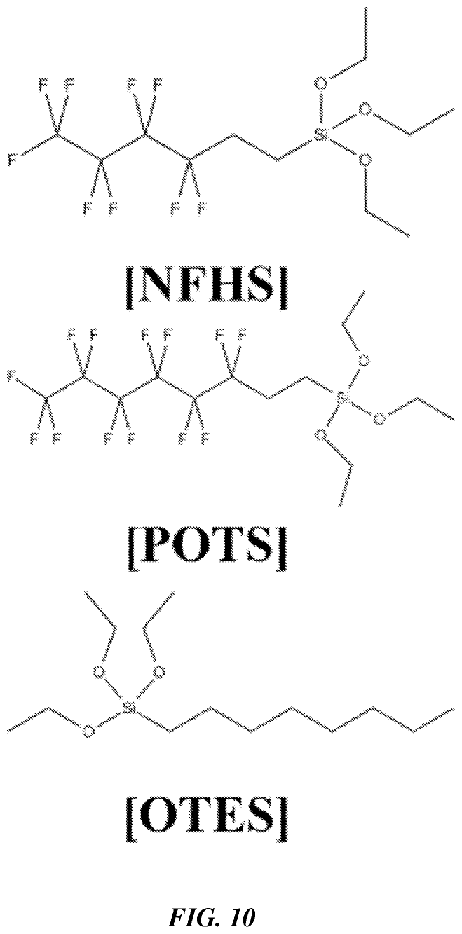

Additional resins with functional groups other than quaternary ammonium groups were made and tested. The focus of the resin design was increasing hydrophobicity and introducing fluorophilic functional groups to enhance interaction with the chains on the PFAS. The silanes chosen for this experiment were nonafluorohexyltriethoxysilane [NFHS], (tridecafluoro-1,1,2,2-tetrahydrooctyl)triethoxysilane [POTS], and n-octyltriethoxysilane [OTES]. FIG. 10 shows the chemical structures of the silanes are shown. Individual sols were made using the same procedure for AEMs and dried accordingly. During resin grinding, the “specialty” sols made used the silanes with different functional groups were added to the mortar with AEM-lab at a ratio of 3:10 (specialty sol:AEM). The resins were ground but not washed, and were sieved by passing through the 1180 micron sieve but stopped at the 600 micron sieve. FTIR was used to confirm presence of functional groups in the resulting resin. IR spectra from the FTIR analysis showed the appearance of C-F groups for NFHS and POTS and enhanced C—H stretch for OTES.

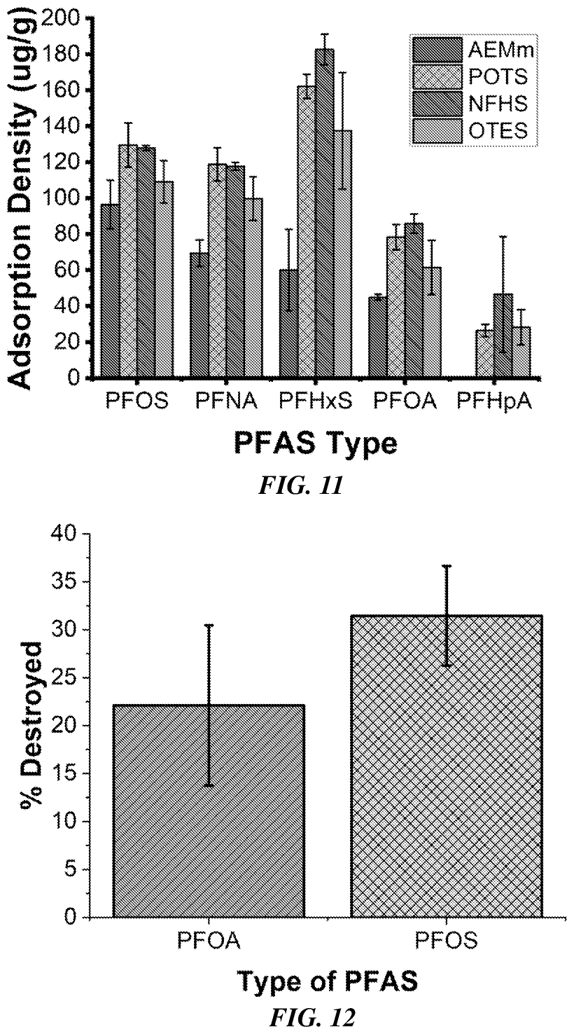

Each specialty silane resin described above was used in a batch slurry reactor experiment similar to the one used for AEM-mfg in FIG. 9. Each batch experiment was run for 72 hours, after which aliquots were collected. The results are shown in FIG. 11, with the AEMm results corresponding to the results shown in FIG. 9 for AEM-mfg at 72 hours. For all PFAS in the mixed solution, adsorption performance was increased. One important consideration for the data in FIG. 11 is that the specialty silanes were ground into the resin containing AEM-lab while the “AEMm” used for comparison was made from manufacturing. This makes it difficult to draw concrete conclusions about the origin of the increased adsorption. Two possible explanations are: (1) increased access to ion exchange sites in AEM-lab compared to AEM-mfg leads to increased adsorption and (2) enhanced adsorption originates from introduction of hydrophobic/fluorophilic functional groups. It is believed that the enhanced performance originates from a combination of these explanations. Another conclusion from the data in FIG. 11 is that the specialty silanes containing C—F bonds (NFHS, POTS) perform better than the alkane chain (OTES). This suggests that the fluorophilic interactions are stronger than the hydrophobic interactions.

### Example 2

This example describes the destruction of PFAS compounds captured by the adsorbent materials described in Example 1 via one type of mechanochemical technique. Specifically, a ball mill technique was used to destroy PFAS compounds captured by the adsorbent materials of Example 1.

To prepare for ball mill destruction measurements, resin must be amended with PFAS. To do this, around 15 g resin was added to a 125-mL HDPE bottle. The resin used for these experiments was unwashed AEM-mfg. Then, 100 mL PFAS solution (˜50 ppb) in DI water was added to the bottle containing the resin. Bottles were shaken by hand to ensure better contact between the solution and resin. These were then allowed to sit for at least two days to ensure PFAS adsorption into the resin. After this period, the resin was filtered using a Buchner funnel and allowed to sit in the fume hood overnight to dry out.

The ball mill destruction experiments were performed based on a procedure previously reported in Turner, L., et al. “Mechanochemical Remediation of Perfluorooctanesulfonic Acid (PFOS) and Perfluorooctanoic Acid (PFOA) Amended Sand and Aqueous Film-Forming Foam (AFFF) Impacted Soil by Planetary Ball Milling.” Sci. Total Environ. 2021, 765, 142722. https://doi.org/10.1016/J.SCITOTENV.2020.142722. From this batch of resin, “pre-ball mill” samples were weighed (˜0.5 g) in triplicate, added to a 15-mL centrifuge tube and set aside. Next, around 5 grams of each PFAS amended resin were weighed for the ball mill experiment. Potassium hydroxide (KOH) co-milling agent was weighed at a ratio of 3:2 (resin: KOH). The resin and KOH were added to the planetary ball mill cups containing stainless steel balls. They were then ball milled for the desired time of the experiment at ˜270 rpm. After the desired time, “post-ball mill” samples were weighed (˜0.3 g) and added to 15-mL centrifuge tubes.

PFAS from the ball mill samples (pre- and post-) were extracted using an extraction solution (1% ammonium chloride (NH₄Cl) in 80% methanol). The solution was added to the centrifuge tube in a 1:10 ratio (e.g., 0.5 g: 5 mL). This was stirred on the end-to-end rotator at 70 rpm for 1 hour. Next, the solution was added to the small centrifuge tubes and centrifuged for 20 minutes at 6,000 rpm. The same sample preparation step in the batch experiments described above was followed except since these samples were extracted in methanol, water was added to the tubes ahead of time rather than methanol (for an end ratio of 50:50 MeOH:DI).

PFAS destruction using a planetary ball mill was investigated. The results shown in FIG. 12 illustrate the results from a ball mill experiment. PFAS-amended AEM-mfg resin was ball milled for 3 hours with the KOH co-milling agent. The percent destroyed was calculated based on the initial and final PFAS concentration extracted from the resin before and after ball milling. The results suggest that PFAS destruction did occur, and that PFOS was more easily destroyed than PFOA. While the percent destruction is much lower than the target (>90%), some PFAS destruction did occur. Further optimization and method development are required but this is a promising first result. When the benchmark was ball milled and extracted using an extraction solution of 1% ammonium hydroxide (w/w %) in methanol, an increase in PFAS concentration was observed after ball milling. While further investigation of extraction conditions for the benchmark resin is warranted, this result suggests that ball milling is not a viable option for PFAS destruction using the benchmark resin, in contrast to the adsorbent materials described in this disclosure.

### Example 3

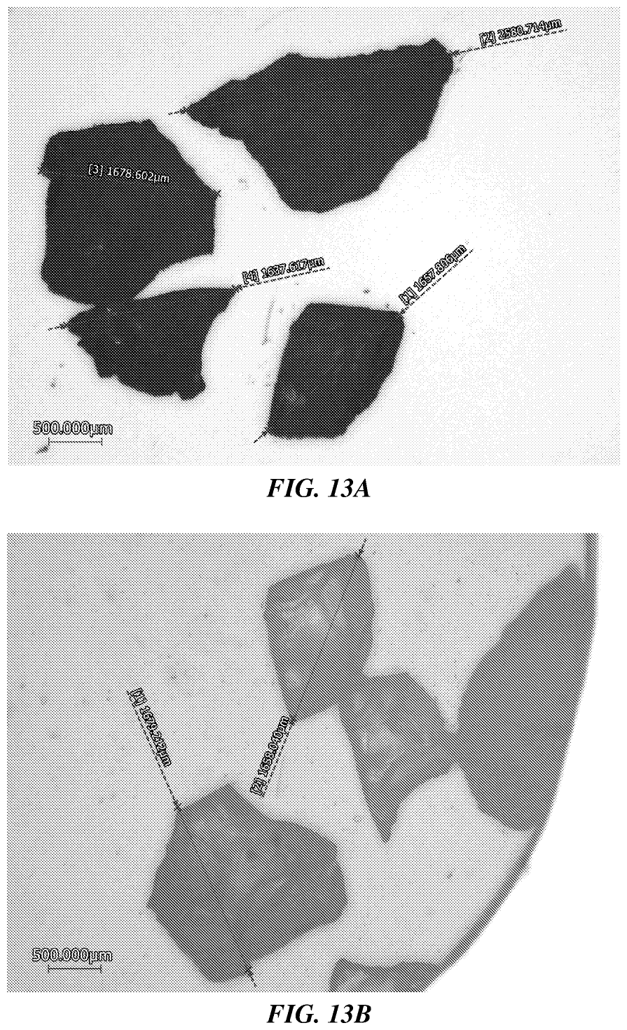

This Example describes testing of the extent of volume expansion of particles of an exemplary adsorbent material comprising ceramic particles. A sample of 6:1 AEM resin prepared according to Example 1 was imaged prior to exposure to water (FIG. 13A) and after exposure to water (FIG. 13B). Measurement of cross-sectional dimensions of the particles indicated minimal dimensional increase in the particles. This experiment indicates the adsorbent materials comprising the ceramic particles of the Example do not undergo a measurable volume expansion.

### Example 4

This Example describes the capture of target species using exemplary adsorbent materials. Specifically, heavy metal capture by functionalized ceramic particles was tested.

Since diffusion within adsorbent particles is often the rate-limiting step in adsorption mass transfer, ion exchange resins are typically designed with a macroporous internal structure, so as to minimize pore diffusion resistances and maximize adsorption rate. Mesoporous structures may also be desirable, depending on the contaminant. Since ion exchange resins are typically used in packed beds in adsorption columns or electrodeionization systems, they are typically sold as beads of around 500-1000 μm in diameter. Smaller beads generally result in faster adsorption rates, but also cause higher hydraulic pressure losses across the packed bed; hence bead size is a tradeoff between these two considerations.

Adsorption is an equilibrium process, with a higher concentration of a pollutant in the aqueous solution surrounding a resin leading to a higher adsorption of that pollutant onto the resin. This relationship is described by an isotherm, which is a plot of aqueous concentration (c, mg pollutant/L solution) vs solid concentration (q, mg pollutant/g resin). Isotherms can be fit according to a Langmuir, Freundlich, or Modified Langmuir-Freundlich (MLF) model. The Langmuir model assumes that an adsorbent has a fixed number of active sites with equal adsorption energy. Since this assumption is fairly close to accurate for ion exchange resins, the Langmuir model typically fits ion exchange resin isotherms quite well. The Freundlich model provides a good empirical fit for a variety of adsorption behaviors, including the adsorption of organics onto activated carbon. Lastly, the Modified Langmuir-Freundlich (MLF) model combines the aforementioned two models to provide even better fits for most adsorbents, and allows for pH dependence to be accounted for. Hence, as far as ion exchange resins are concerned, the MLF model is recommended for fitting isotherms with more data points or where accounting for pH dependence is desired, while the Langmuir model is recommended for fitting isotherms with less data points or where a mathematically simpler model is desired.

Other parameters relevant to the performance of ion exchange resins include adsorption kinetics and the hydraulic properties of resin beads. Faster adsorption kinetics mean that a smaller column can be used to achieve the same removal efficiency. Resins beads must also be sized and shaped appropriately to minimize hydraulic pressure losses across the packed bed for reasons of energy efficiency.

Ceramic particles comprising functional groups were prepared according to the methods generally described in U.S. Patent Publication No. 2020-0384421 and U.S. Patent Publication No. 2020-0388871. The process involved combining TEOS and functionalized silanes such as (3-mercaptopropyl)triethoxysilane (MPTES) and TEAPS with 0.3 M HCl while stirring until the mixtures became clear. Then, the mixture was heated to 60° C. and stirred for 30-35 minutes. The resulting mixture was allowed to dry until fully solidified, and then ground with a mortar and pestle for 10 minutes. The ground resin was then sieved with 1180 micron and 300 micron sieves, keeping the powder that passed through the first sieve but not the second. The resulting powder was rinsed 3×10 minutes with DI water in a Buchner funnel. For cation exchange resin prepared with MPTES, before grinding, the resin was soaked in 20% H₂O₂ solution for 16 hours and then rinsed again 3×10 minutes with DI water. The soaking occurred before grinding. The resulting anion and cation exchange resins were soaked in 0.25 M NaCl or 1 M H₂SO₄ solution, respectively, for at least 24 hours and then rinsed 3×10 minutes with 0.25 M NaCl or 1 M H₂SO₄ and 1×10 minutes with DI water. The resulting resin was allowed to dry overnight in a fume hood.

Adsorption isotherms were measured for the cation exchange and anion exchange ceramic particle resins. Pollutant adsorption isotherms were determined to depend on numerous factors, including the identity of the pollutant, the functional groups and structure of the resin, and the pH, salinity, and competing ions present in the surrounding water. However, the relative performance of materials can be compared by doing isotherm tests with a specific pollutant dissolved in DI water.

Isotherms were measured as follows. Samples with 10-15 different initial pollutant concentrations were used. Each sample was prepared as a 20 mL solution. Then, 100 mg of resin was tipped into the appropriate vial. The mass of each vial was recorded. Each vial was capped, sealed with parafilm, and allowed to stir on an unheated hotplate for at least 40 hours. The resulting solutions in each vial were filtered into fresh vial, and the pollutant concentrations were measured in the filtered solutions using colorimetry or inductively coupled plasma optical emission spectrometry (ICP-OES). The adsorption at equilibrium (q, mg pollutant/g resin) can be calculated as follows:

$$q = \frac{( {c}_{0} - c ) V}{m}$$

where c₀ is the initial concentration of the pollutant, c is the final/equilibrium concentration, V is the volume of solution in the vial, and m is the mass of resin added to the vial. Corresponding values of c and q can be paired to form points, which can be plotted to form an isotherm. The isotherm can then be fitted to a Langmuir, Freundlich, or Modified Langmuir-Freundlich (MLF) model.

An important metric is adsorption-per-mass, since in some instances the size of an adsorption column is a more relevant concern than its weight. The following densities are of potential relevance: dry material density (the density of the resin material when the resin is dry), dry bulk density (the density of the resin powder accounting for void spaces between particles), wet material density (the density of the resin material when the resin is submerged in water, and has been allowed to expand or contract to equilibrium), and wet bulk density (the density of the resin powder when submerged in water and allowed to expand or contract to equilibrium). Hydrated expansion, typically expressed as a percent, represents the change in the bulk volume of a resin when submerged in water. Significant expansion in particular is to be avoided, as it leads to lower adsorption densities. As such, the composition of commercially available resins is typically a tradeoff between including functional groups to raise adsorption density, and including cross-linkers to prevent expansion. These metrics can be measured by first performing the following steps: (1) placing a graduated cylinder on the balance and zeroing it, (2) gently removing the cylinder from the balance and measuring resin powder into the graduated cylinder up to the 5 mL line, (3) gently return the cylinder to the balance to weigh the amount of resin in the cylinder, (4) re-zeroing the balance, (5) gently removing the cylinder from the balance, and using a dropper to add water up to the 10 mL line (starting by filling to around 8 mL, then stirring the resin with the spatula to ensure every bit of resin gets properly exposed to water and hydrated, then filling the rest of the way to 10 mL), (6) gently returning the cylinder to the balance to weigh the amount of water added, and (7) removing the cylinder from the balance and check the level of hydrated powder in the cylinder every 5 minutes until it no longer changes, and recording this volume. The dry bulk density can be calculated by dividing the mass of resin measured in Step (3) by the dry bulk volume (5 mL), the wet bulk density can be calculated by dividing the mass of resin measured in Step (3) by the wet bulk volume measured in Step (7). The wet material volume can be calculated by subtracting the volume of water added from 10 mL. The volume of water added can be calculated using V=m p with the mass measured in Step (6). The wet material density can be calculated by dividing the mass of resin measured in Step (3) by the wet material volume calculated above. The hydrated expansion is the percent increase of the hydrated bulk volume measured in Step 7 from the original dry bulk volume (5 mL). It be calculated by taking the difference between the hydrated bulk volume and 5 mL, and dividing that difference by 5 mL.

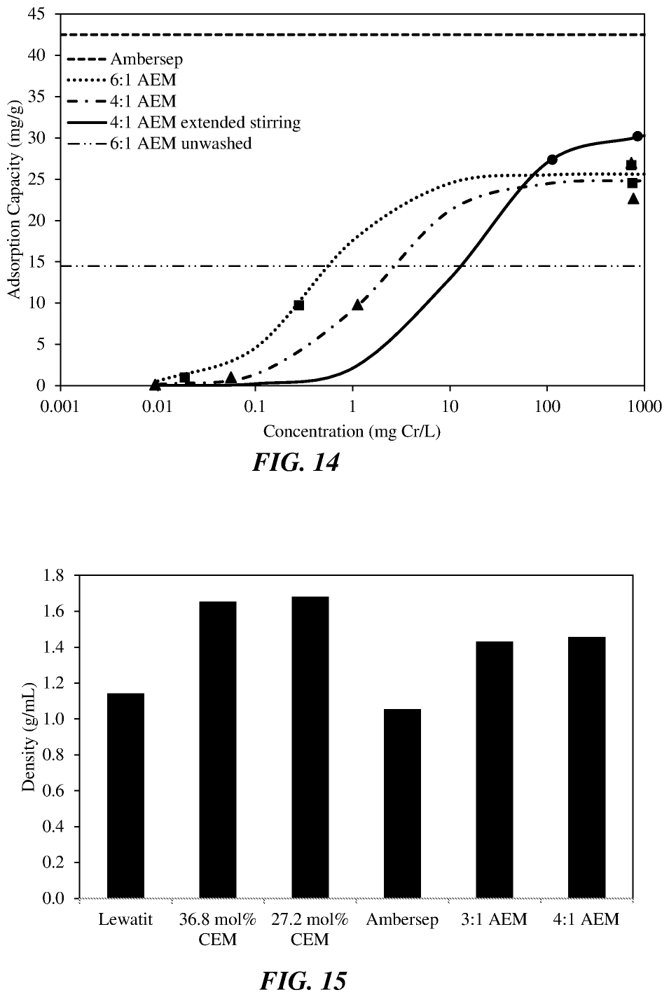

Maximum adsorption data for unwashed 6:1 AEM sol and Ambersep 21K XLT commercial resin were collected by doing isotherm-style tests at high concentrations of potassium chromate, with two different concentrations and two different times for each resin to ensure equilibrium was reached at the maximum value. In this Example, the nomenclature “X:1 AEM sol” refers to a material prepared from a sol prepared using a molar ratio of TEOS to TEAPS of X to 1. For example, a 6:1 AEM sol refers to a material formed from a sol prepared with a 6:1 molar ratio of TEOS to TEAPS. These data yielded the horizontal line seen on the graph in FIG. 14 where “Ambersep” refers to the maximum adsorption of the Ambersep 21K XLT commercial resin. Note that the resolution of the max adsorption test was low, with potential for ≈10-30% error. When preparing the experiments, the chromate solution immediately turned from yellow to orange on contact with an unwashed AEM sol, indicating conversion from chromate to dichromate, which occurs in the presence of acid. As such, the washing procedures outlined in Example 1 were implemented for all future resins, to remove residual contaminants and convert the resins more fully to their Cl⁻ or Na⁺ forms. Isotherm tests were conducted on 6:1 and 4:1 sols, stirred for ˜ 30 minutes prior to drying and washed according to the procedure described above. The results are shown as the solid curves on the graph in FIG. 14. A 4:1 AEM sol stirred for multiple hours (“4:1 AEM extended stirring”) was also tested.

As indicated by the plot in FIG. 14, the 4:1 AEM sol stirred for ≈30 minutes was the best-performing resin at high concentrations under the conditions tested, which is the more relevant range for many wastewaters. The 4:1 AEM sol stirred for multiple hours performed measurably worse. Without wishing to be bound by any particular theory, it is believed that the worse performance was likely due to changes in pore microstructure caused by the increased viscosity of the sol. This indicates the importance of stirring time to resin microstructure and performance.

The washed 6:1 AEM sol performed similarly to the 4:1 AEM sol stirred for several hours, and substantially better than the unwashed 6:1 AEM sol. Since washing brought the maximum adsorption of the 6:1 sol up by 66%, from ≈15 to ≈25 mg/g, a good washing procedure can be important to resin performance. All of the AEM sols performed worse than the Ambersep commercial resin on a mass basis, but that is not the key metric. Since the size of the packed bed in an adsorption column is generally of greater concern than its mass, it would be more important to compare the sols to the commercial resin using adsorption per unit volume. The resins would be best compared using their material density. To determine the material density of each resin, a known mass of resin was added to a graduated cylinder, and then the mass of water required to fill the cylinder was measured. From there, the volume taken up by the resin particles and the material density was calculated. The results are shown in FIG. 15. The densities of the AEM sols were found to be very similar to one another, and likewise the (cation exchange material (CEM) sols had similar densities to each other. As such, comparing CEM or AEM sols on a mass basis is adequate, as it will lead to the same results as a volumetric-basis comparison. However, the Ambersep and Lewatit commercial resins were substantially less dense, indicating that adjusting the adsorption values using the density is required to adequately compare the commercial resins to the sols of the adsorbent materials of this Example. Another relevant parameter measured while collecting density data was hydrated expansion, or the percentage by which the resin bed expanded within the graduated cylinder upon adding water. To maintain high adsorption densities, this hydrated expansion is usually kept to a low or practically eliminated in commercial resins by adding cross-linkers. The results in Table 2 indicate little to no expansion for the commercial Lewatit and Ambersep resins, and the 4:1 AEM sol, but measurable expansion for the 36.8 mol % CEM sol and substantial expansion for the 27.2 mol % and 3:1 sols. This indicates that care must be taken when developing sols of new compositions and microstructures, to reduce or eliminate hydrated expansion.

TABLE 2
Hydrated expansion of resin beds.

| | Resin | | | | | |
|---|---|---|---|---|---|---|
| | | 36.8 mol | 27.2 mol | | 3:1 | 4:1 |
| | Lewatit | % CEM | % CEM | Ambersep | AEM | AEM |
| Expansion | 0% | 4% | 27% | 0% | 12% | 0% |

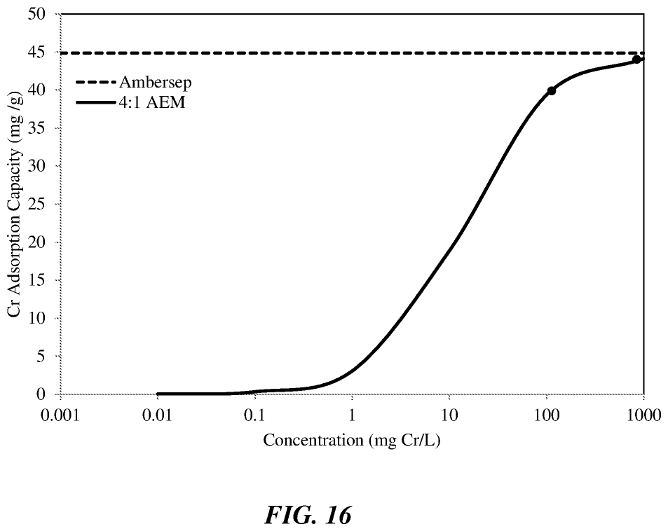

Taking the best performing AEM Sol, the 4:1 stirred for ˜30 minutes, and comparing it to the Ambersep and the unwashed 6:1 on a volumetric basis yields the plot in FIG. 16. Corrected to a volumetric basis, the 4:1 AEM sol performed very similarly to the Ambersep commercial resin in terms of max adsorption, indicating that it is possible to make sols with comparable performance to commercial options, in terms of adsorption density.

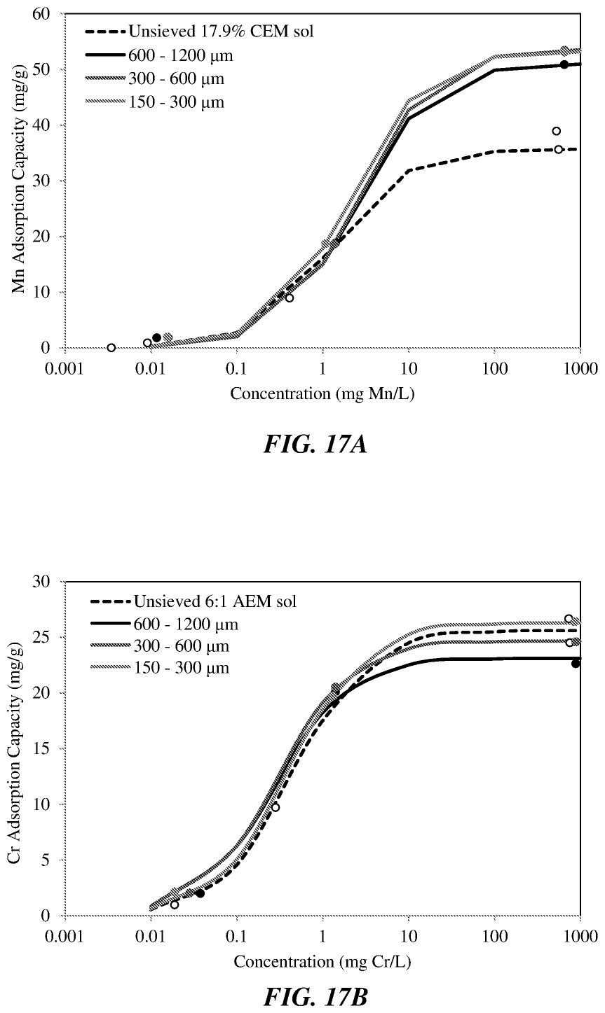

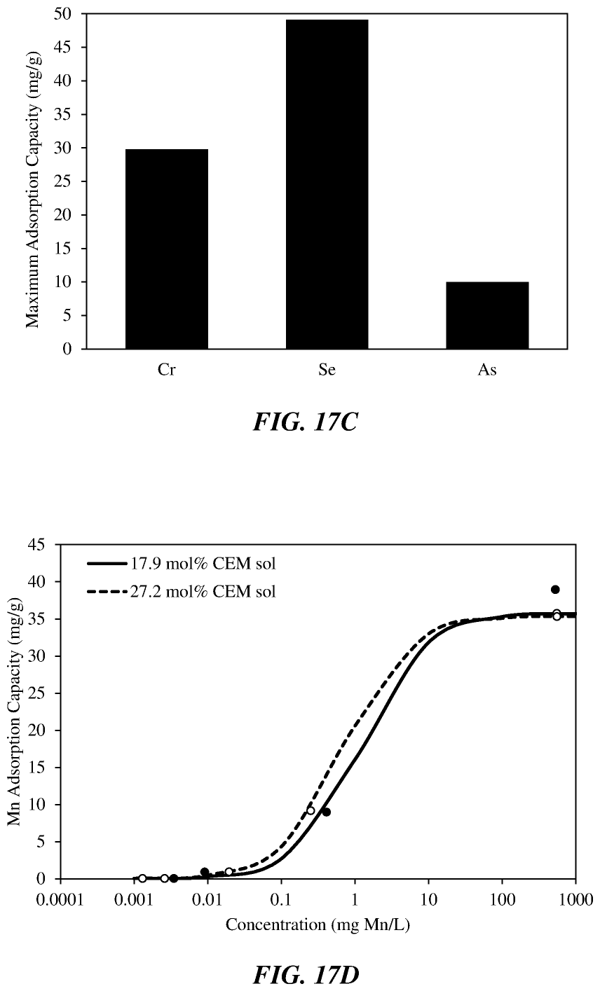

The particle size dependence of adsorption was tested by sieving 6:1 AEM Sol into three particle size ranges: 150-300 m, 300-600 m, and 600-1200 m. The results were compared in FIGS. 17A and 17B. The data showed a weak but measurable particle size dependence. Without wishing to be bound by any particular theory, this could be explained by larger particles having a greater number of pores cut off from the surface. It was also observed that the isotherms of the unsieved sample was closer to the smaller particle size ranges, which is likely due to a downward-weighted particle size distribution, including particles below 150 jm.

With that said, however, some qualitative information could still be gleaned from the data.

Additional experiments using the same methodology but measuring other target species led to the observation that both the Ambersep commercial resin and the 4:1 AEM sol adsorbed chromate, selenite, and arsenite to some degree (FIG. 17C). Additionally, it was observed that unsieved 17.9 mol % CEM sol and 27.2 mol % CEM sol adsorbed approximately the same amount of manganese (FIG. 17D). In conclusion, this Example demonstrates that adsorbent materials comprising ceramic particles prepared according to this disclosure can capture target species such as metal ions and oxyanions.

### Example 5

This Example describes an experimental comparison of the durability of exemplary adsorbent materials with a commercially-available polymer ion exchange resin. Specifically, the performance of metal ion capture before and after exposure to the oxidizer hydrogen peroxide was tested.

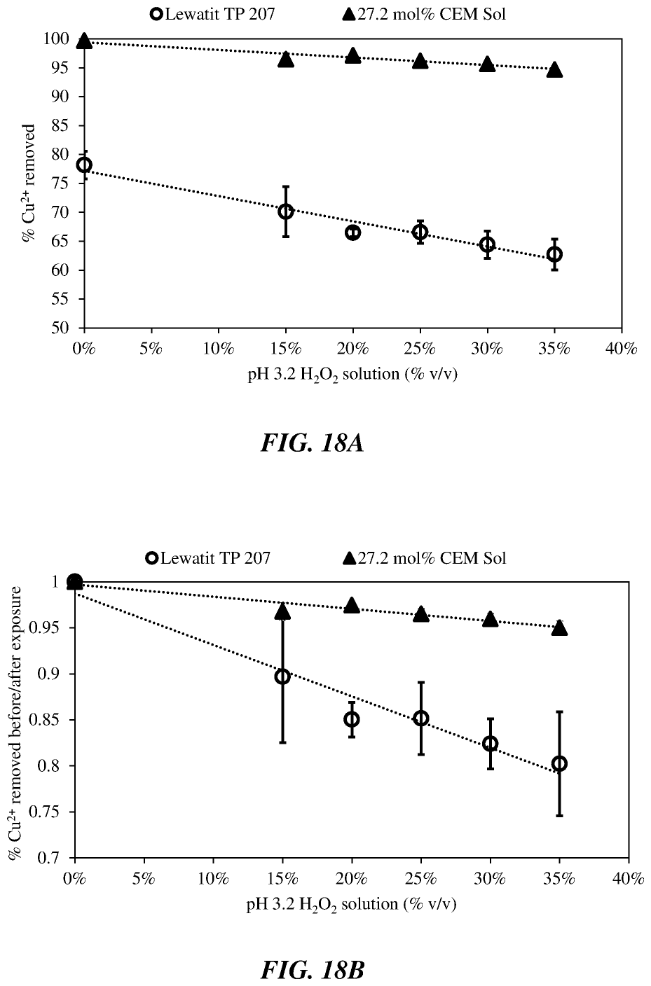

Samples of an adsorbent material in the form of a resin of particles identical to the 27.2 mol % CEM sol prepared in Example 4 was compared to samples of Lewatit TP 207 polymer ion exchange resin. Each sample was tested by exposing 0.1 g of resin to 10 mL of a pH 3.2 aqueous hydrogen peroxide solution of increasing concentrations and shaken for 46 hours on an orbital shaker. The hydrogen peroxide solution was refreshed twice to ensure sufficient exposure. The fresh hydrogen peroxide-exposed resins were rinsed with deionized water and then shaken with 10 mL of pH 3.2 aqueous solution of 300 mg/L copper sulfate for 4 hours. The supernatant was analyzed for copper concentration via ultraviolet-visible (UV-vis) spectrophotometry. The difference in copper solution between this value and the 300 mg/L stock solution was calculated in terms of a “% Cu²⁺ removed after exposure” value. FIG. 18A presents a plot of this after-exposure value for the after-exposed porous adsorbent material (solid triangles) and the polymer ion exchange resin (hollow circles) as a function of concentration of hydrogen peroxide. FIG. 18B presents a plot of a ratio of the % Cu²⁺ removed before exposure to % Cu²⁺ removed by corresponding samples that were never exposed to H₂O-2. This ratio of % Cu²⁺ removed by the resins before and after hydrogen peroxide exposure demonstrates superior oxidation resistance of the porous adsorbent material of this disclosure as compared to the commercially available polymer ion exchange resin. It should be noted that the error bars for 27.2 mol % CEM sol in FIGS. 18A-18B are smaller than the markers for the data points.

### Example 6

This Example describes experiments evaluating the effect on metal ion removal performance by loading of functional groups and the functionalization of porous adsorbent materials with second functional groups.

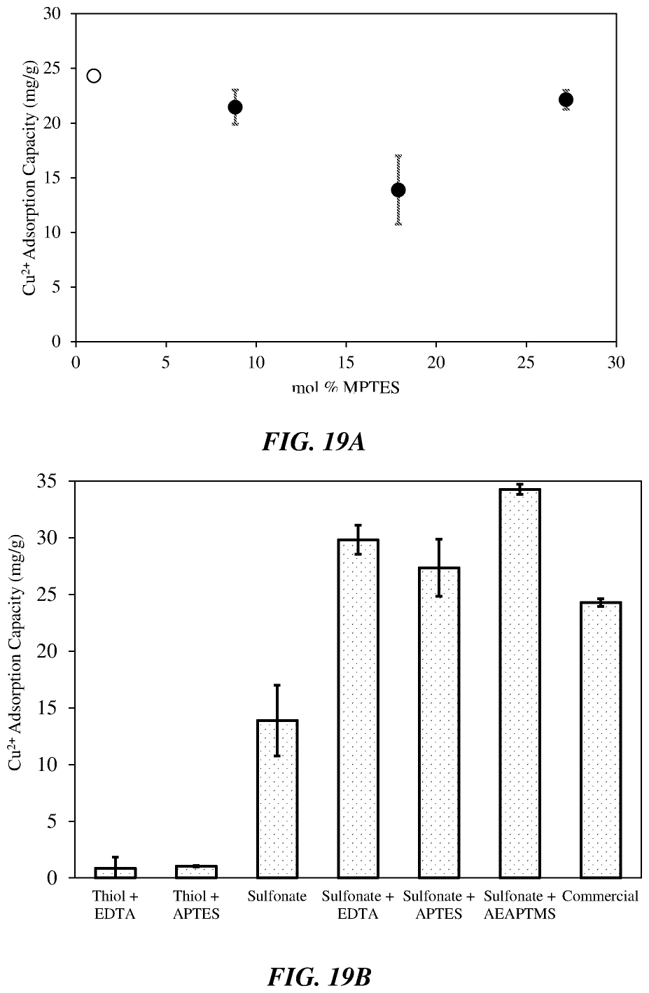

It was determined by the experiments of this Example that the metal ion capture performance of the porous adsorbent materials of this disclosure can, in some embodiments, be modulated by the functional group loading (e.g., sulfonate and/or sulfonic acid functional group loadings) (FIG. 19A) and/or by the further addition of yet other functional groups via modification with other functionalized precursors (FIG. 19B). While these particular experiments in this Example only show data for Cu²⁺ removal, it is expected that removal of any of a variety of metal ions in solution would be affected by the choice of additional functionalized silicon-containing precursors (e.g., functionalized silanes). In FIG. 19A, the commercial polymer ion exchange resin is located at 1 mol % with a hollow circle marker solely for comparison purposes. The functionalized silicon-containing precursors for further functionalization tested in this Example were APTES ((3-Aminopropyl)triethoxysilane), EDTA (N-(triethoxysilylpropyl)ethylenediamine, triacetic acid), and AEAPTMS (N-(2-aminoethyl)-3-aminopropyltriethoxysilane). Though not tested, it is believed in the context of this disclosure that functionalization with an iminodiacetic acid group, a salicylaldehyde Schiff base group, an imidazole group, a bispicolylamine group, an aminomethyl phosphonic group, and/or variations on those or other functionalized silicon-containing precursors would also modulate metal ion removal by the porous adsorbent material. These functional groups are contemplated to modulate metal ion ability because they contain groups (e.g., amines, carboxylates) that can coordinate to metal ions and, in some instances, have a chelating ability for at least some metal ions.

Porous adsorbent materials in the form of resins prepared from CEM sols using MPTES were produced as described above in Example 4 and sieved to 600-1180 μm. After the resin was dried in a 40° C. oven, additional functionalized silicon-containing precursors were added to applicable samples by soaking 5 g of resin in 15 mL of an acidic ethanolic solution containing the functionalized silicon-containing precursor. Typically, the functionalized silicon-containing precursor solution was composed of 95 mL of ethanol, 5 mL of water, 3 mL of acetic acid, and 2 mL of the functionalized silicon-containing precursor. While increased functionalized silicon-containing precursor concentrations were tested (up to 10 mL functionalized silicon-containing precursor), the best performance under the particular conditions tested came from 2 mL functionalized silicon-containing precursor solutions. The resin/functionalized silicon-containing precursor solutions were left to sit undisturbed for 24 hours at room temperature. Solutions were held at both room temperature (RT) and 40° C., and it was determined that the RT functionalization was more successful. After the time elapsed, the resin was rinsed 3 times with ethanol over a vacuum flask and then dried in a 40° C. oven for >72 hours. The samples labeled “thiol” in this Example are porous adsorbent resins that do not have any sulfonate group. The procedure for the “thiol” resin is the same as the sulfonate-containing resin except that it does not undergo an oxidation step to form sulfonate groups from the thiol groups. Metal ion capture performance was evaluated by adding 0.1 g of the resin to 10 mL of an aqueous, pH 3.2, 300 mg/L copper sulfate solution and shaking at RT for 4 hours.

The supernatant of the samples was analyzed for copper concentration via UV-vis spectrophotometry, and the % Cu²⁺ removed was calculated based on a comparison to the stock copper sulfate solution. FIG. 19A shows a plot of % Cu²⁺ removed as a function of amount of MPTES used in the silicon-containing precursor sol used to produce the CEM resin. The results in FIG. 19A demonstrate that with increasing sulfonate functionalization, metal adsorption increases. Above ˜30 mol % of the sulfonate-containing precursor MPTES results in a resin that does not survive the oxidation process. FIG. 19B shows a plot comparing the copper adsorption for resins produced from sols containing 17.9 mol % MPTES and further modified by additional functionalized silicon-containing precursors. Again, the “thiol” data points have the same underlying resin as the “sulfonate” resin but pre-oxidation. EDTA, APTES, and AEAPTMS functionalized silicon-containing precursors increased the amount of copper adsorbed by the resin. While thiols have been used to remove metals from aqueous solutions, in this case the porous adsorbent materials functionalized with thiol as opposed to sulfonate and/or sulfonic acid groups did not effectively remove copper.

The effect of functional group loading and additional functionalization on metal ion capture selectivity by the porous adsorbent material was also explored. 0.1 g of resin (functionalized as described above) was exposed to 10 mL of a pH 3.2 solution containing 100 mg/L of Cu²⁺, 100 mg/L of Ca²⁺, and 100 mg/L of Na⁺ for 4 hours while shaken at room temperature. The supernatant was analyzed for unabsorbed ions with ICP-OES. Metal ion capture selectivity was calculated by comparing how many ions of each element were adsorbed by the resin.

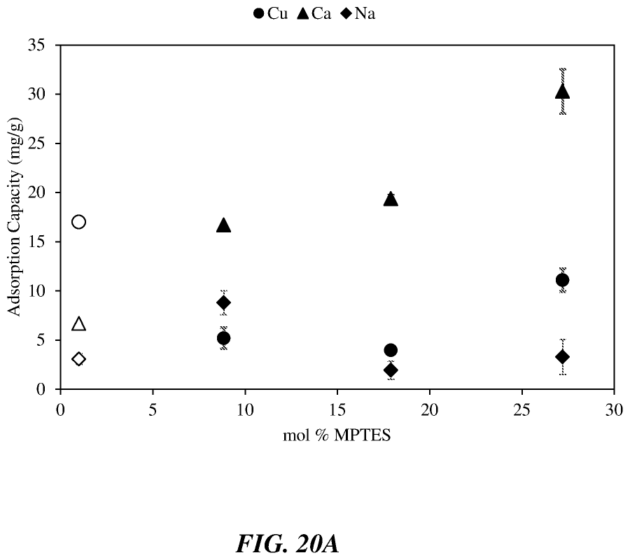

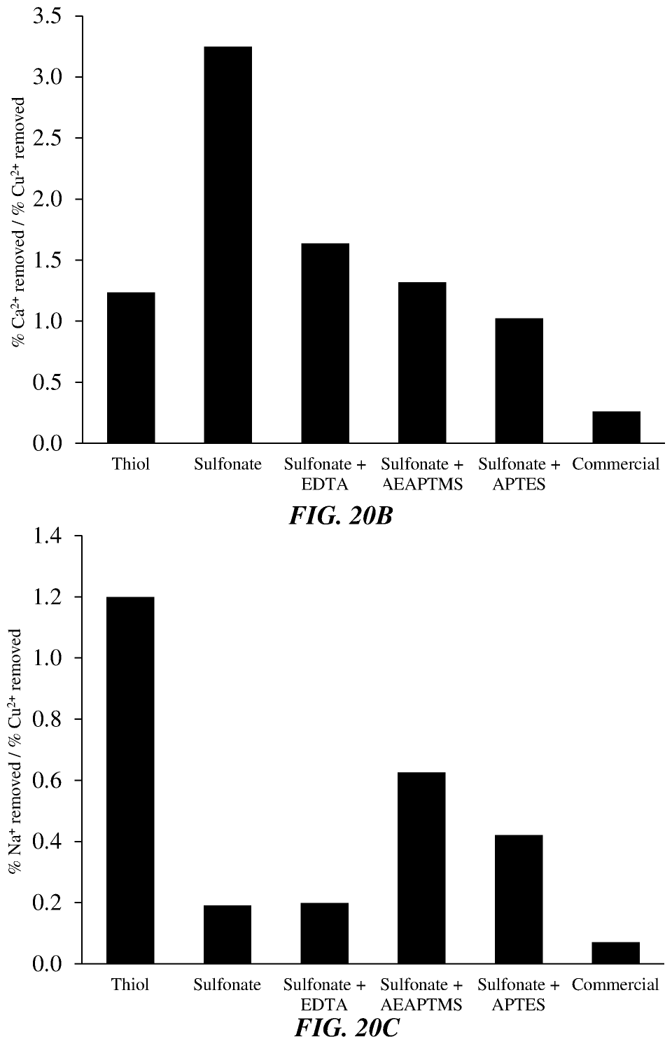

When exposed to a copper/calcium/sodium mixed ion solution, the porous adsorbent material CEM resin embodiments of this Example most readily adsorbed calcium ions, followed by copper ions, and then sodium ions (FIGS. 20A, 20B, 20C). Both the mol % of MPTES (FIG. 20A) and the additional functionalized silicon-containing precursors (FIGS. 20B and 20C) modulate the metal ion selectivity of the resin. In FIG. 20A, the commercial sample is marked by hollow markers from comparison purposes, and the porous adsorbent materials of this disclosure have solid markers. Circle markers correspond to copper ions, triangle markers correspond to calcium ions, and diamond markers correspond to sodium ions. FIG. 20B shows a ratio of percentages of calcium ions to copper ions removed by each resin tested, while FIG. 20C shows a ratio of percentages of sodium ions to copper ions removed by each resin tested.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An adsorbent material, the adsorbent material comprising ceramic particles, wherein:
the ceramic particles comprise a functional group covalently bonded to a surface of the ceramic particles;
a mean maximum cross-sectional dimension of the ceramic particles is greater than or equal to 100 nanometers and less than or equal to 3000 microns; and
the ceramic particles are free of any metal or metalloid atoms bound to any other metal or metalloid atoms via a linkage comprising an arylene group or comprise metal or metalloid atoms directly bound to other metal or metalloid atoms via a linkage comprising an arylene group in an amount of less or equal to 50 mol % of the metal or metalloid atoms in the ceramic particles.

2. An adsorbent material, the adsorbent material comprising ceramic particles, wherein:
the ceramic particles comprise a functional group covalently bonded to a surface of the ceramic particles;
a mean maximum cross-sectional dimension of the ceramic particles is greater than or equal to 100 nanometers and less than or equal to 3000 microns; and
upon exposure to a liquid, the adsorbent material does not undergo a volume expansion or undergoes a volume expansion by a factor of less than 1.5.

3. A system for treating a fluid mixture comprising a fluorine-containing molecule, the system comprising:
a vessel comprising:
an inlet for receiving the fluid mixture, and
an adsorbent material within the vessel, the adsorbent material comprising functional groups having an affinity for the fluorine-containing molecule; and
a mechanochemical apparatus configured to receive solid material from the vessel.

4. A method for treating a fluid mixture comprising a target species comprising a fluorine-containing molecule, the method comprising:
exposing an adsorbent material comprising free ceramic particles to the fluid mixture, wherein the ceramic particles comprise a functional group bonded to the ceramic having an affinity for the target species; and
removing an amount of the target species from the fluid mixture at least in part by capturing the target species with the ceramic particles using the functional group.

5. A method for treating a fluid mixture comprising a target species, the method comprising:
exposing an adsorbent material comprising free ceramic particles to the fluid mixture, wherein the ceramic particles comprise a functional group bonded to a surface of the ceramic particles, the functional group having an affinity for the target species, wherein the adsorbent material has a volume of greater than or equal to 0.01 m³; and
removing an amount of the target species from the fluid mixture at least in part by capturing the target species molecules with the ceramic particles using the functional group.

6. A method for treating fluorine-containing molecules, comprising subjecting a target species comprising a fluorine-containing molecule captured by functional groups covalently bound to an adsorbent material to a mechanochemical transformation.

7. A method for treating a target species, comprising subjecting a target species captured by functional groups covalently bound to a surface of ceramic particles of an adsorbent material to a mechanochemical transformation, wherein a mean maximum cross-sectional dimension of the ceramic particles is greater than or equal to 100 nanometers and less than or equal to 3000 microns.

8. The adsorbent material, system, or method of any one of the preceding claims, wherein the adsorbent material comprises a ceramic.

9. The adsorbent material, system, or method of any one of the preceding claims, wherein the adsorbent material comprises ceramic particles.

10. The adsorbent material, system, or method of any one of the preceding claims, wherein the ceramic comprises a metal or metalloid.

11. The adsorbent material, system, or method of any one of the preceding claims, wherein the metal or metalloid is Si, Al, Ti, or Zn.

12. The adsorbent material, system, or method of any one of the preceding claims, wherein a mean maximum cross-sectional dimension of the ceramic particles is greater than or equal to 100 nanometers and less than or equal to 3000 microns.

13. The adsorbent material, system, or method of any one of the preceding claims, wherein a mean maximum cross-sectional dimension of the ceramic particles is greater than or equal to 10 microns and less than or equal to 3000 microns.

14. The adsorbent material, system, or method of any one of the preceding claims, wherein a mean maximum cross-sectional dimension of the ceramic particles is greater than or equal to 10 microns and less than or equal to 1500 microns.

15. The adsorbent material, system, or method of any one of the preceding claims, wherein the ceramic has an average pore diameter of less than or equal to 10 nm.

16. The adsorbent material, system, or method of any one of the preceding claims, wherein the ceramic comprises a silica-based ceramic.

17. The adsorbent material, system, or method of any one of the preceding claims, wherein the target species comprises a fluorine-containing molecule.

18. The adsorbent material, system, or method of any one of the preceding claims, wherein the target species comprises a metal or metalloid-containing ion.

19. The adsorbent material, system, or method of any one of the preceding claims, wherein the target species comprises an oxyanion.

20. The adsorbent material, system, or method of any one of the preceding claims, wherein the oxyanion is nitrate.

21. The adsorbent material, system, or method of any one of the preceding claims, wherein the target species comprises a metal or metalloid oxide.

22. The adsorbent material, system, or method of any one of the preceding claims, wherein the functional group has affinity for a fluorine-containing molecule.

23. The adsorbent material, system, or method of any one of the preceding claims, wherein the fluorine-containing molecule comprises a hydrophilic head group.

24. The adsorbent material, system, or method of any one of the preceding claims, wherein the hydrophilic head group comprises a sulfonate and/or sulfonic acid group or a carboxylate and/or carboxylic acid group.

25. The adsorbent material, system, or method of any one of the preceding claims, wherein the fluorine-containing molecule comprises a hydrophobic tail group.

26. The adsorbent material, system, or method of any one of the preceding claims, wherein the fluorine-containing molecule comprises a per- or poly-fluoroalkyl substance.

27. The adsorbent material, system, or method of any one of the preceding claims, wherein the per- or poly-fluoroalkyl substance comprises a perfluoroalkyl carboxylic acid.

28. The adsorbent material, system, or method of any one of the preceding claims, wherein the per- or poly-perfluoroalkyl carboxylic acid comprises perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, and/or perfluorotetradecanoic acid.

29. The adsorbent material, system, or method of any one of the preceding claims, wherein the per- or poly-fluoroalkyl substance comprises a perfluoroalkyl sulfonic acid.

30. The adsorbent material, system, or method of any one of the preceding claims, wherein the perfluoroalkyl sulfonic acid comprises perfluorobutanesulfonic acid, perfluoropentansulfonic acid, perfluorohexanesulfonic acid, perfluoroheptanesulfonic acid, perfluorooctanesulfonic acid, perfluorononanesulfonic acid, perfluorodecanesulfonic acid, and/or perfluorododecanesulfonic acid.

31. The adsorbent material, system, or method of any one of the preceding claims, wherein the per- or poly-fluoroalkyl substance comprises a fluorotelomer sulfonic acid.

32. The adsorbent material, system, or method of any one of the preceding claims, wherein the fluorotelomer sulfonic acid comprises 1H,1H, 2H, 2H-perfluorohexane sulfonic acid, 1H,1H, 2H, 2H-perfluorooctane sulfonic acid, and/or 1H,1H, 2H, 2H-perfluorodecane sulfonic acid.

33. The adsorbent material, system, or method of any one of the preceding claims, wherein the per- or poly-fluoroalkyl substance comprises a perfluorooctanesulfonamide.

34. The adsorbent material, system, or method of any one of the preceding claims, wherein the perfluorooctanesulfonamide comprises perfluorooctanesulfonamide, N-methyl perfluorooctanesulfonamide, and/or N-ethyl perfluorooctanesulfonamide.

35. The adsorbent material, system, or method of any one of the preceding claims, wherein the per- or poly-fluoroalkyl substance comprises a perfluorooctane sulfonamidoacetic acid.

36. The adsorbent material, system, or method of any one of the preceding claims, wherein the perfluorooctane sulfonamidoacetic acid comprises N-methyl perfluorooctanesulfonamidoacetic acid and/or N-ethyl perfluorooctanesulfonamidoacetic acid.

37. The adsorbent material, system, or method of any one of the preceding claims, wherein the per- or poly-fluoroalkyl substance comprises a perfluorooctane sulfonamide ethanol.

38. The adsorbent material, system, or method of any one of the preceding claims, wherein the perfluorooctane sulfonamide ethanol comprises N-methyl perfluorooctanesulfonamidoethanol and/or N-ethyl perfluorooctanesulfonamidoethanol.

39. The adsorbent material, system, or method of any one of the preceding claims, wherein the per- or poly-fluoroalkyl substance comprises a per- or polyfluoroether carboxylic acid.

40. The adsorbent material, system, or method of any one of the preceding claims, wherein the per- or polyfluoroether carboxylic acid comprises hexafluoropropylene oxide dimer acid, 4,8-Dioxa-3H-perfluorononanoic acid, perfluoro-3-methoxypropanoic acid, perfluoro-4-methoxybutanoic acid, and/or nonafluoro-3,6-dioxaheptanoic acid.

41. The adsorbent material, system, or method of any one of the preceding claims, wherein the per- or poly-fluoroalkyl substance comprises an ether sulfonic acid.

42. The adsorbent material, system, or method of any one of the preceding claims, wherein the ether sulfonic acid comprises 9-chlorohexadecafluoro-3-oxanonane-1-sulfonic acid, 11-chloroeicosafluoro-3-oxaundecane-1-sulfonic acid, and/or perfluoro(2-ethoxyethane)sulfonic acid.

43. The adsorbent material, system, or method of any one of the preceding claims, wherein the per- or poly-fluoroalkyl substance comprises a fluorotelomer carboxylic acid.

44. The adsorbent material, system, or method of any one of the preceding claims, wherein the fluorotelomer carboxylic acid comprises 3-perfluoropropyl propanoic acid, 2H,2H,3H,3H-perfluorooctanoic acid, and/or 3-perfluoroheptyl propanoic acid.

45. The adsorbent material, system, or method of any one of the preceding claims, wherein the per- or poly-fluoroalkyl substance comprises hexafluoropropylene oxide dimer acid (HFPO-DA), a salt of HFPO-DA, and/or a fluorochemical known to be used to produce HFPO-DA or a salt of HFPO-DA.

46. The adsorbent material, system, or method of any one of the preceding claims, wherein the functional group comprises an ion exchange functional group.

47. The adsorbent material, system, or method of any one of the preceding claims, wherein the functional group comprises an amine and/or ammonium group, or an imidazole and/or imidazolium group.

48. The adsorbent material, system, or method of any one of the preceding claims, wherein the functional group comprises a primary amine group.

49. The adsorbent material, system, or method of any one of the preceding claims, wherein the functional group comprises a secondary amine group.

50. The adsorbent material, system, or method of any one of the preceding claims, wherein the functional group comprises a tertiary amine group.

51. The adsorbent material, system, or method of any one of the preceding claims, wherein the functional group comprises a quaternary ammonium group.

52. The adsorbent material, system, or method of any one of the preceding claims, wherein the functional group comprises two or more amine and/or ammonium groups.

53. The adsorbent material, system, or method of any one of the preceding claims, wherein the functional group comprises a sulfonate and/or sulfonic acid group and/or a carboxylate and/or carboxylic acid group.

54. The adsorbent material, system, or method of any one of the preceding claims, wherein the functional group comprises an optionally substituted or unsubstituted, branched or unbranched C₁-C₁₈ alkyl group.

55. The adsorbent material, system, or method of any one of the preceding claims, wherein the functional group comprises a fluoroalkyl group.

56. The adsorbent material, system, or method of any one of the preceding claims, wherein the functional group is present in the ceramic in an amount of greater than or equal to 0.01 mmol per gram of the ceramic.

57. The adsorbent material, system, or method of any one of the preceding claims, wherein the ceramic particles are free of any metal or metalloid atoms bound to any other metal or metalloid atoms via a linkage comprising an arylene group or comprises metal or metalloid atoms directly bound other metal or metalloid atoms via a linkage comprising an arylene group in an amount of less or equal to 50 mol % of the metal or metalloid atoms in the ceramic particles.

58. The adsorbent material, system, or method of any one of the preceding claims, wherein the ceramic particles are free of any metal or metalloid atoms bound to any other metal or metalloid atoms via a linkage comprising an alkylene or arylene group or comprises metal or metalloid atoms directly bound other metal or metalloid atoms via a linkage comprising an alkylene group or arylene group in an amount of less or equal to 50 mol % of the metal or metalloid atoms in the ceramic particles.

59. The adsorbent material, system, or method of any one of the preceding claims, wherein the ceramic particles are free of any metal or metalloid atoms bound to any other metal or metalloid atoms via a linkage comprising an aliphatic, heteroaliphatic, arylene, or heteroarylene group or comprises metal or metalloid atoms directly bound other metal or metalloid atoms via a linkage comprising an aliphatic, heteroaliphatic, arylene, or heteroarylene in an amount of less or equal to 50 mol % of the metal or metalloid atoms in the ceramic particles.

60. The adsorbent material, system, or method of any one of the preceding claims, wherein upon exposure to a liquid, the adsorbent material does not undergo a volume expansion or undergoes a volume expansion by a factor of less than 1.5.

61. The adsorbent material, system, or method of any one of the preceding claims, wherein, upon exposure to a liquid, the adsorbent material does not undergo a volume expansion or undergoes a volume expansion by a factor of less than or equal to 1.05.

62. The adsorbent material, system, or method of any one of the preceding claims, wherein the adsorbent material has a volume of greater than or equal to 0.01 m³.

63. The adsorbent material, system, or method of any one of the preceding claims, wherein the ceramic particles are present in the adsorbent material in an amount of greater than or equal to 25 wt % versus the total weight of the adsorbent material.

64. The adsorbent material, system, or method of any one of the preceding claims, wherein the adsorbent material comprises:
a first subset of the ceramic particles each comprising a first functional group covalently bound to the ceramic, and
a second subset of the ceramic particles each comprising a second, different functional group covalently bound to the ceramic.

65. The adsorbent material, system, or method of any one of the preceding claims, wherein at least some of the ceramic particles comprise:
a first functional group covalently bound to the ceramic, and
a second, different functional group covalently bound to the ceramic.

66. The adsorbent material, system, or method of any one of the preceding claims, wherein the first functional group comprises an ion exchange group and the second functional group comprises a second, different ion exchange group.

67. The adsorbent material, system, or method of any one of the preceding claims, wherein the first functional group comprises an ion exchange group and the second functional group comprises a chelating group.

68. The adsorbent material, system, or method of any one of the preceding claims, wherein the first functional group comprises a sulfonate and/or sulfonic acid group and the second functional group comprises an amine group.

69. The adsorbent material, system, or method of any one of the preceding claims, wherein the adsorbent material is in the form of a resin and/or beads.

70. The adsorbent material, system, or method of any one of the preceding claims, wherein the ceramic is sol-gel-derived.

71. The adsorbent material, system, or method of any one of the preceding claims, wherein the ceramic is derived from the co-condensation of a metal or metalloid-containing precursor comprising the functional group or a moiety comprising a leaving group.

72. The adsorbent material, system, or method of any one of the preceding claims, wherein the ceramic is derived from a mixture comprising a compound having the structure (I): 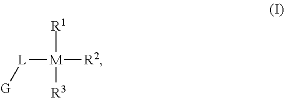
wherein each of R⁴, R⁵, and R⁶ are independently chosen from optionally-substituted or unsubstituted C₁₋₁₈ alkoxy and halo, L is chosen from optionally-substituted or unsubstituted C₁₋₁₈ alkylene and arylene, M is the metal and/or metalloid, and G comprises the functional group.

73. The adsorbent material, system, or method of any one of the preceding claims, wherein the ceramic is derived from a mixture comprising a compound having the structure (II): 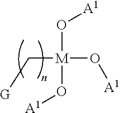
where A¹ is independently chosen from hydrogen, methyl, ethyl, propyl, or butyl, n is greater than or equal to 1 and less than or equal to 18, M is the metal and/or metalloid, and G comprises the functional group.

74. The adsorbent material, system, or method of any one of the preceding claims, wherein M is Si, Al, Ti, or Zn.

75. The adsorbent material, system, or method of any one of the preceding claims, wherein M is Si.

76. The system of any one of the preceding claims, wherein the mechanochemical apparatus comprises a ball mill.

77. The system of any one of the preceding claims, wherein the ball mill is a planetary ball mill.

78. The method of any one of the preceding claims, further comprising subjecting at least some of the amount of the target species removed from the fluid mixture to a mechanochemical transformation.

79. The method of any one of the preceding claims, wherein, during at least some of the subjecting step, the at least some of the target species subjected to the mechanochemical transformation are captured by the ceramic particles.

80. The method of any one of the preceding claims, wherein the mechanochemical transformation is performed at least in part via ball milling the at least some of the target species molecules.

81. The method of any one of the preceding claims, wherein the mechanochemical transformation is performed at least in part via ball milling the target species captured by functional groups covalently bound to an adsorbent material.

82. The method of any one of the preceding claims, wherein the ball milling is planetary ball milling.

83. The method of any one of the preceding claims, wherein the ball milling comprises exposing the at least some of the fluorine-containing molecules to a base.

84. The method of any one of the preceding claims, wherein the base is a hydroxide-containing salt.

85. The method of any one of the preceding claims, wherein the hydroxide containing salt is potassium hydroxide.
